(19) United States
(12) Patent Application Publication
(10) Pub. No.: US 2017/0270574 A1
(43) Pub. Date: Sep. 21, 2017

(54) SYSTEM AND METHOD FOR INTEGRATING E-COMMERCE AND IN-STORE RETAIL COMMERCE

(71) Applicant: ELEVEN VISUAL, LLC, Eden Prairie, MN (US)

(72) Inventor: Anthony Hessurg, Minnetrista, MN (US)

(21) Appl. No.: 15/310,243

(22) PCT Filed: May 12, 2015
(86) PCT No.: PCT/US2015/030276

§ 371 Date: Nov. 10, 2016

Related U.S. Application Data
(60) Provisional application No. 61/991,759, filed on May 12, 2014.
(60) Provisional application No. 62/082,353, filed on Nov. 20, 2014.

(51) Int. Cl. G06Q 30/06; G06Q 50/00; G06Q 10/08

(52) U.S. Cl. CPC G06Q 30/0601; G06Q 10/083; G06Q 50/01

(57) ABSTRACT

An e-commerce integration method and system is designed to integrate the advantages of e-commerce shopping with the advantages of brick-and-mortar shopping. The e-commerce integration system coordinates online purchase decisions with an in-person provider. The shopper is provided an opportunity to inspect the selected product at the in-person provider. Further, the system manages any required additional processing of the purchased product.

### CROSS REFERENCE TO RELATED APPLICATIONS

This application claims priority to U.S. Provisional Patent Application No. 61/991,759, filed May 12, 2014, entitled “System and Method for Integrating E-Commerce and In-Store Retail Commerce”, and claims priority to U.S. Provisional Patent Application No. 62/082,353, filed Nov. 20, 2014, entitled “System and Method for Integrating E-Commerce and In-Store Retail Commerce”, the contents of which are incorporated herein in their entirety for all purposes.

### TECHNICAL FIELD

The instant disclosure relates generally to an e-commerce integration system. More specifically, the instant disclosure relates to a method and system for integrating e-commerce and traditional “brick-and-mortar” commerce.

### BACKGROUND

Electronic commerce, or e-commerce, generally relates to the buying and selling of products or services over a network, typically the Internet. E-commerce providers frequently establish online, virtual storefronts. Such virtual storefronts frequently comprise online catalogs of various products. E-commerce providers only need to show within their virtual storefronts electronic information such as images, descriptions, and/or specifications of a product. A customer may purchase a product from the virtual storefront by providing payment information to the e-commerce provider, and, upon processing the payment information, the product is shipped from a fulfillment center (e.g., Amazon, etc.) for quick delivery to the customer. Unlike the virtual storefronts provided by e-commerce providers in the form of web pages, brick-and-mortar retail stores typically have physical shelves, bins, and other systems for displaying actual products for sale. To make a purchase from such a retail establishment, the customer must travel to the brick-and-mortar retail store, select the product(s) to be purchased, and then take the product(s) to a register to pay for the purchase.

### SUMMARY

Customers prefer a large selection of available products, and further, enjoy the ability to research and browse products online without having to depart their home or office, such as may be provided by an e-commerce provider. Customers also enjoy being able to physically inspect a product, try a product (e.g., try on clothes, shoes, etc.), observe the actual size and appearance of the product, etc. before actually making a purchase, such as may be provided by a brick-and-mortar retailer. The e-commerce integration methods and systems of the present disclosure provides the customer with the ability to view a large selection of available products without departing their home, as may be provided by e-commerce shopping, while also providing the customer with the ability to inspect/try/observe the product in person prior to providing payment information, as may be provided by brick-and-mortar shopping. An e-commerce integration system (EIS) provides computing resources to provide all e-commerce functions, including providing an online catalog of products, coordinating shipment with a designated in-person provider, along with scheduling, coordinating, and tracking various aspects of the product shipment. The EIS may be configured to allow a customer to browse and research products online, yet still inspect the product in-person at their preferred in-person provider, thereby potentially reducing overhead associated with distributors, middlemen, and other similar intermediaries. The e-commerce integration method may also comprise an in-retail component for completing sales, including an in-person representative provider web application.

According to one embodiment, a method includes providing a website displaying at least one product; receiving, by a server, at least one selection, from a customer, of at least one product for inspection by the customer; and submitting, by a server, at least one selection of at least one product to at least one product provider, wherein the product provider provides the at least one product for inspection by the customer; and wherein the purchase of at least one product occurs after an inspection of the at least one product by the customer. The method may also include sending a communication (e.g., invitation, hyperlink, etc.) to the customer to visit the website and/or wherein the at least one product is sent to an in-person provider for inspection. It may also include sending an invitation to visit the website to the customer and/or wherein at least one product is sent to the customer's home or office for purchase or inspection. The method may further include marketing to the customer after a visit with an in-person provider, especially if the customer did not purchase a product during the visit. The method may further include wherein the in-person provider may collect information about the customer and the customer's preferences pre-visit, during the visit, post-visit, or any combination thereof. If the in-person provider fails to enter the information, they will be prompted to do so when the customer makes a selection from the website.

According to another embodiment, a computer program product includes a non-transitory computer readable medium having code to receive, by a server, at least one selection, from a customer, of at least one product for inspection by the customer; and submit, by a server, at least one selection of at least one product to at least one product provider, wherein the product provider provides the at least one product for inspection by the customer; and wherein the purchase of at least one product occurs after an inspection of the at least one product by the customer. The medium also includes code to send an invitation to visit the website to the customer and/or wherein the at least one product is sent to an in-person provider for inspection. The medium may also include code to send an invitation to visit the website to the customer post in-person visit to prompt customer to shop online. The post-visit purchase may occur online with shared information from the in-person provider for some industries.

According to another embodiment, a system includes a memory and at least one processor. The at least one processor is coupled to the memory. The at least one processor is configured to receive, by a server, at least one selection, from a customer, of at least one product for inspection by the customer; and submit, by a server, at least one selection of at least one product to at least one product provider, wherein the product provider provides the at least one product for inspection by the customer; and wherein the purchase of at least one product occurs after an inspection of the at least one product by the customer.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings. FIGURE and FIG. may be used interchangeably, along with their corresponding plural versions.

FIG. 1 is a diagrammatic view, illustrating a method of integrating e-commerce and retail commerce, according to at least one embodiment of the disclosure;

FIG. 2 is a flow chart, illustrating a method of integrating e-commerce and retail commerce, according to at least one embodiment of the disclosure;

FIG. 3 is a flow chart, illustrating a method of integrating e-commerce and retail commerce, according to at least one embodiment of the disclosure;

FIG. 4 is a flow chart, illustrating a method executed by a server for integrating e-commerce and retail commerce, according to one embodiment of the disclosure;

FIG. 5 is a diagrammatic view, illustrating a method for coordinating a communication with at least one hybrid e-commerce website, according to at least one embodiment of the disclosure;

FIGS. 6A-6Y are diagrammatic views, illustrating methods of providing a user consultation within a hybrid e-commerce system, according to at least one embodiment of the disclosure;

FIG. 7 is a diagrammatic view, illustrating a method of coordinating further modification or processing of a product(s) with third parties, according to at least one embodiment of the disclosure;

FIG. 8 is a diagrammatic view, illustrating a method of reminding a customer to visit the e-commerce website, according to at least one embodiment of the disclosure;

FIG. 9 is a diagrammatic view, illustrating a hybrid e-commerce server network, according to at least one embodiment of the disclosure;

FIG. 10 is a block diagram illustrating a data management system configured to store databases, tables, and/or records according to one embodiment of the disclosure;

FIG. 11 is a block diagram illustrating a data storage system according to one embodiment of the disclosure;

FIG. 12 is a block diagram illustrating a computer system according to one embodiment of the disclosure;

FIGS. 13A-13E are process charts illustrating alternative and exemplary methods for implementing a hybrid e-commerce website and an e-commerce integration system;

FIG. 14 is a diagram illustrating various aspects of customer personas utilized by a hybrid e-commerce platform according to embodiments;

FIG. 15 is a flow diagram illustrating various functionalities that may be provided to customers based on customer personas associated with the customer according to embodiments;

FIG. 16 is a diagram illustrating various functions and interactions between systems of an in-person provider and a hybrid e-commerce platform according to embodiments;

FIG. 17 is a diagram illustrating various functions and actions that may be performed by an administrator operating a hybrid e-commerce platform according to embodiments;

FIG. 18 is a diagram illustrating various functions that may be performed by support staff of an operator of a hybrid e-commerce platform according to embodiments;

FIGS. 19A-19C are various flow diagrams illustrating operations for associating a customer with a customer persona according to embodiments;

FIGS. 20A-20E are various flow diagrams illustrating operations for associating or modifying a customer's personas according to embodiments;

FIG. 21 is a flow diagram illustrating how an office management system may be integrated with various systems operations in conjunction with a hybrid e-commerce platform according to embodiments;

FIG. 22 is a diagram illustrating various reporting features that may be utilized by entities cooperating to provide a hybrid e-commerce platform according to embodiments;

FIGS. 23A-23C are various diagrams illustrating order fulfillment workflows in a hybrid e-commerce system according to embodiments;

FIG. 24 is a flow diagram illustrating processing of various lab ordering transactions in a hybrid e-commerce platform according to embodiments;

FIG. 25 is a flow diagram illustrating a flow of financial information for a purchase made via a hybrid e-commerce platform according to embodiments;

FIG. 26 is a flow diagram illustrating an embodiment of providing a wine club membership and membership fulfillment using a hybrid e-commerce platform according to embodiments;

FIG. 27 is a flow diagram illustrating a data flow for exchanging information between entities operating in coordination with a hybrid e-commerce platform according to embodiments;

FIG. 28 is a flow diagram illustrating various payment transaction and processing flows in a hybrid e-commerce platform according to embodiments;

FIG. 29 is a flow diagram illustrating various aspects of a payment transaction flow for an in-retail purchase using a hybrid e-commerce platform according to embodiments;

FIG. 30 is a flow diagram illustrating various aspects of a payment transaction flows for purchases made using a hybrid e-commerce platform according to embodiments;

FIG. 31 is a flow diagram illustrating various aspects of a shipping flows for purchases made using a hybrid e-commerce platform according to embodiments;

FIG. 32 is a block diagram illustrating various data and data flows utilized by a hybrid e-commerce platform according to embodiments; and

FIG. 33 is a block diagram of an exemplary embodiment of a hybrid e-commerce platform architecture.

### DETAILED DESCRIPTION

An e-commerce integration method and system is described, and further, is structured and arranged to coordinate with other scheduling servers and/or supply-chain servers. The exemplary embodiments of a hybrid e-commerce integration system described herein may reduce or eliminate many of the negative aspects of traditional e-commerce for both the product retailer and the customer while simultaneously providing both the customer and the retailer with the benefits of traditional brick-and-mortar retail services. For example, as will be apparent from the description and FIGURES to follow, the hybrid e-commerce integration systems disclosed herein enable an in-person provider or product retailer to offer customers a large selection of products without having to maintain all of the products on hand (e.g., as in a traditional e-commerce customer experience), while enabling the customers to obtain an in-person inspection of the products prior to being charged for the purchase (e.g., as in a traditional brick-and-mortar customer experience). Thus, the in-person provider or product retailer is able to reduce storage space typically required to keep products “on hand,” a benefit traditionally only realized by e-commerce retailers, while offering customers the ability to touch, see, feel, try-on, inspect, and/or use the product before being charged for the product, a benefit traditionally only realized by customers through brick-and-mortar customer experiences. Furthermore, one or more of the disclosed embodiments ensures that the product the customer desires (e.g., a particular size, color, model, etc. of the product) is on-hand when the customer visits the in-person provider or product retailer, thereby eliminating brick-and-mortar customer experiences where the desired product is out of stock and having to visit another location that has the product in stock, if any.

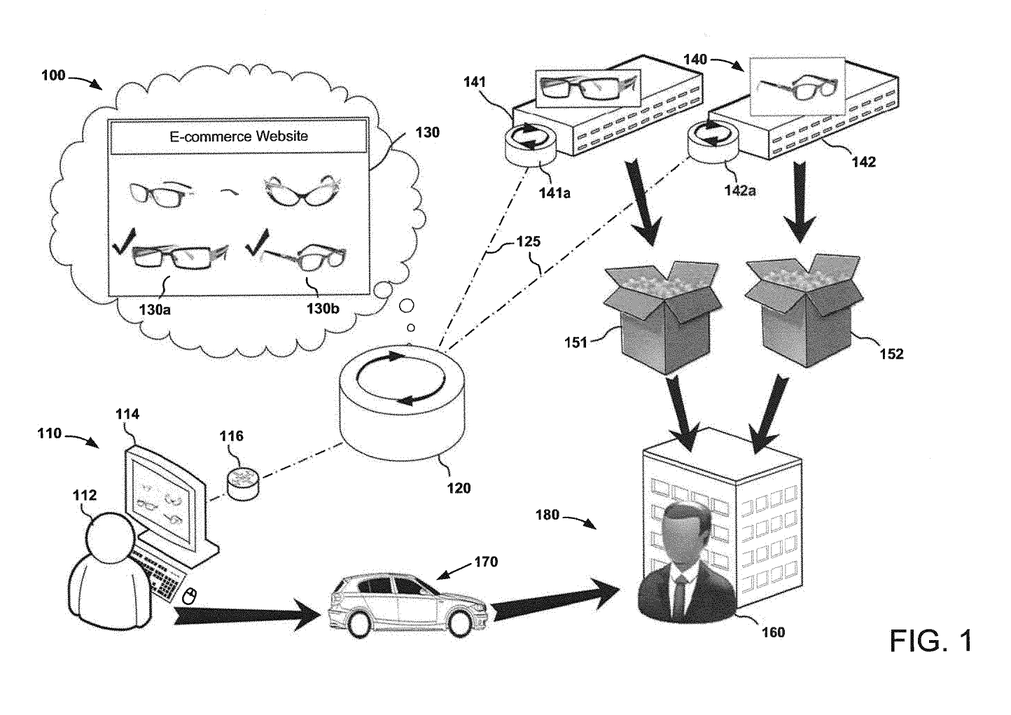

FIG. 1 is a diagrammatic view, illustrating a method of integrating e-commerce and retail commerce, according to at least one embodiment of the disclosure. At least one hybrid e-commerce server 120 provides the structure to implement the e-commerce integration method and system. It should be understood that the at least one hybrid e-commerce server 120 may represent a single server or multiple servers, with redundant functions for backup protection and/or distinct functions for improved network architecture, cloud-based capability, or any combination thereof. Further, server 120 may be embodied by a processor(s), mobile platform(s), or any other hardware/firmware, as known to one skilled in the art. Although not shown in FIG. 1, the at least one hybrid e-commerce server 120 may include a processor and a memory communicatively coupled to the processor. The memory may store instructions that, when executed by the processor, cause the processor to perform the operations of the at least one hybrid e-commerce server 120, as described with reference to FIGS. 1-13E.

During operation, a customer 112 browses an online selection of available product(s) 110 via the hybrid e-commerce platform 130, (exemplarily embodied here as a website) using an exemplary online device 114. In some embodiments, the at least one hybrid e-commerce server 120 may host the hybrid e-commerce platform 130. One such e-commerce integration system using hybrid e-commerce websites is Commercity™. Such hybrid e-commerce platform/website 130 (and/or the at least one hybrid e-commerce server 120) may be maintained (in which maintaining may include without limitation managing, owning, administering, overseeing, licensing, etc.) by a hybrid e-commerce provider (“HECP”). A HECP may maintain an individual hybrid e-commerce platform or multiple hybrid e-commerce platforms. Further, it should be understood that such hybrid e-commerce platforms may be branded for specific industries, such as through creation of white-label websites that may be customized with logos and other information for a particular product or category of product, a particular retailer, etc. An individual HECP may manage a hybrid e-commerce platform(s) 130 for a specific industry, or alternatively, many manage many hybrid e-commerce platform(s) 130 for multiple industries, whether under one brand or multiple brands. In the case of the optical industry, one such branded hybrid e-commerce platform is Commercity™. In other embodiments, the at least one hybrid e-commerce server 120 provides messaging content and/or an online catalog of products for display on a third party retailer's website, which is an exemplary method of allowing the third party retailer to maintain the look and feel of their proprietary brand and/or website, not shown. Look and feel includes visual aspects of the webpage, including color, layout, and other formatting characteristics, as well as branding information, such as logos, icons, etc. In other embodiments, the hybrid e-commerce platform 130 may be hosted on the at least one hybrid e-commerce server 120 but may still automatically adopt the look and feel of the third party's website/brand. Another exemplary method of integrating the third party website may be to forward customer 112 to the hybrid e-commerce platform 130. In some embodiments, one hybrid e-commerce platform may be created for a particular industry, e.g., optical industry, wherein the one website will integrate with all participating retailers/in-person providers. In some embodiments, the in-person provider (e.g., store retailer) may be able to manage and/or edit the product catalog and/or product pricing. In further embodiments, an in-person provider may have a webpage(s), or section thereof, with information about their retail business. In some embodiments, the in-person provider (e.g., retailer) may be restricted from changing the creative look and feel of the hybrid e-commerce platform 130, such as when there is a single industry-branded hybrid e-commerce website, such as Commercity™.

An online device 114 may be any device that allows customer 112 to access the Internet and browse to web pages using uniform resource locators (URLs). Such online devices 114 include, without limitation, a desktop computer, a laptop computer, a tablet computer, a smartphone, a Chromebook, a smart TV, a smart peripheral device for connection to a monitor/TV, or any other similar browsing device. The online device may connect to the Internet through any available wired or wireless network, including, without limitation, a connection to an Internet Service Provider (ISP) 116, or a cellular data connection (e.g., a 3^{rd} Generation (3G) cellular connection, a 4^{th} Generation (4G)/long term evolution (LTE) cellular connection, etc.), not shown.

Using the hybrid e-commerce platform 130, the customer 112 selects at least one product for an in-person inspection. In the exemplary embodiment of FIG. 1, the selected products are eyeglass frames 130a and 130b. It should be understood that no embodiment of the present disclosure is limited to a specific product, or a category of product. Instead, any product is within the scope of this disclosure. Exemplary products for use with the e-commerce integration method and system include, without limitation, all optical eyewear, audiology products, jewelry, all electronics, musical instruments, dental products, orthopedic products, and all medical products. Products that require additional tailoring (e.g., jewelry, clothes, etc.), adjusting (e.g., eyewear, orthopedics, and medical products), manufacturing (e.g., eyeglass lenses for eyeglass frames, custom painting, aftermarket accessories, etc.), and/or consultation (e.g., hearing aid fitting by an audiologist, jewelry appraisal by a jeweler, etc.) by an in-person provider are well suited for the various embodiments of the e-commerce integration method and system. Additionally, products that have shipment restrictions (e.g., firearms, which are restricted to shipment between dealers, alcohol, and/or tobacco,) and/or handling restrictions (e.g., certain medical or hazardous materials (HAZMAT)) are also well suited for the e-commerce integration method and system, since an in-person provider (i.e., a firearm dealer) is required for shipment or handling of the product. Another exemplary product category may include products where it is difficult for a retailer to maintain a large inventory (e.g., cost prohibitive), such as china collections, other fine dining products, or specialty fabrics.

It is noted that jewelry is frequently purchased as a gift, such as for a significant other. Often, it can be difficult selecting product that the recipient truly likes. Additionally, jewelry can be a more expensive gift, and once purchased and given, the recipient may not feel comfortable with returning if they do not like the gift. Purchasing jewelry via the hybrid e-commerce platform may alleviate some of these difficulties. For example, a customer can use consultation tools to search for items that match their and/or the recipients preferences. The customer can use a social rating and commenting functionality to request friends and family of the recipient to rate and comment on selected items. Then the customer can set up a showing event to bring the recipient to the jewelry retailer to try-on the selected product and see the comments and ratings of their friends and family on each item. For example, instead of a husband giving his wife a wrapped present on their anniversary, he could take her to dinner and surprise her with a showing event at local jewelry retailer that was set up just for her. The online consultation along with input from her friends and family could be used to select the product for her own special event. Further, the purchase will benefit from being made after having had an opportunity to have a skilled jeweler evaluate and appraise the items selected for the try-on event, as well as consulting on fitting adjustments that can be made, etc. Additionally, as a result of the consultation, or during the showing, complementary pieces of jewelry or collection pieces may be discussed, providing the jewelry retailer with an opportunity to upsell or cross market products to the customer.

As another example, a customer may visit the hybrid e-commerce platform (e.g., a web page) provided by the hybrid e-commerce server to select jewelry for try-on and/or purchase. Upon visiting the hybrid e-commerce platform, the customer may choose to participate in an online consultation that may collect customer preference information that may be used by the hybrid e-commerce platform to narrow and tailor the product(s) displayed to the customer by the hybrid e-commerce platform in order to help the customer efficiently choose the product best tailored to their preferences. In an embodiment, the product consultation may be provided via the hybrid e-commerce page. For jewelry, the consultation may be split up during the customer's flow through the website into a design/fashion consultation and a quality (e.g., cut, clarity, color, carat weight, a.k.a. the diamond 4Cs), and/or cost consultation. For example, the fashion/design consultation could determine preference data including but not limited to: who the jewelry is for; the recipients fashion preferences; type of jewelry (e.g., necklace, ring, bracelet, earring, etc.); material preference (gold, platinum, etc.), jewel preference (diamond, gemstone, pearl, etc.). The quality consultation could be used to establish the price range and quality that the customer would like selected products to be in. Consultation data and answers may be linked to an in-person provider web application which shares results, product recommendations, try-on selections, and/or social ratings with the in-person provider for an improved and informed in-person visitation.

The hybrid e-commerce platform provides the customer a catalog of products, preferably tailored to customer's preferences based on the consultation(s). If the customer did not participate in a consultation, the customer may still be able to browse a large selection of jewelry via the hybrid e-commerce platform, and make selections of particular jewelry for purchase or try-on at the in-person provider (jewelry retailer). Further, the customer may choose to use (or not use) any social media functionality (e.g., “My Looks”). The hybrid e-commerce platform allows the customer to share selected items with friends and family of the customer or recipient of the gift to attain their comments and ratings on the selected items. In this manner, the customer can attain social affirmation and be more confident on the item they purchase. As explained elsewhere herein, “My Looks” combines typical product wish list functionality with unique social media affirmation and rating functionality. Social media functionality may be integrated with the hybrid e-commerce platform (e.g., using an API) in order to provide known social media (Facebook, Twitter, Pinterest, Instagram, etc., or any combination thereof) capabilities to users of the hybrid e-commerce platform. In contrast to standard wish list functionality, the “My Looks” page allows the customer to request feedback from friends and family and to rate and comment on product(s) (e.g., jewelry), as well as the ability to save products for purchase, or try-on/inspection selection.

During checkout, the hybrid e-commerce server may schedule shipping of the selected jewelry to the partner in-person provider (jewelry retailer). When one or more of the particular jewelry items is to be shipped to the particular retailer, information indicating an expected shipping date, and expected arrival date may be provided to the customer. The platform may inform the retailer of the customer's order shipping information and provide a tracking link via the in-retail sales associate web application. Additionally, the hybrid e-commerce platform may provide the tracking link to the customer, and may also email the customer when the order is in and ready to be picked up. The customer may then visit the particular retailer to purchase, pick-up or try-on the particular jewelry. The hybrid e-commerce platform may also allow the customer to set up a try-on event at their in-person provider (jewelry retailer).

Following the purchase or in-person inspection, the hybrid e-commerce platform may utilize marketing automation software to create an ongoing shopping cycle with customers. The platform will profile customers using cumulative customer data and like browsing and purchasing behavior, as well as events including, but not limited to holidays, anniversary date, birth date, seasonal fashions, and sales and promotions combined with customer profiling to create an ongoing shopping cycle to keep the customer continually engaged with retailers partnered with the hybrid e-commerce server. Additionally, because the hybrid e-commerce server promotes in-person inspect, a relationship between the retailers and customer may become more personal, as opposed to marketing campaigns that attempt to get the customer to purchase a product online.

The salon and cosmetology industries are another example of an industries that may benefit from one or more aspects of the hybrid e-commerce platform. Hair care and styling is frequently disconnected from the purchase of products and styling tools even though many customers believe their hair looks best immediately after receiving care (e.g., a cut, color, blowout or styling). The hybrid e-commerce platform may be used to integrate sales of hair products and styling tools with the in-person care provider (salon). For example, the customer may set a hair appointment using scheduling tools provided by the hybrid e-commerce platform. If the customer does not have account preferences, they are asked if they would like their stylist (in-person provider) to inform them of what products and tools are used at their next appointment.

Additionally, upon visiting the hybrid e-commerce platform, the customer may choose to participate in an online consultation that may collect customer preference information that may be used by the in-person provider (stylist) to provide services (cut, color, blowout or styling) for the customer. The hair care consultation may be split into a hair type (customer self identifies hair type e.g., fine, thick, oily, dry, etc.) and a fashion consultation where the customer identifies fashion preference and desired hair looks. In an embodiment, the fashion consultation tool may be combined with a virtual try-on tool to provide the customer with a meaningful way of viewing and selecting hair styles, colors and other treatments to their hair. The customer can virtually apply different hair styles and treatments to an image of their face. Identification of their hair type may be used to narrow the different hair style and treatment options they can choose from; preferably tailored to customer's preferences and hair type. Or if the customer did not participate in the consultation, they may browse a large selection of styles and treatment options via the hybrid e-commerce platform.

Further, the customer may choose to use (or not use) the social media functionality (e.g., “My Looks”). The hybrid e-commerce platform may allow the customer to share virtual try-on images of hair options (e.g., “looks”) with friends and family to attain comments and ratings on the selected “looks”. This way, the customer can attain social affirmation and be more confident on hair services and treatments they chose. “My Looks” for hair care is a new take on wish list functionality capturing the customers desired hair look with unique social media affirmation and rating functionality. The social media functionality may be provided by the hybrid e-commerce platform using integrated APIs and known social media (Facebook, Twitter, Pinterest, Instagram, etc., or any combination thereof). The “My Looks” page allows the customer to request feedback from friends and family and to rate and comment on “looks” for the customer's hair.

Consultation data, customer preferences and social comments and ratings are linked to an in-person provider web application which shares results, preferences, and/or social ratings with the in-person provider for an improved and informed in-person servicing. The customer may self-identify their desired look and service treatments to the hybrid e-commerce platform with assistance from the social sharing, and this information may be provided to the in-persons provider (e.g., hair stylist). This may minimize misinterpretation between a customer and their in-person provider of what they desire (e.g., by replacing the customer's description of the desired look in words with an image of the desired look). The customer may also request to be informed of the products and styling tools are used during the servicing. This may remove the socially awkward step of the in-person provider trying to push products onto their customers, and the information may be communicated to the in-person provider via the in-person provider web application. At or after the hair appointment, the in-person provider may provide inputs to the hybrid e-commerce platform via the in-person provider web application the product and styling tools used during the appointment via the in-person provider web application. In an embodiment, if the in-person provider does not provide inputs regarding the products and styling tools used during the appointment, the hybrid e-commerce platform may recommend (e.g., via e-mail, text messaging, or other marketing tools provided via the hybrid e-commerce platform) products and styling tools to the customer, where the recommended products and styling tools correspond to products and styling tools offered by the in-person provider. The customer will have multiple purchase options. If the hair product and styling tools are in-stock in the salon, the customer can purchase during their visit. They can also purchase post hair appointment online at the hybrid e-commerce website. The hybrid e-commerce platform may use marketing automation software to contact the customer (e-mail and/or text), inform them of the hair product and possibly styling tools used, and link them to the hybrid e-commerce website where they can purchase products.

Additionally, the hybrid e-commerce platform may utilize marketing automation software to increase frequency of hair care appointments, and to create an ongoing shopping cycle with customers. The platform will establish a hair care maintenance schedule for customers and contact them via email and/or text to schedule appointments in a more routine manner The platform may also use data on hair product quantity and usage amount to establish a replenishment schedule for customers and contact them via email and/or text to increase reorder frequency. E-mails and text communications may be used to link the customer to the hybrid e-commerce website for appointment scheduling and product purchasing. The hybrid e-commerce platform may also utilize salon events and promotions in marketing automation efforts. With the hybrid e-commerce platform customers will benefit from the hybrid commerce model of online consultations, virtual try-ons, social participation, commenting and ratings, and the in-person provider skills (hair stylist/cosmetologist).

The hybrid e-commerce server and the hybrid e-commerce platform may be utilized to provide additional advantages and benefits in other industries as well. For example, medical device manufacturers and distributors may partner with a hybrid e-commerce provider (HECP) to provide for the sale of medical devices using the hybrid e-commerce platform. In an exemplary use case, a customer may visit the hybrid e-commerce platform (e.g., a web page) provided by the hybrid e-commerce server to select medical devices for try-on and/or purchase. Upon visiting the hybrid e-commerce platform, the customer may choose to participate in an online consultation. The consultation may collect customer preference information that may be used by the hybrid e-commerce platform to narrow and tailor the product(s) displayed to the customer by the hybrid e-commerce platform in order to help the customer efficiently choose the product best tailored to their preferences. In an embodiment, the product consultation may be provided via the hybrid e-commerce page. In the context of hearing aids, the consultation could determine preference data including but not limited to: costs, battery life, fit, visual appearance. The consultation may also be used to educate customers on the different technologies used, to provide customer feedback (ratings and reviews), and to collect customer preferences.

The hybrid e-commerce platform may provide the customer a catalog of products, preferably tailored to customer's preferences. If the customer did not participate in the consultation or specify any preferences, the customer may browse a large selection of medical devices via the hybrid e-commerce platform, and may make selections of particular medical device for purchase or try-on at the in-person provider. In an embodiment, consultation data and answers may be linked to an in-person provider web application which shares results, product recommendations, try-on selections, and/or social ratings with the in-person provider for an improved and informed in-person visitation. Further, the customer may choose to use (or not use) any social media functionality to share selected items with friends and family to attain their comments and ratings on the selected items. Such functionality may be provided via a wish list with social commenting application provided by the hybrid e-commerce platform. In an embodiment, the wish list with social commenting application may operate in a manner that is similar to the “My Looks” functionality, but, instead of providing for virtual try-on of products, the wish list with social commenting application may allow the customer to obtain feedback from known associates. In an embodiment, feedback provided to the customer via the wish list with social commenting application may be limited to feedback received from other customers that have purchased and/or used the product that the customer is seeking feedback on. For example, if the customer lists a particular brand and model of hearing aid on his/her using the wish list with social commenting application, feedback may be limited to comments and ratings provided by others that have purchased/used the particular brand and model of hearing aid. In another embodiment, feedback provided to the customer via the wish list with social commenting application may be limited to persons associated with, or known to the customer. By limiting feedback to persons that have purchased and/or used the particular product, or by limiting feedback to persons affiliated with the customer, the customer may be more confident in the feedback, and the feedback may be more credible to the customer. This way, the customer can attain social affirmation, ask for direct feedback on products from people they know and be more confident on the item they purchase. In the context of medical devices, the “My Looks” functionality (e.g., the wish list with social commenting application) may allow the customer to request feedback from friends and family, and to ask if they have experience with any of the medical devices selected.

During checkout, the hybrid e-commerce server may schedule shipping of the selected medical devices to the partner in-person provider. When one or more of the particular medical devices is to be shipped to the particular retailer, information indicating an expected shipping date, and expected arrival date may be provided to the customer. The platform will inform the retailer of the customer's order shipping information and provide a tracking link via the in-retail sales associate web application. Additionally, the hybrid e-commerce platform may provide the tracking link to the customer, and may also email the customer when the order is in and ready to be picked up. The customer may then visit the particular retailer to purchase, pick-up or try-on the medical device. The hybrid e-commerce platform may also allow the customer to set up an appointment at their in-person provider.

By using the hybrid e-commerce platform, the customer is able to use the consultation tools and social rating and commenting functions to aid in selection of product for in-retail try-on. When the customer visits the in-person provider to try-on and/or inspect, the customer may be more likely to purchase the medical devices during this visit (e.g., due to social affirmation of the selected products). The hybrid e-commerce platform may utilize marketing automation software to create an ongoing maintenance and check-up cycle with customers. With hearing aids for example, the platform may establish a check-up and maintenance schedule for customers, and may contact them via email and/or text to schedule appointments in a more routine manner. The platform may also use data on battery life and other wear parts to establish a reorder schedule for customers, and contact them via email and/or text to improve product maintenance. Emails and text communications may also link customer to the hybrid e-commerce website for appointment scheduling and product purchasing.

In the firearm industry, the quantity of firearm options has increased creating an inventory issue for firearm retailers, especially those with smaller store footprints in rural areas. Also, first time gun ownership has recently increased, creating a larger demand for first time owners to be educated on firearm and ammunition options. With the hybrid e-commerce platform, customers will benefit from the hybrid commerce model of online consultations, social participation, commenting and ratings, in-retail product inspection, and the licensed sale of the in-person provider (firearm retailer). Firearm and ammunition manufacturers and distributors may partner with a hybrid e-commerce provider (HECP) to provide for the sale of firearms and ammunition using the hybrid e-commerce platform.

To illustrate, a customer may visit the hybrid e-commerce platform (e.g., a web page) provided by the hybrid e-commerce server to select firearms for inspection and/or purchase. Upon visiting the hybrid e-commerce platform, the customer may choose to participate in an online consultation to collect customer preference information that may be used by the hybrid e-commerce platform to narrow and tailor the product(s) displayed to the customer by the hybrid e-commerce platform in order to help the customer efficiently choose the product best tailored to their preferences. In an embodiment, the product consultation may be provided via the hybrid e-commerce page. Regarding firearms, the consultation could determine preference data including but not limited to: usage, ammunition caliber, size, type, etc. The consultation may also be used to educate customers (including but not limited to different ammunition calibers, gun recoil, technology, etc.), provide customer feedback (ratings and reviews), and to collect customer preferences.

The hybrid e-commerce platform may provide the customer a catalog of products, preferably tailored to customer's preferences, or if the customer did not participate in the consultation or specify preferences, may allow the customer to browse a large selection of firearms via the hybrid e-commerce platform. The customer may make selections of particular firearms for purchase or inspection at the in-person provider (licensed firearm retailer). Further, the customer may choose to use (or not use) any social media functionality (e.g., the wish list with social commenting application) to share selected items with friends and family, and to obtain their comments and ratings on the selected items. In an embodiment, feedback provided to the customer via the wish list with social commenting application may be limited to persons associated with, or known to the customer, and/or to persons that have purchased and/or used the particular product (e.g., the firearm) the customer is contemplating purchasing. By limiting feedback to persons that have purchased and/or used the particular product, or by limiting feedback to persons affiliated with the customer, the customer may be more confident in the feedback, and the feedback may be more credible to the customer. In this manner, the customer obtains social affirmation, and can also ask for direct feedback on products from people they know and be more confident on the item they purchase.

Consultation data and answers are linked to an in-person provider web application which shares results, product recommendations, inspection selections, and/or social ratings with the in-person provider for an improved and informed in-person visitation. During checkout, the hybrid e-commerce server may schedule shipping of the selected firearms to the partner in-person provider (licensed firearm retailer). When one or more of the particular firearms is to be shipped to the particular retailer, information indicating an expected shipping date, and expected arrival date may be provided to the customer. The platform will inform the retailer of the customer's order shipping information and provide a tracking link via the in-retail sales associate web application. In an embodiment, the hybrid e-commerce platform may provide the tracking link to the customer, and may also email the customer when the order is in and ready to be picked up. The customer may then visit the particular retailer to purchase, pick-up or inspect the particular firearm. The hybrid e-commerce platform may also allow the customer to set up an appointment at their in-person provider (licensed firearm retailer).

The hybrid e-commerce platform may utilize marketing automation software to create an ongoing shopping cycle with customers. The platform may profile customers using cumulative customer data and like browsing and purchasing behavior. The hybrid e-commerce platform may utilize events including, but not limited to seasonal uses, hunting events, sales and promotions combined with customer profiling to create an ongoing shopping cycle. The platform may also use data on ammunition quantity and usage to establish a replenishment schedule for customers, and contact them via email and/or text to increase ammunition reorder frequency. Emails and text communications may link customer to the hybrid e-commerce website for product purchasing.

As another example, of an industry that may benefit from the hybrid e-commerce platform, wigs and hairpieces are items customers may want to try-on before they purchase. Wig and hairpiece manufacturers prefer not to ship to customer's homes for try-on, as they do not want the products worn for more than a try-on period. Using the hybrid e-commerce platform to facilitate the try-on and purchase of wigs and hairpieces, customers benefit from proper fitting from a skilled in-person provider (wig and hairpiece retailer). For example, wig and hairpiece manufacturers and distributors may partner with a hybrid e-commerce provider (HECP) to provide for the sale of wigs and hairpieces using the hybrid e-commerce platform. A customer may visit the hybrid e-commerce platform (e.g., a web page) provided by the hybrid e-commerce server to select hairpieces for try-on and/or purchase. Upon visiting the hybrid e-commerce platform, the customer may choose to participate in an online consultation that collects customer preference information that may be used by the hybrid e-commerce platform to narrow and tailor the product(s) displayed to the customer by the hybrid e-commerce platform, thereby assisting the customer to efficiently choose the product best tailored to their preferences. Preferences may include, but are not limited to, synthetic or human hair, color, style, partial or full piece, fashion preferences, etc. In an embodiment, the product consultation may be provided via the hybrid e-commerce page.

Further, the customer may choose to use (or not use) the social media functionality (e.g., “My Looks”), which may allow the customer to share virtual try-on images of hair options “looks” with friends and family to attain comments and ratings on the selected “looks.” In this manner, the customer can attain social affirmation and be more confident on wig or hairpiece purchases. Consultation data, customer preferences and social comments and ratings are linked to an in-person provider web application which shares results, preferences, and/or social ratings with the in-person provider for an improved and informed in-person servicing. During checkout, the hybrid e-commerce server may schedule shipping of the selected wigs and/or hairpieces to the partner in-person provider (retailer). When one or more of the particular hairpiece is to be shipped to the particular retailer, information indicating an expected shipping date, and expected arrival date may be provided to the customer. The platform will inform the retailer of the customer's order shipping information and provide a tracking link via the in-retail sales associate web application. In an embodiment, the hybrid e-commerce platform may provide the tracking link to the customer, and may also email the customer when the order is in and ready to be picked up. The customer may then visit the particular retailer to purchase, pick-up or inspect the particular hairpiece. The hybrid e-commerce platform may also allow the customer to set up an appointment at their in-person provider (retailer).

The hybrid e-commerce platform may utilize marketing automation software to create an ongoing shopping cycle with customers. The platform may profile customers using cumulative customer data and like browsing and purchasing behavior. The hybrid e-commerce platform will utilize events including, but not limited to seasonal fashions, holidays, sales and promotions combined with customer profiling to create an ongoing shopping cycle.

The bridal industry is yet another example of an industry where embodiments of the hybrid e-commerce platform may provide unique advantages to customers. For example, wedding dresses are items customers want to try-on before they purchase. This is because the customer benefits from a proper fitting by a skilled in-person provider (e.g., a bridal retailer). However, dress manufacturers prefer not to ship to customers' homes for try-on, as they do not want the products worn for more than a try-on period. Dress manufacturers and distributors may partner with an HECP to provide for the sale of dresses using the hybrid e-commerce platform. With the hybrid e-commerce platform, customers will benefit from the hybrid commerce model of online consultations, social participation, commenting and ratings, and the in-person provider skills.

For example, a customer may visit the hybrid e-commerce platform (e.g., a web page) provided by the hybrid e-commerce server to select dresses for try-on and/or purchase. Upon visiting the hybrid e-commerce platform, the customer may choose to participate in an online consultation to collect customer preference information that may be used by the hybrid e-commerce platform to narrow and/or tailor the product(s) displayed to the customer by the hybrid e-commerce platform, which may help the customer more efficiently choose the product(s) best tailored to their preferences. Preferences identified by the consultation may include, but are not limited to, dress style, material, sleeve style, fashion elements, color, price range, etc. In an embodiment, the product consultation may be provided via the hybrid e-commerce page.

Further, the customer may choose to use (or not use) the social media functionality (e.g., “My Looks”) that allows the customer to share virtual try-on images of dress options (e.g., “looks”), and/or just images of the dress options with friends and family to attain comments and ratings on the selected “looks.” In this manner, the customer can attain social affirmation and be more confident on dress selections/purchases. “My Looks” for dress shopping is a new take on wish list functionality capturing the customers desired bridal look with unique social media affirmation and rating functionality. The social media functionality may be provided by integrating (e.g., using an application programming interface (API)) the hybrid e-commerce platform with known social media (e.g., Facebook, Twitter, Pinterest, Instagram, etc., or any combination thereof). The “My Looks” page allows the customer to request feedback from friends and family, and to rate and comment on “looks” for the customer's wedding dress options.

Consultation data, customer preferences and social comments and ratings are linked to an in-person provider web application which shares results, preferences, and/or social ratings with the in-person provider for an improved and informed in-person servicing. During checkout, the hybrid e-commerce server may schedule shipping of the selected dresses to the partner in-person provider (e.g., the bridal retailer). When one or more of the particular dresses is to be shipped to the particular retailer, information indicating an expected shipping date, and expected arrival date may be provided to the customer. The platform will inform the retailer of the customer's order shipping information and provide a tracking link via the in-retail sales associate web application. In an embodiment, the tracking link may be provided to the customer, and the hybrid e-commerce platform may email the customer when the order is in. The customer may then visit the particular in-person provider to purchase, pick-up or inspect the particular dress. The hybrid e-commerce platform may also allow the customer to set up an appointment at their in-person provider. Using the hybrid e-commerce platform, the customer is able to use the consultation tools and social rating and commenting functions to aid in selection of product for in-retail try-on. Thus, the customer may visit the in-person provider to try-on, pick-up and purchase a dress during this visit. The hybrid e-commerce platform may utilize marketing automation software to solicit friends and family of the customer for bridal and dress services.

In some embodiments, the at least one hybrid e-commerce server 120 may query customer 112 for a location for the in-person inspection. The at least one hybrid e-commerce server 120 may also locate or assist in locating an in-person provider for customer 112. The in-person inspection may be performed at any location, including, without limitation, the customer's location (e.g., home, office, post office box, etc.) or at an in-person provider. Frequently, the in-person provider is a person(s) capable of providing the customer with additional service(s) and/or product(s). In the exemplary eyewear embodiment, the in-person provider 160 may be any eye care provider (“ECP”, which may include opticians, optometrists, and/or ophthalmologists) that preferably retails eyewear in conjunction with their practice. The customer 112 may receive an optical refraction from any of the three types of eye care providers, and further, may receive additional medical services from the optometrist and ophthalmologist. Further, the ECP may provide an in-store shop with eyewear and other related products for purchase. As such, the online shopping experience 110 is intertwined with additional services and/or products offered by the in-person provider 160. Alternatively, customer 112 may choose to skip the in-person provider, and instead, purchase at least one product directly from of the hybrid e-commerce platform 130.

In most embodiments, the hybrid e-commerce platform 130 is configured to optionally allow customer 112 to purchase a product(s) directly from the hybrid e-commerce platform 130 without inspecting the product, where the product may be shipped directly to customer 112, bypassing in-person provider 160. Such examples include where customer 112 is already affiliated with the hybrid e-commerce platform 130 or, in the case of the optical industry, already has a prescription (Rx) for eyeglasses (or affiliated with the in-person provider 160). In most embodiments, the hybrid e-commerce platform 130 is capable of receiving (e.g., upload) prescriptions (or other similar permission requirements, especially in other industries), thereby allowing customer 112 to purchase directly from the hybrid e-commerce platform 130.

Upon receipt of a shipping location for the in-person inspection of at least one selected product, the at least one hybrid e-commerce server 120 sends a message(s) 125 to a product provider, which may include, without limitation, a fulfillment center 141, a wholesale provider 142, and/or a product manufacturer 743, depending upon the origin of the product immediately prior to shipment, in this case, eyeglass frames 130a and 130b. The present disclosure should not be limited based upon the entity that provides (i.e., manufacturers, stores, and/or ships) the product. Further, intermediate shippers, intermediate wholesalers, and other intermediaries are within the scope of this disclosure but not shown in FIG. 1. If there is more than one product provider, the product providers do not have to be related business entities. The server message(s) 125 may include any message format (e.g., extensible markup language (XML)/markup language, Javascript/script language, structured query language (SQL), hypertext markup language (HTML) 5/JavaScript running in a browser, Android/iOS/Windows Mobile-based native mobile application or “app”, etc.) suitable for communication between the at least one hybrid e-commerce server 120 and product provider servers 141a and 142a.

The product provider(s) 141 and 142 ship their respective products, 130a and 130b, using shipping methods to the in-person provider for inspection by customer 112. Any shipment method may be used, depicted in FIG. 1 as packages 151 and 152, including a fulfillment center, ground freight, air freight, government postal services, private parcel services (e.g., FedEx®, UPS®, etc.) or future delivery methods (e.g., drone delivery). In many embodiments, the details of the shipment of products 130a and 130b may be communicated back to the hybrid e-commerce server 120 by product provider servers 141a and 142a. Product provider servers 141a and 142a may be any scheduling server, fulfillment center server, supply-chain management server, or combination thereof. In many embodiments, hybrid e-commerce server 120 notifies the in-person provider 106 that the product(s) have shipped. Such notification may be by email or a server message 125 from the at least one hybrid e-commerce server 120 to any professional scheduling software or scheduling server 520 used by the in-person provider, 160. The hybrid ecommerce platform 130 may include one or more APIs for integrating with known email marketing software/platforms (marketing automation software), including SAAS. It should be understood that any email software service may be used or integrated with the hybrid e-commerce server 120, including without limitation exemplary platforms such as Constant Contact®, Exact Target®, Bronto®, eCircle®, Evergage®, eWayDirect®, Keymail, Listrak, SimpleRelevance®, UpSellit Email Remarketing, and Ve Interactive.

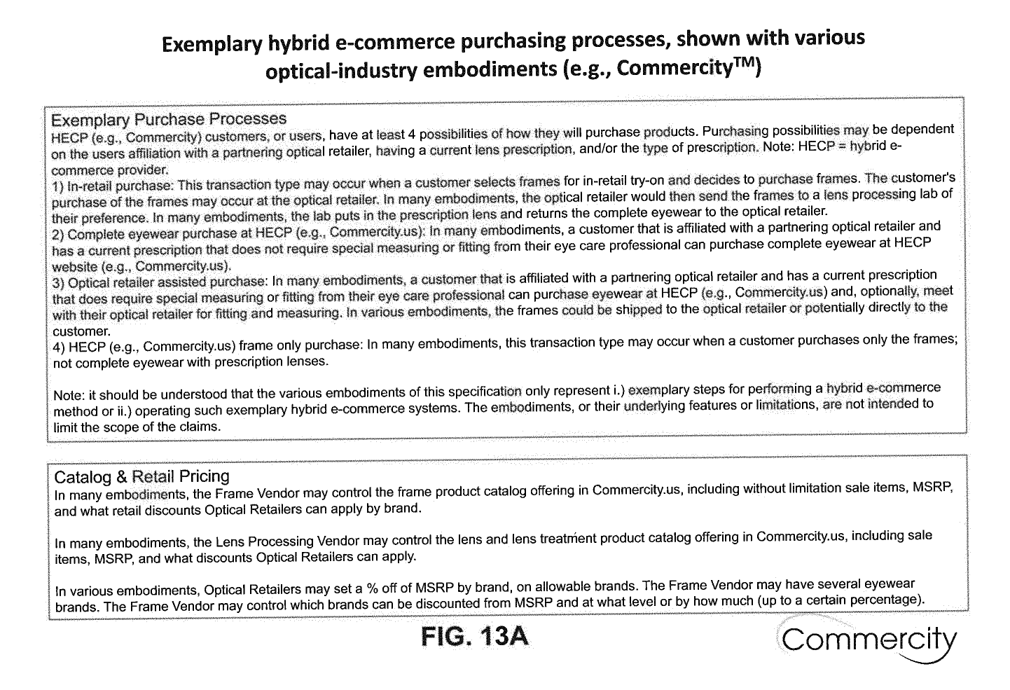

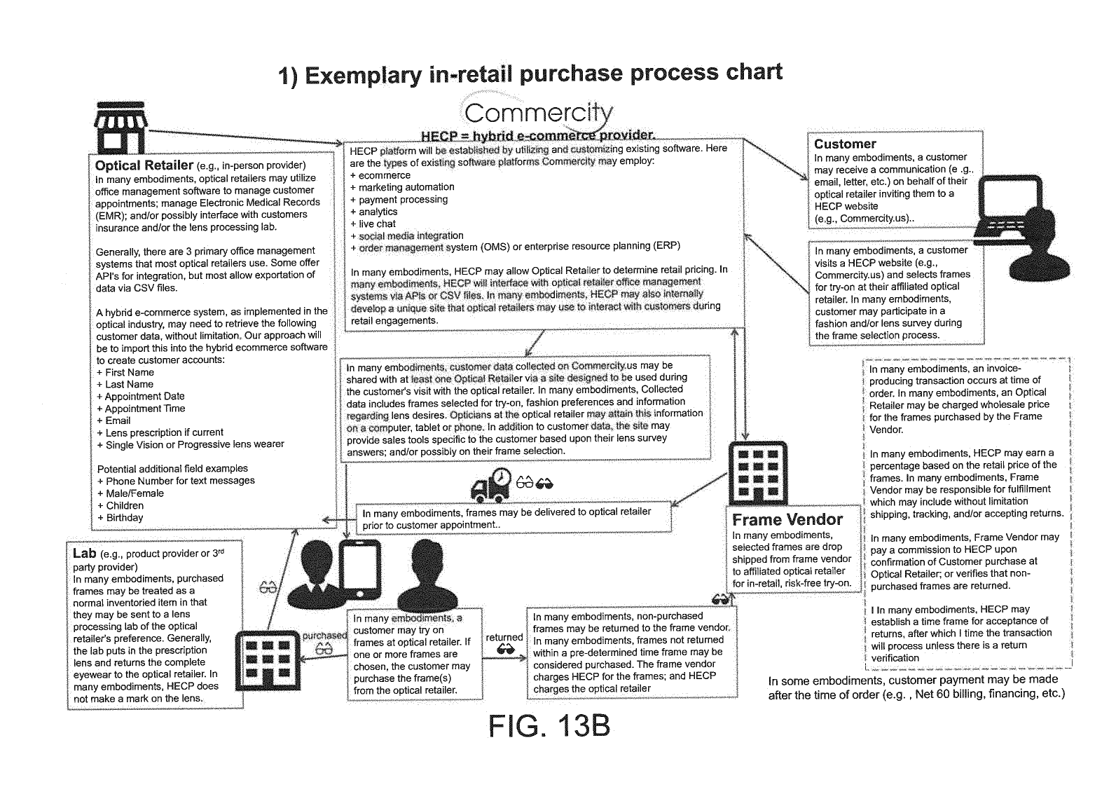

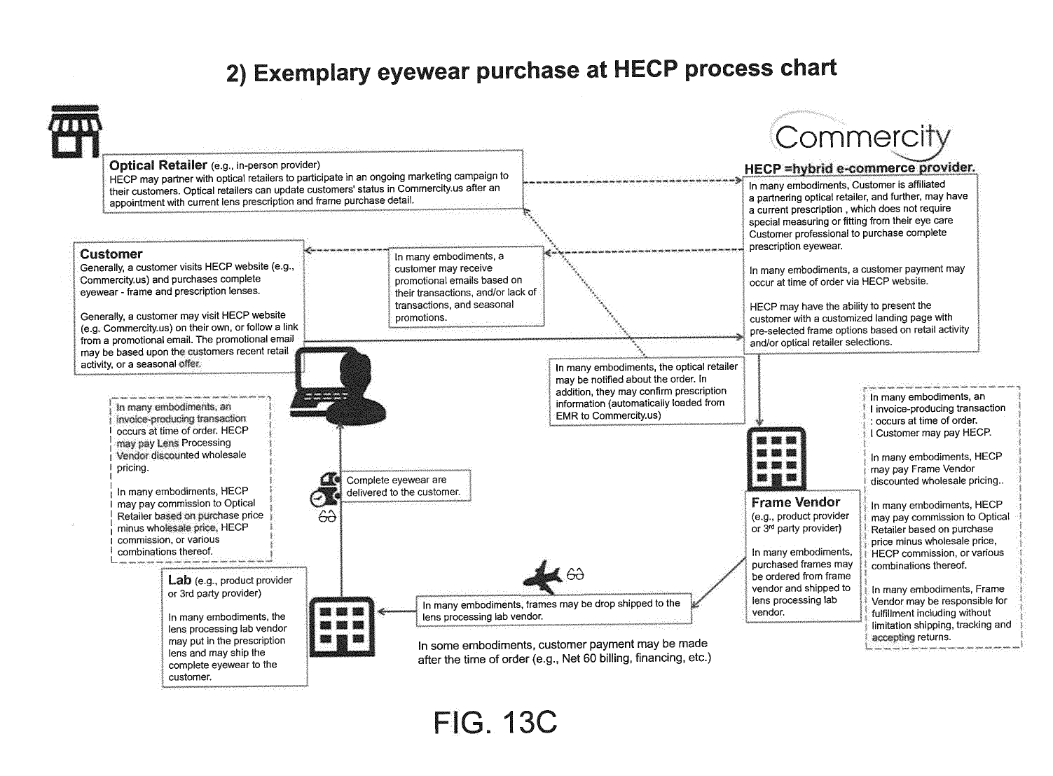

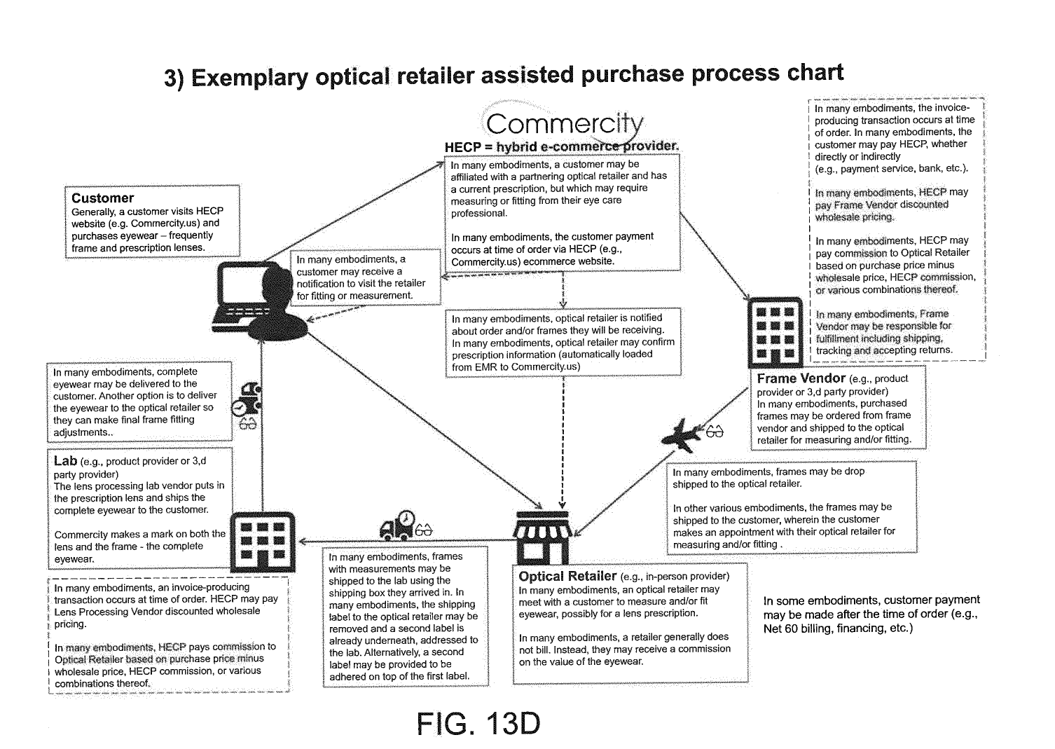

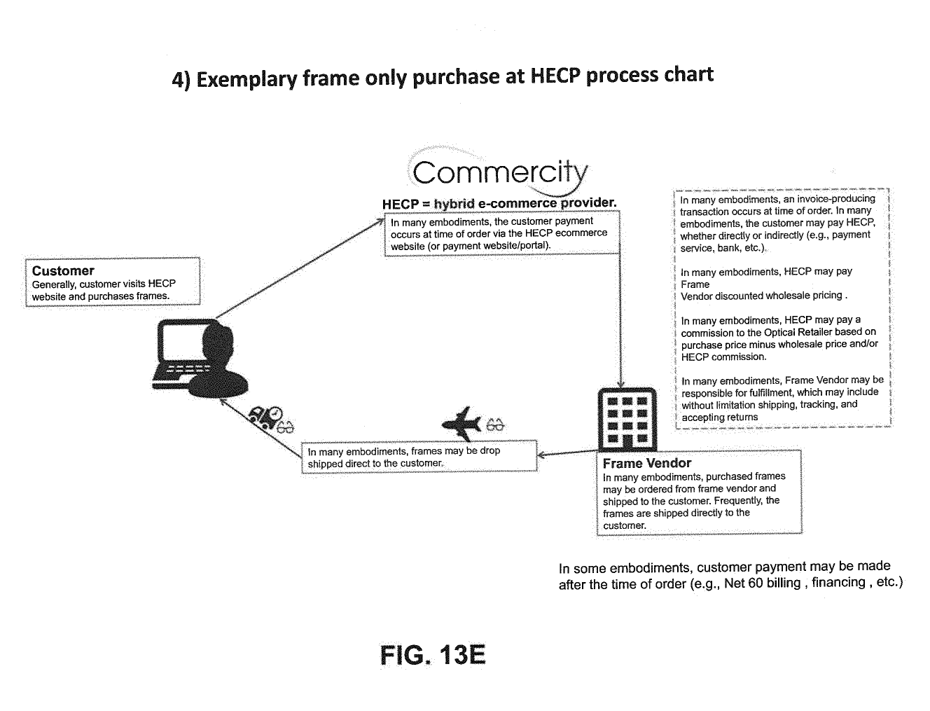

In many embodiments, customer 112 receives a communication to visit their in-person provider 160 (e.g., an appointment reminder, a request to schedule an appointment/visit, a marketing campaign, etc.). In particular, a communication may be sent to remind customer 112 to schedule an appointment. The initial appointment (or visit) may be limited to a consultation with the in-person provider 160 without an inspection of the product (e.g., such as when customer 112 has not yet shopped for any product using the hybrid e-commerce platform 130). In the case of the optical industry, the appointment may be to check vision, renew an expired prescription, shop products in the provider's 160 store. Alternatively, customer 112 may have visited the hybrid e-commerce platform 130 and selected product(s) for inspection prior to the initial appointment with in-person provider 160, where the product(s) is shipped and available for inspection at the time of the initial appointment. In cases where customer 112 has not selected product(s) for inspection from the hybrid e-commerce platform 130, an additional appointment may be required for the inspection of the product(s). In such cases, customer 112 may schedule the subsequent appointment with in-person provider 160 during the initial appointment. Alternatively or additionally, the subsequent inspection appointment may be linked to customer 112 selecting product(s) for inspection from the hybrid e-commerce platform 130. In some embodiments, the status of the product(s) (e.g., product order has been received, product is about to ship, product has shipped, etc.) may be used to prompt and/or refine the scheduling of inspection 180. Additionally, following the initial appointment, communications may be sent to customer 112 to visit website 130, select product(s) for inspection, schedule another appointment, or any combination thereof, and as further illustrated in FIGS. 13A-E. Scheduling may be performed by the in-person provider's scheduling services (including third party services), the hybrid e-commerce platform, or any combination thereof. The hybrid e-commerce platform 130 may include an application programming interface (API) for integrating with known scheduling software/platforms, including but not limited to SAAS modeling software.

In many embodiments, customer 112 travels 170 to the location of the in-person provider 160 in order to inspect 180 the products. In embodiments, customer 112 will receive face-to-face feedback from in-person provider 160 during the inspection 180. For example, and in the case of eyewear, an optician or optometrist 160 may perform an initial fitting of the selected eyeglass frames, 130a and 130b. Further, optician or optometrist 160 may discuss lens options for the eyeglass frame(s).

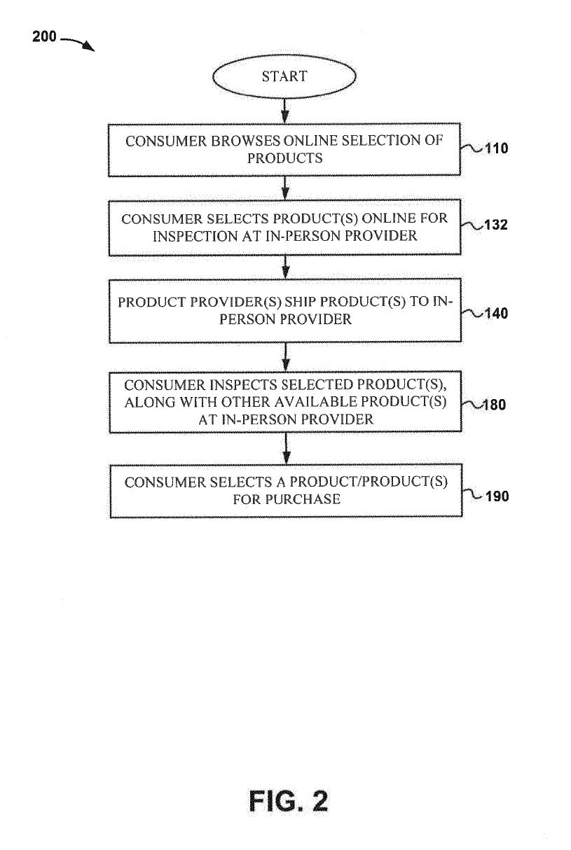

FIG. 2 is a flow chart, illustrating a method of integrating e-commerce and retail commerce, according to at least one embodiment of the disclosure. The method 200 begins at block 110, where a customer uses a hybrid e-commerce platform (e.g., an on-line webpage with a product catalog) to browse a selection of available product(s). In an aspect, the e-commerce platform may be the hybrid e-commerce platform 130 of FIG. 1. At block 132, the customer selects at least one product(s), which the customer would like to inspect in-person. At the time of selection, the customer has not yet elected to purchase any of the selected product(s) and has not been charged for the product(s). At block 140, the product provider(s) ships the selected product(s) to an in-person provider. At block 180, the customer inspects the selected product(s) at the in-person provider. Most notably, the sale of the selected product, at 190, occurs after the customer has the ability to inspect the product in block 180.

Using, the hybrid e-commerce platform, the method of FIG. 2 provides the customer with the benefits of traditional e-commerce services (e.g., large selection of products accessible from anywhere) and brick-and-mortar retail services (e.g., the ability to touch, feel, inspect, try on, etc.) without the drawbacks of the respective services. For example, in a traditional e-commerce setting, the customer is required to purchase the product without having an opportunity to touch, feel, inspect, or try on the product. When the product arrives, the customer may not be satisfied with the appearance, feel, look, fit, etc. of the product, which may look different from the product as presented by the e-commerce website. In the brick-and-mortar retail setting, the customer may visit a retail store looking for a particular product, but the retail store may not have the particular product in stock, or may not have the size of the particular product that the customer desires. Thus, the customer must visit a second retail store to see if that store has the particular product the customer is looking for. These scenarios can be a frustrating experiences for customers. In contrast, the method of FIG. 2 enables the customer to select products from among a large selection of products provided via the hybrid e-commerce platform, and to inspect the selected products in-person before purchasing one or more of the selected products. Thus, when the customer visits the retail store, the selected products are available, thereby eliminating visits to retail stores that are out of stock, or that do not have the size of the product that the customer desires. Additionally, because the customer is provided with the opportunity to touch, feel, inspect, or try on the product, the likelihood that the customer will be satisfied with the product and purchase the product is increased.

The hybrid e-commerce platform may also provide advantages other than allowing the customer to touch, feel, inspect, and try on products before providing payment for the product. For example, many customers are hesitant to purchase jewelry online because they are not certain of the quality of the materials that the jewelry is made from, such as the total carat weight of gem stones in a piece of jewelry, the quality of the gem stones, etc. In a jewelry purchase scenario, the customer may select one or more jewelry items for appraisal by a gemologist (e.g., a gemologist of chosen by the customer or suggested by the hybrid e-commerce platform). Thus, the customer is able to obtain a qualified opinion (e.g., an appraisal of the jewelry) for products purchased via the hybrid e-commerce platform prior to providing payment. Additionally, the in-person inspection may be performed at a location where the gemologist is located, so that the customer can visually inspect the jewelry to determine whether the jewelry fits and is pleasing to the customer eye when worn. Furthermore, the hybrid e-commerce platform may allow jewelry retailers to carry a larger selection of jewelry pieces than they normally would be able to maintain on hand. For example, a jewelry retailer may carry a first number of jewelry items as on-hand items at a physical location, such as a brick-and-mortar retail store location, and a second number of jewelry items as virtual items that may be viewed and purchased via the hybrid e-commerce platform. Thus, the jewelry retailer is able to carry a wider selection of jewelry items with having to incur costs for keeping the virtual jewelry items on-hand. This may enable the jewelry retailer to capture sales from a greater number of customers, thereby increasing the jewelry retailers revenues.

The hybrid e-commerce platform may also provide customers with an ability to obtain qualified opinions (other than a jewelry appraisal) for other industries. For example, in the optical industry, the customer may receive an eyewear frame fitting, measurements for a prescription, etc. during an in-person inspection. This may enable the customer to select a pair of eyewear frames that are comfortable to wear and that provide the proper fit and vision corrections that the customer requires, thereby increasing the customers satisfaction with the purchase of the eyewear frames. In a firearms setting, the customer may visit a licensed firearms dealer for in-person inspection of a firearm purchased from the hybrid e-commerce platform. During the in-person inspection, the customer may verify that the firearm satisfies the customer's preferences for size, feel, look, quality, etc., and the licensed firearms dealer may perform any background checks required by government regulations, and may provide the customer with training on how to use the firearm and/or upsale the customer on accessories for the firearm, some of which may have been designated for in-person inspection by the customer using the hybrid e-commerce platform. As yet another example, alcoholic beverage sales are restricted to entities that have obtained a license to sale and/or distribute alcoholic beverages. The hybrid e-commerce platform may provide for in-store pickup of alcoholic beverage purchases at a licensed alcoholic beverage retailer/distributor. Thus, the hybrid e-commerce platform may provide for new types of e-commerce purchases (e.g., purchases of goods that require a special license, such as firearms, and purchases of goods that are restricted by government regulations, such as alcoholic beverages).

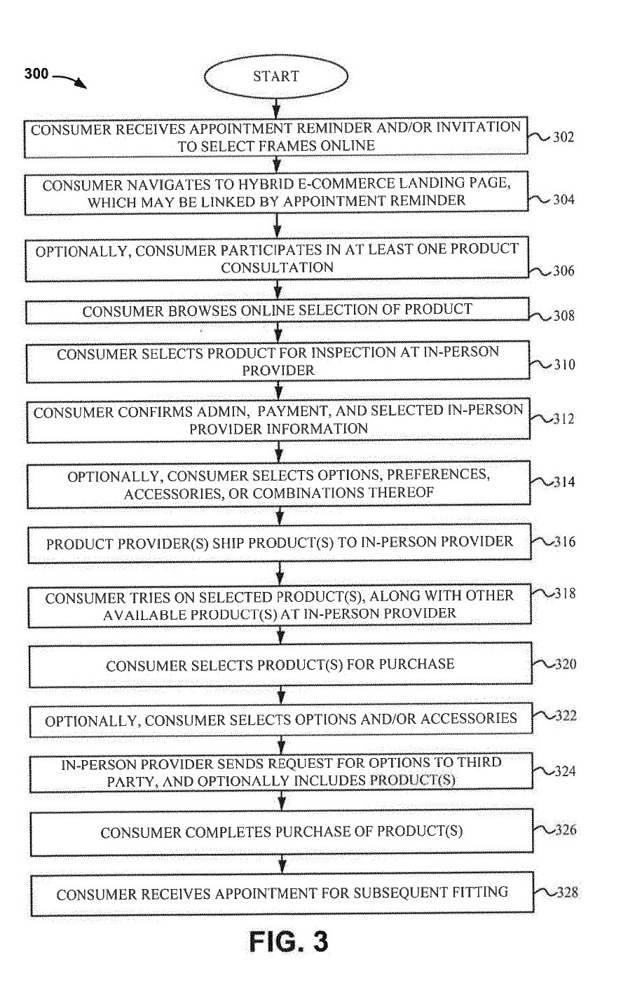

FIG. 3 is a flow chart, illustrating a method of integrating e-commerce and retail commerce as related to the eyewear market, according to at least one embodiment of the disclosure. It should be noted that the eyewear market is only one exemplary market in which method 300 may be used. Method 300 may be used in nearly any product market, including those discussed in paragraph 024 and elsewhere herein. In most embodiments, method 300 begins at block 302, where, optionally, a customer receives a communication (e.g., an appointment reminder, marketing campaign, request to schedule an appointment/visit, an e-mail message, a text message, etc.) prompting the customer to a visit to their ECP, as described in paragraph 030 and elsewhere herein.

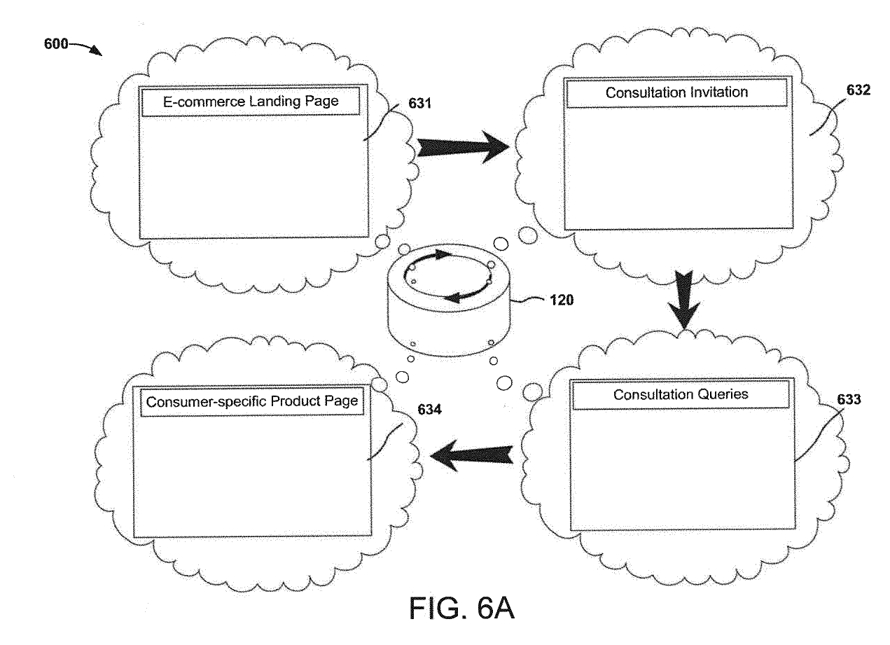

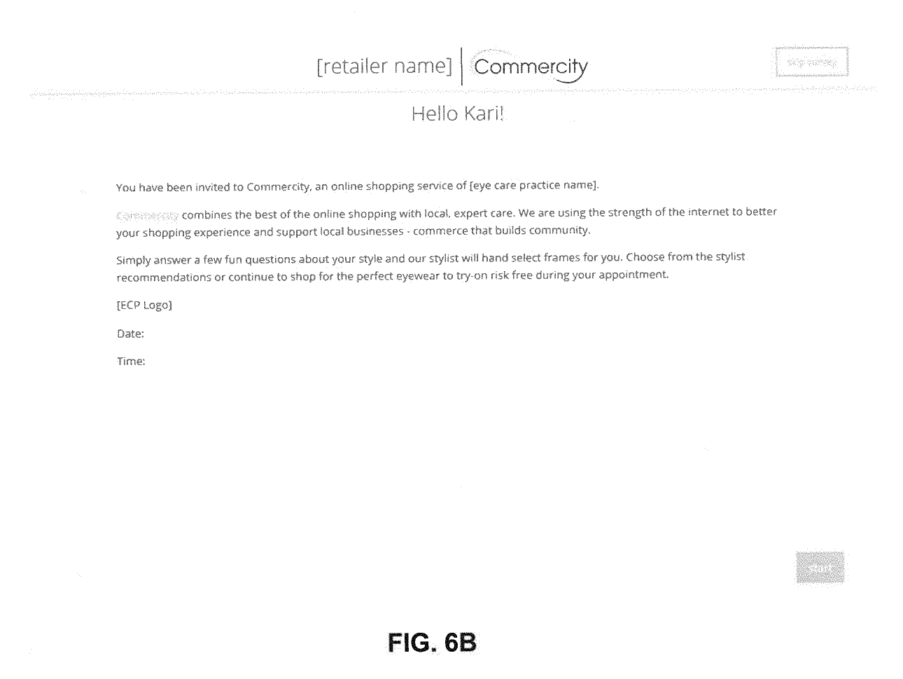

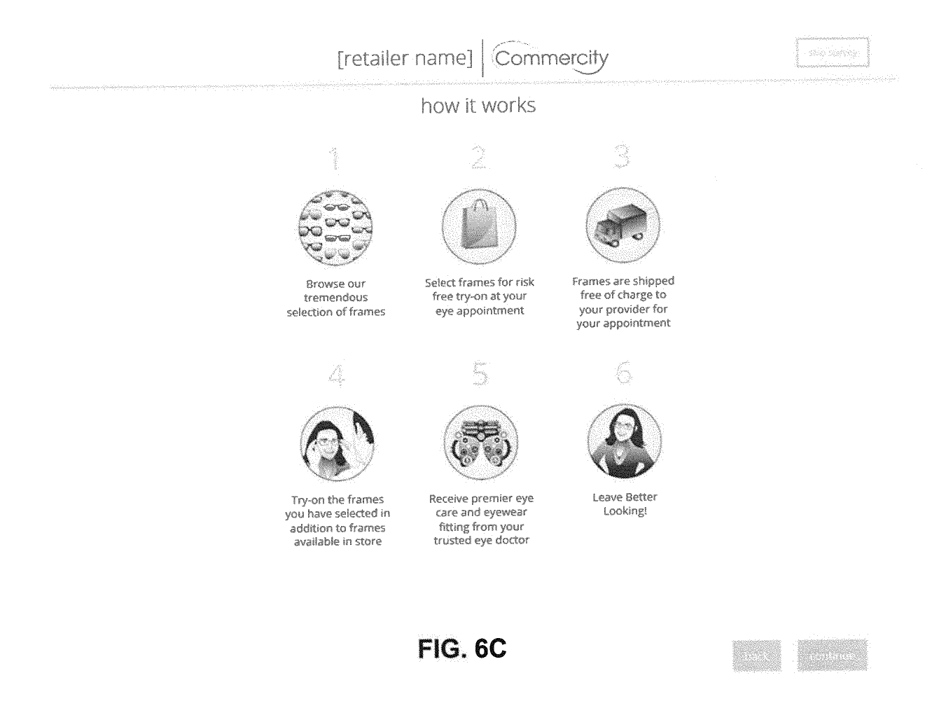

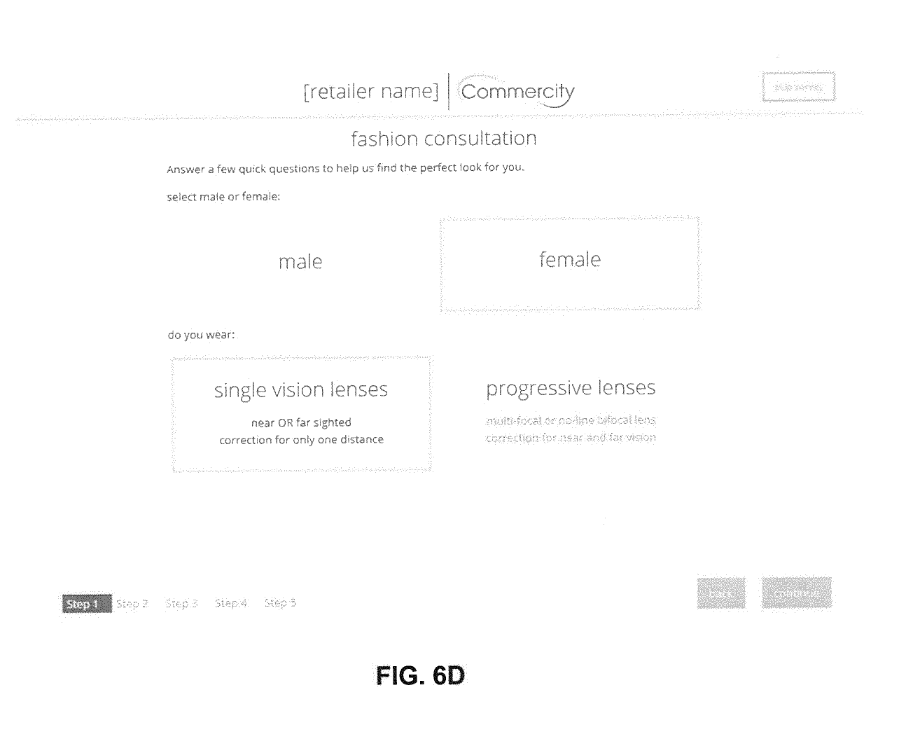

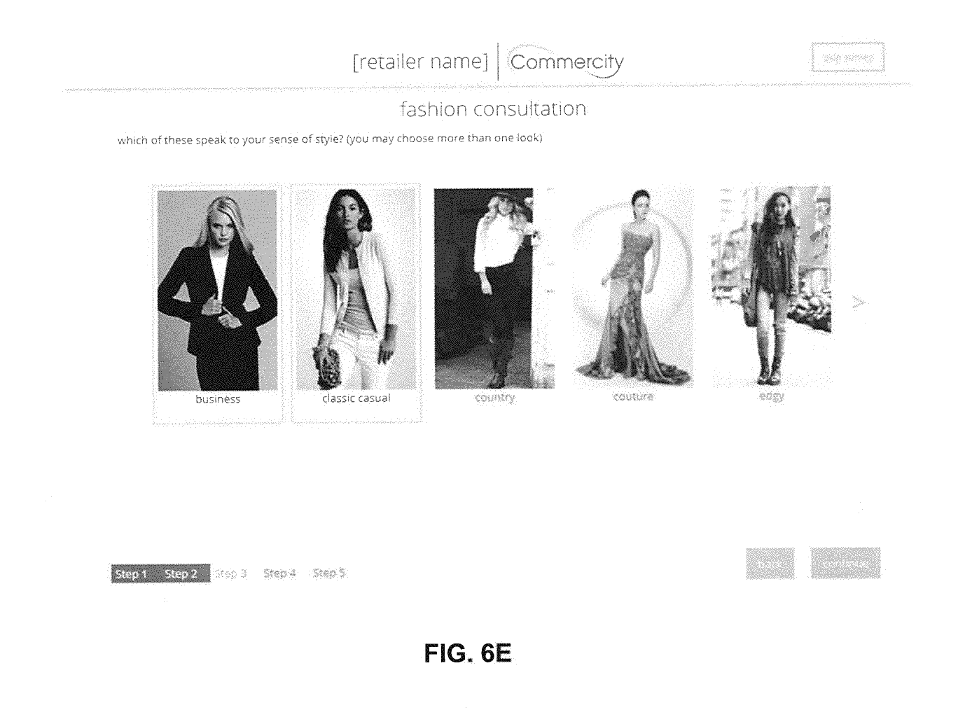

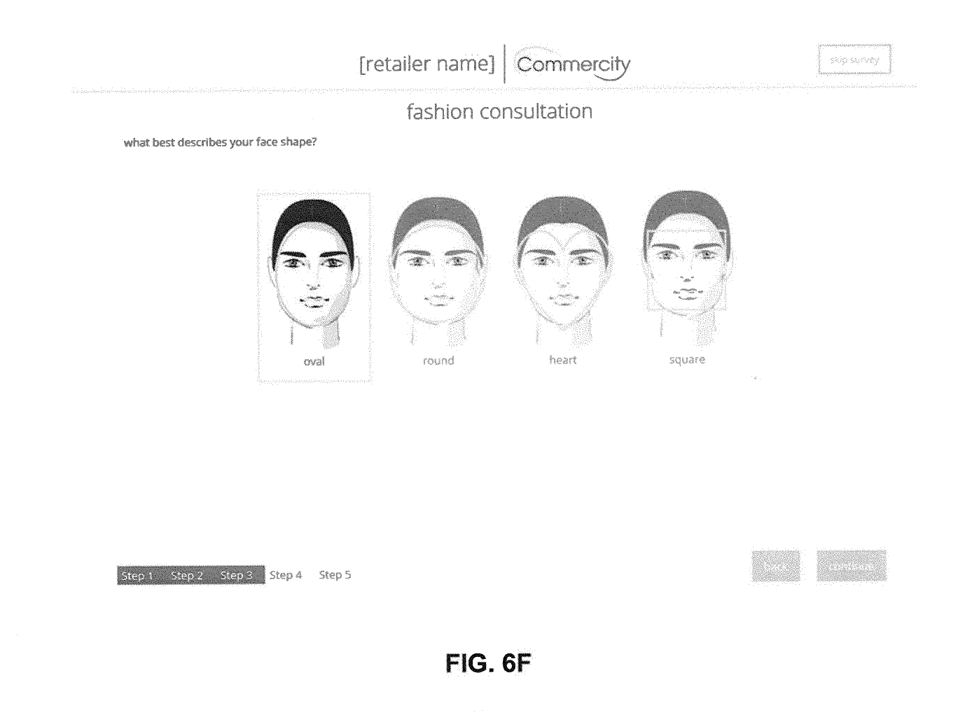

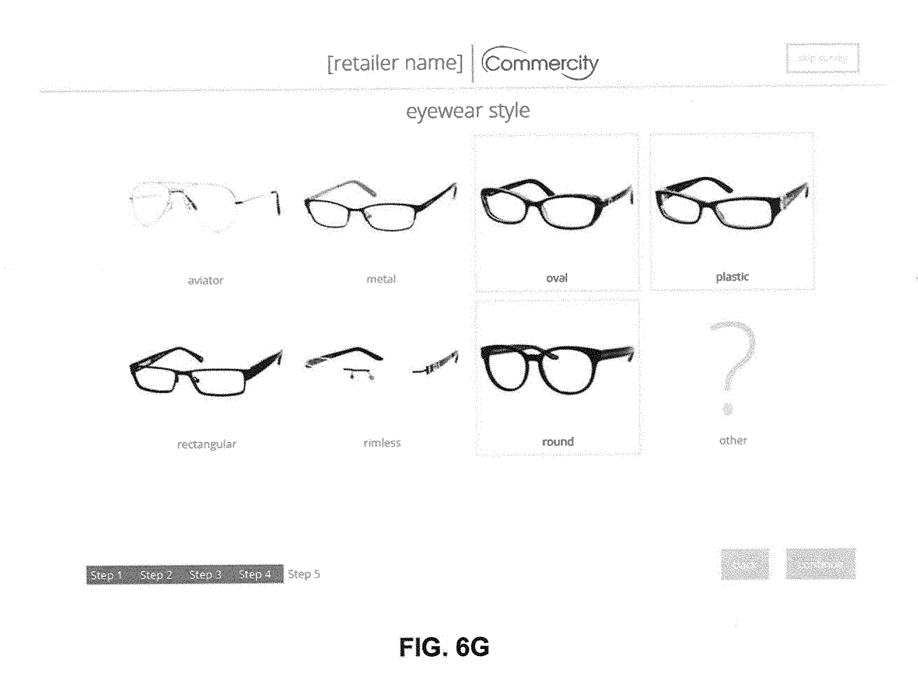

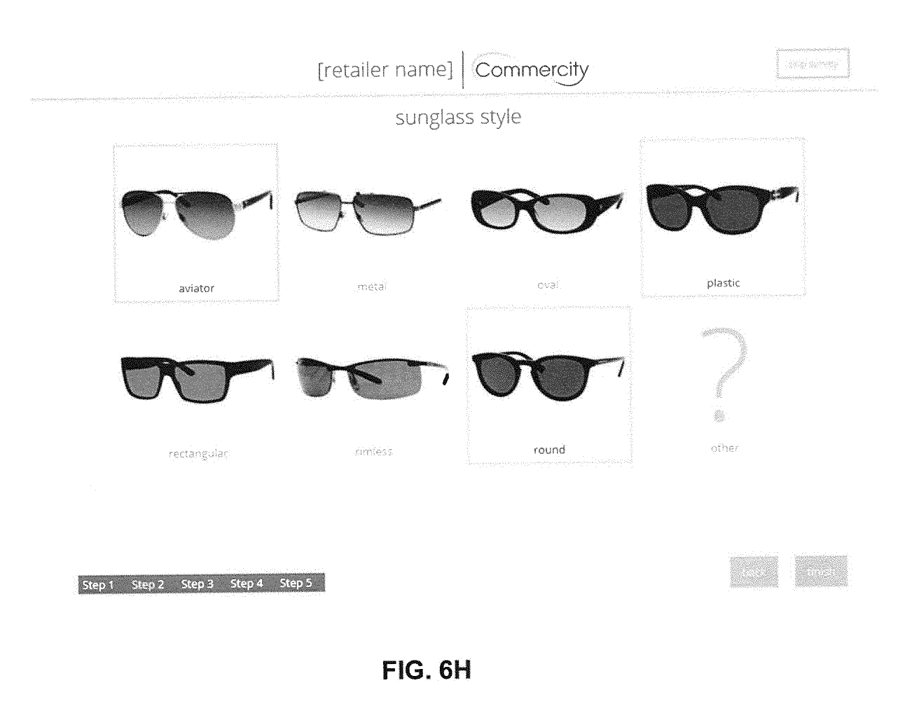

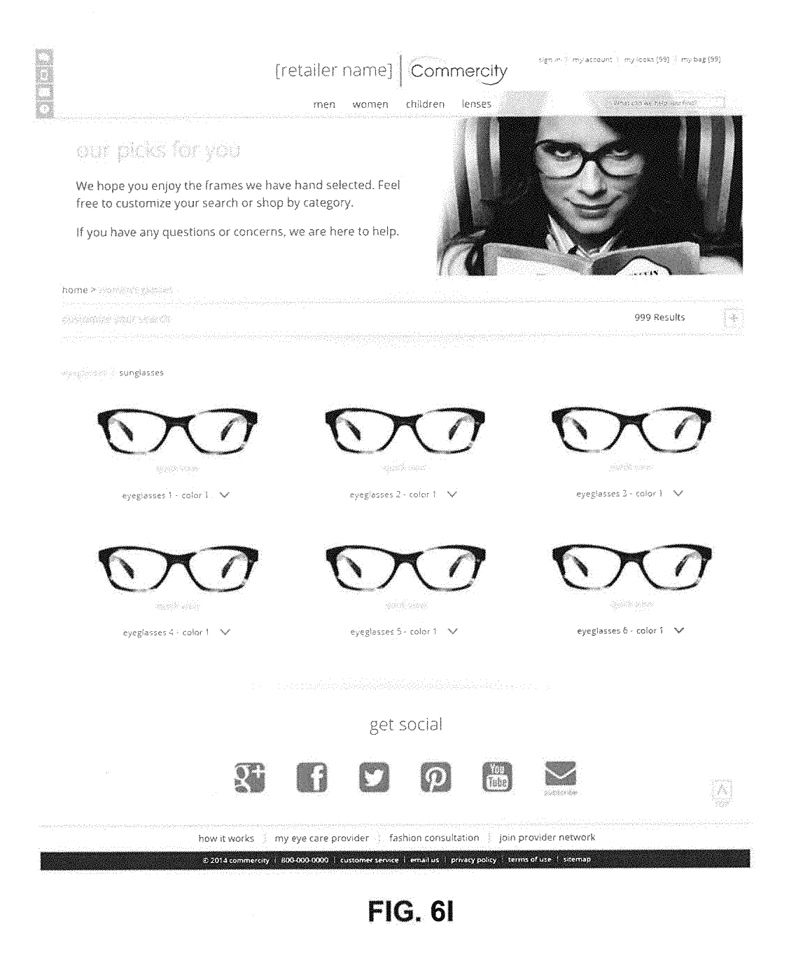

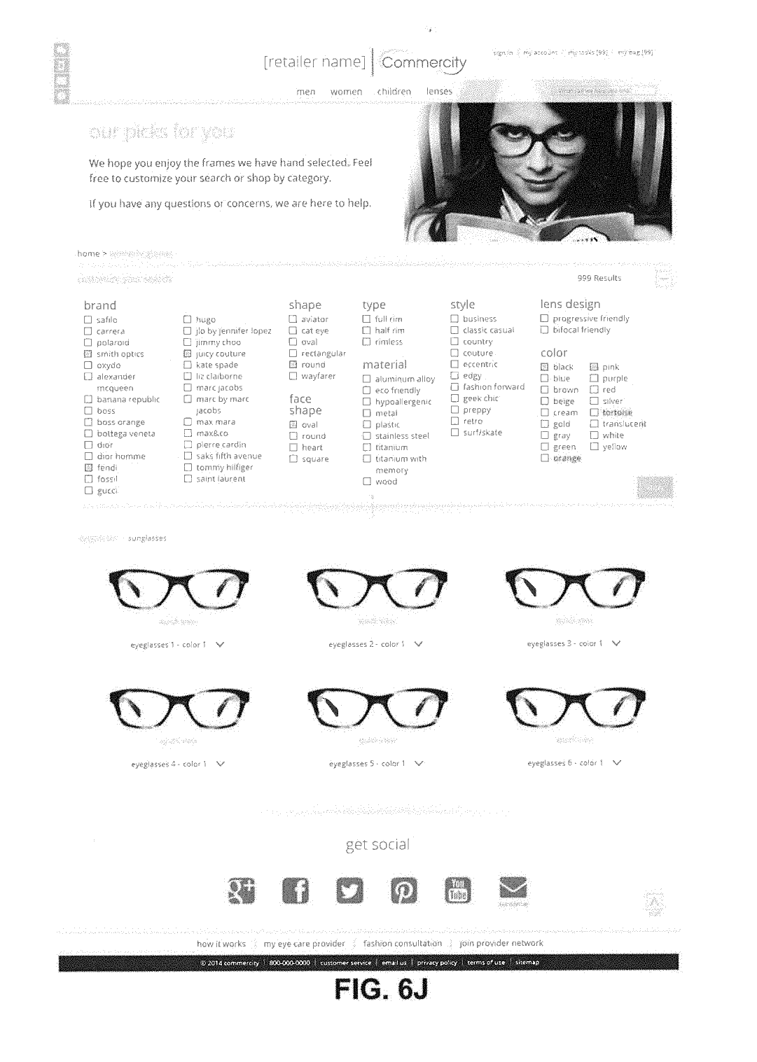

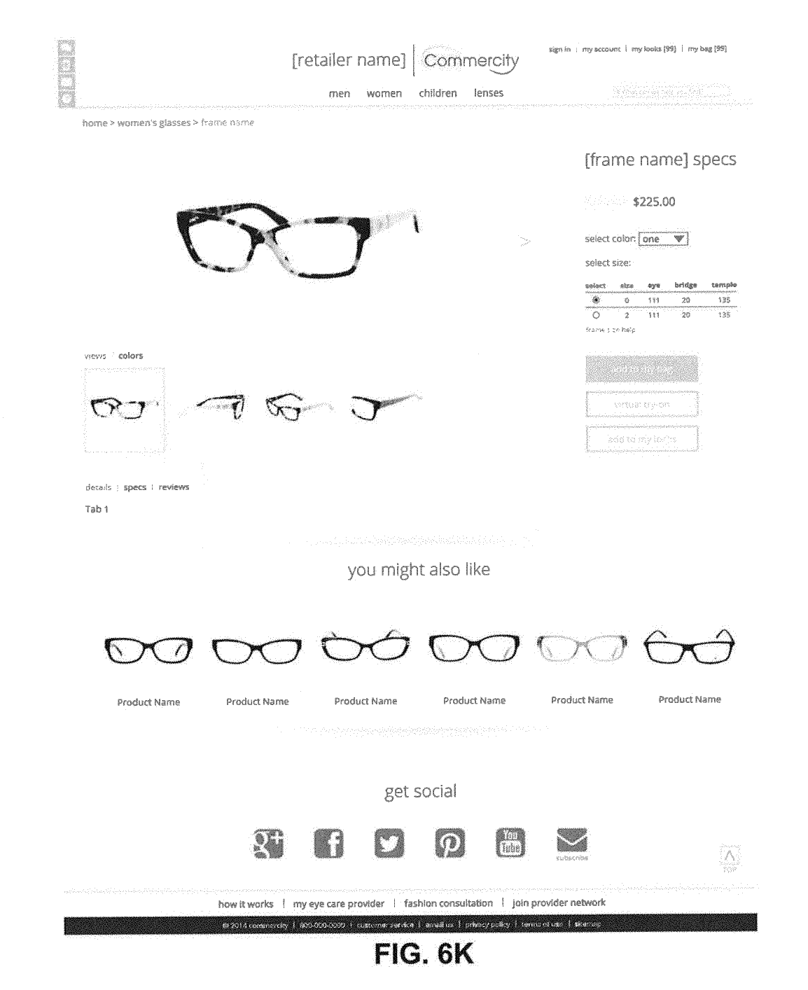

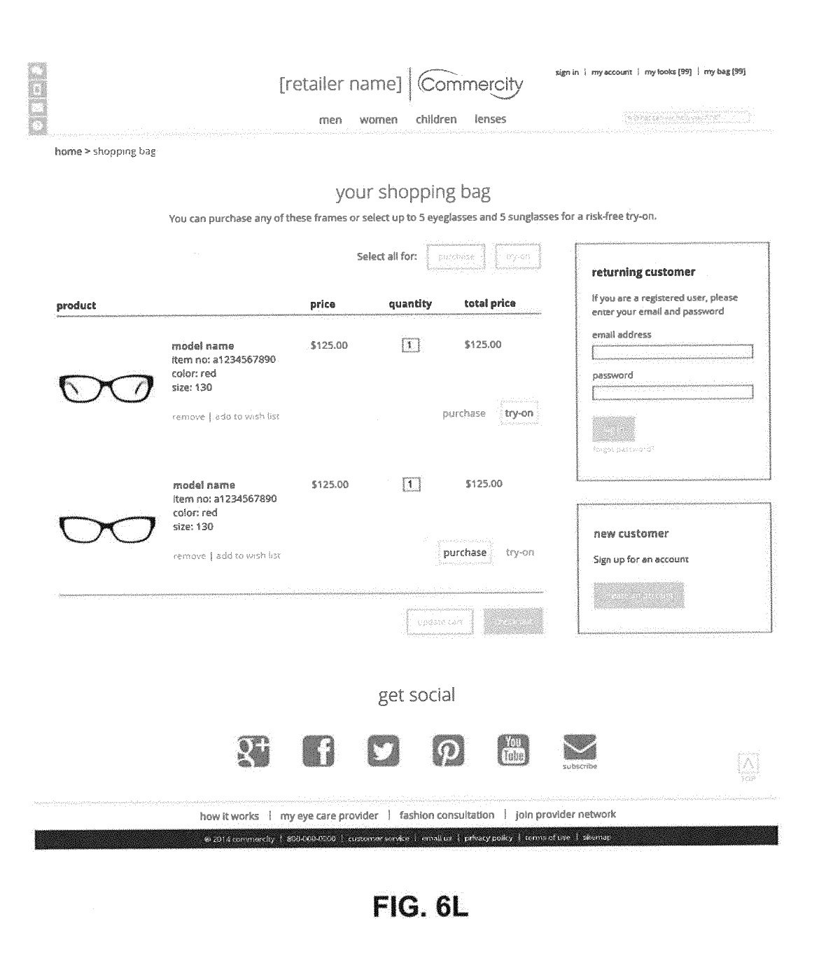

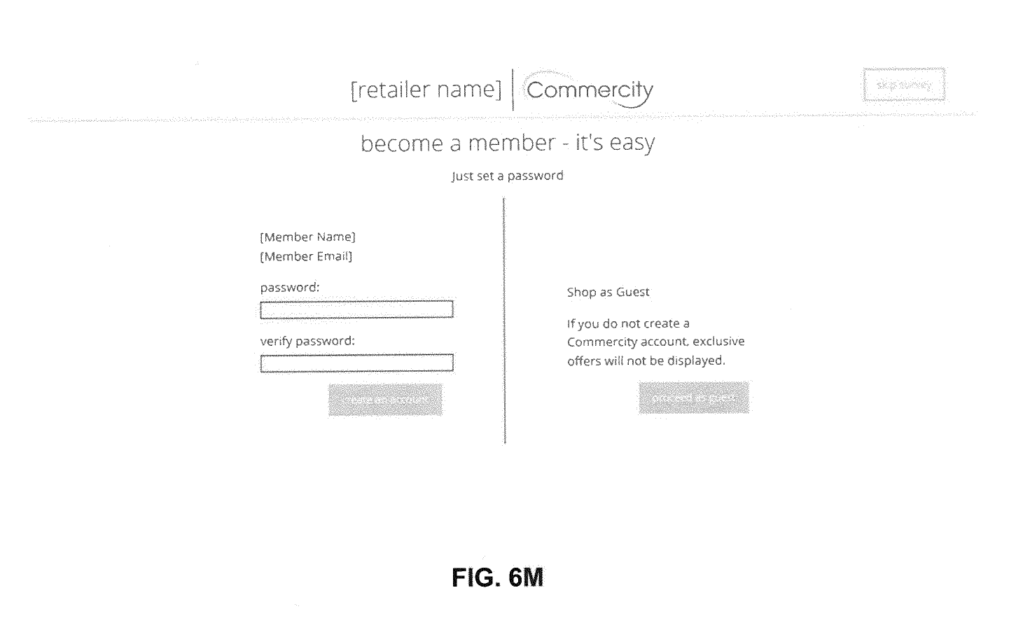

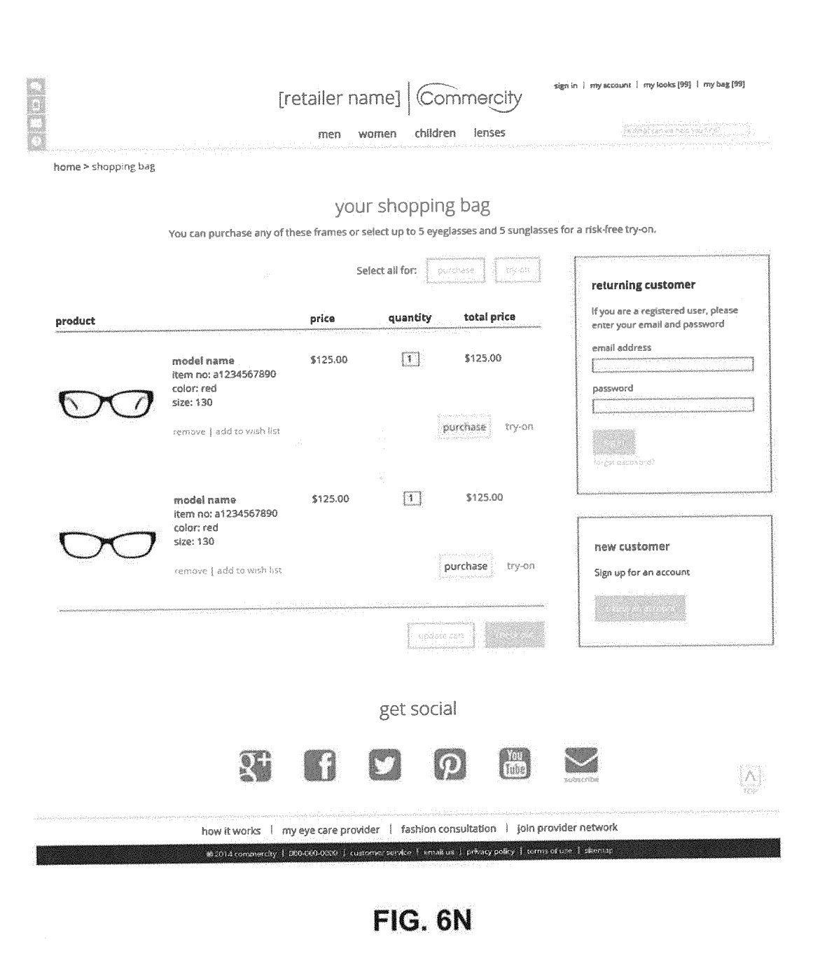

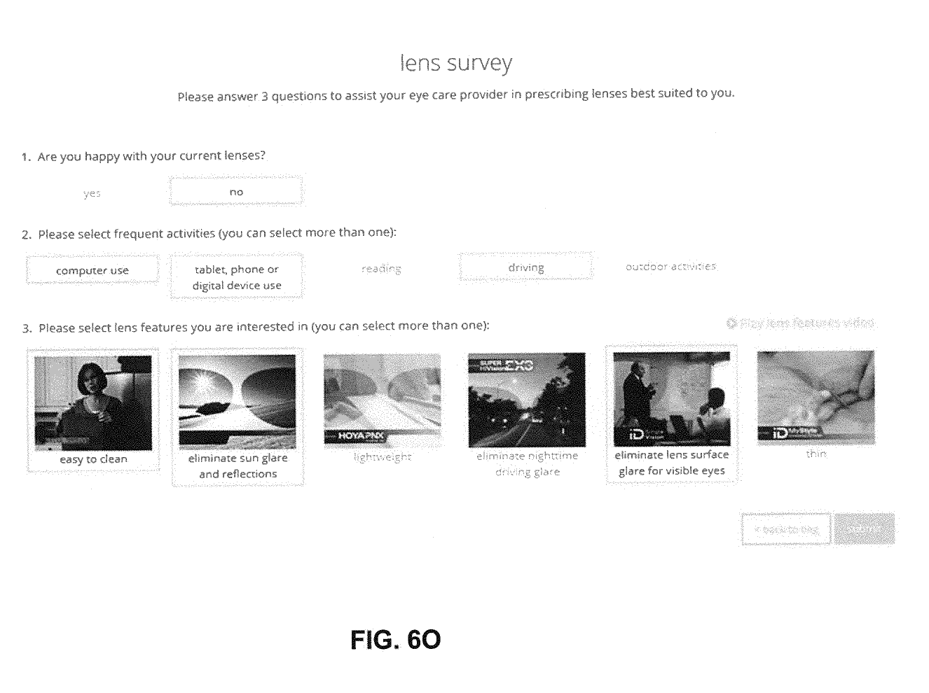

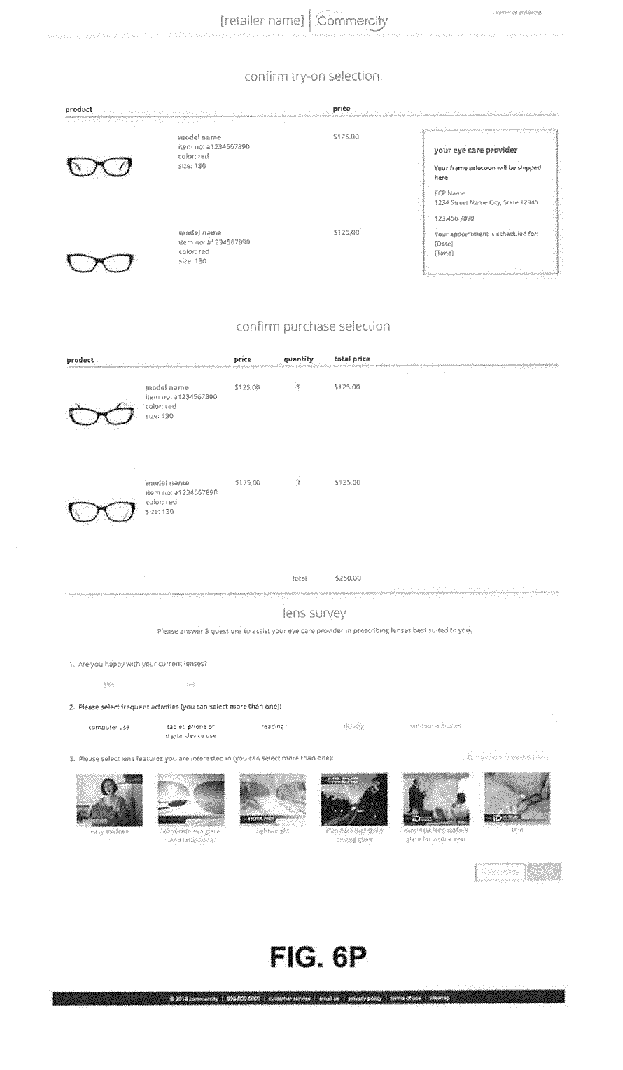

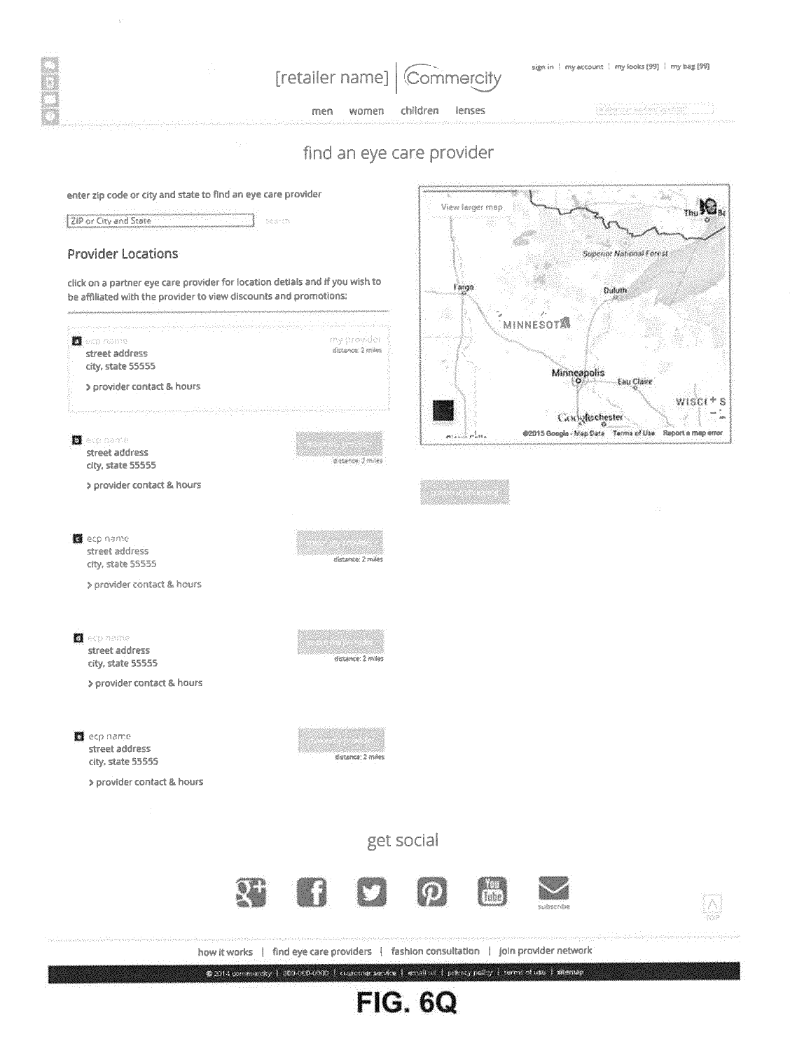

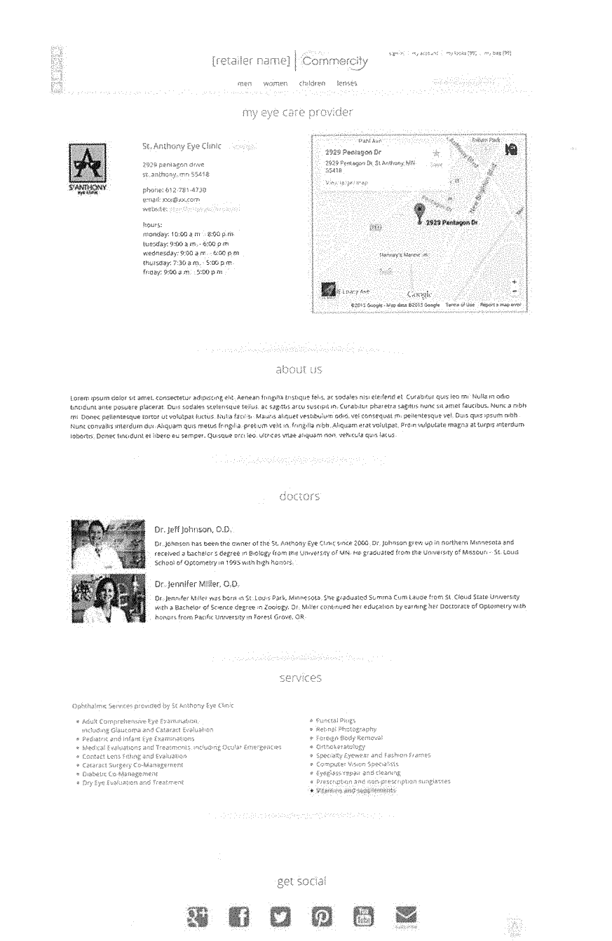

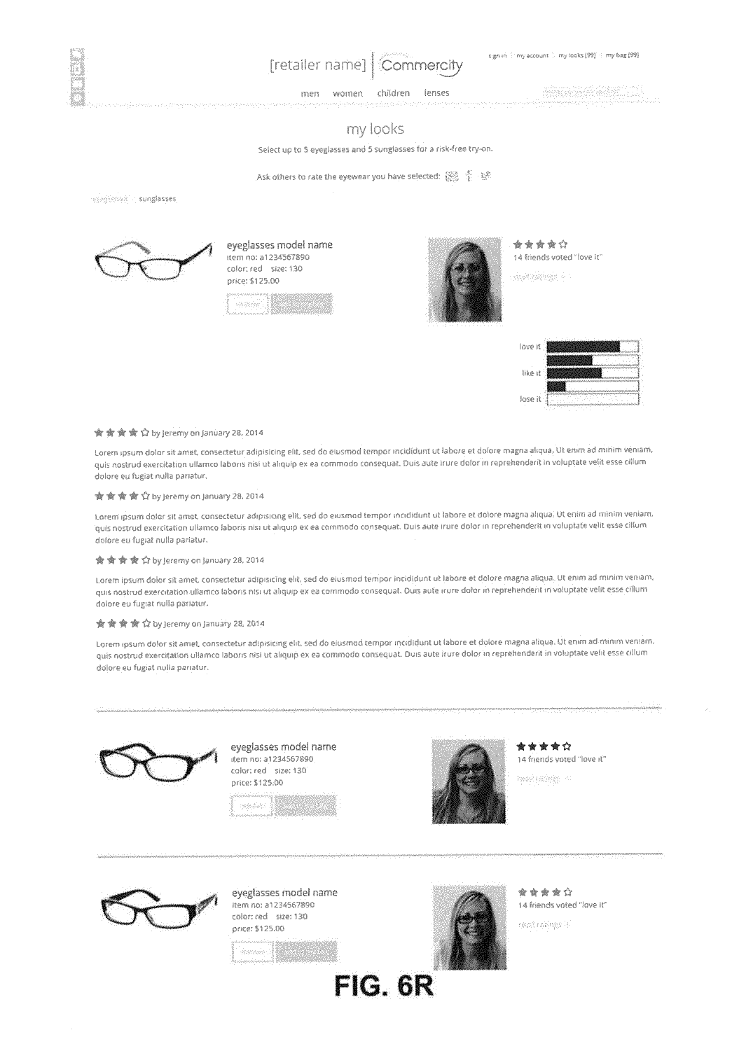

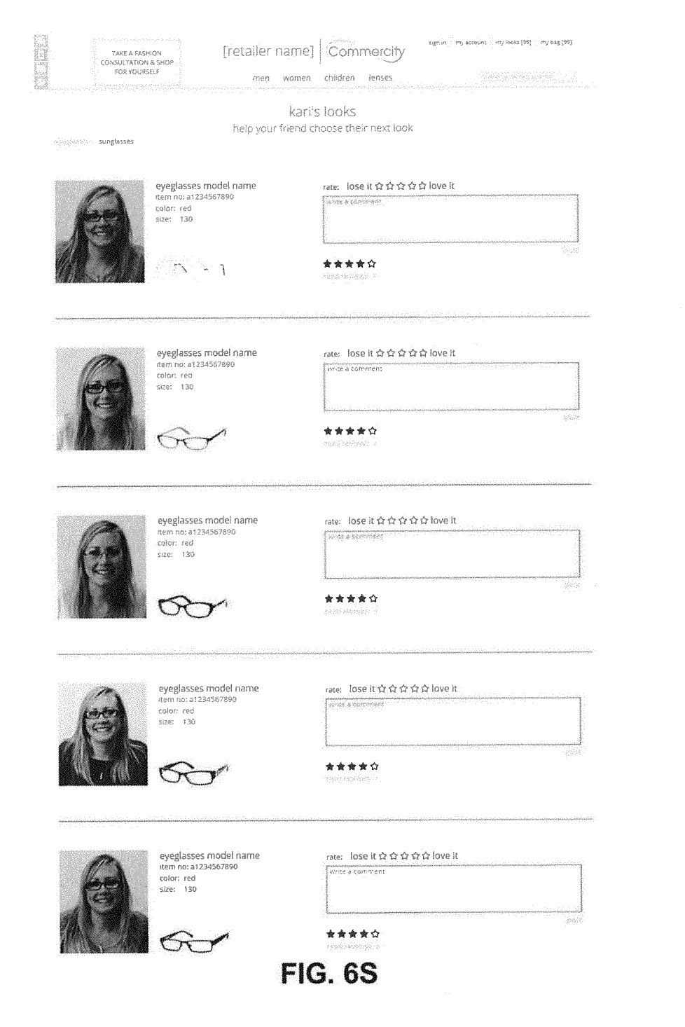

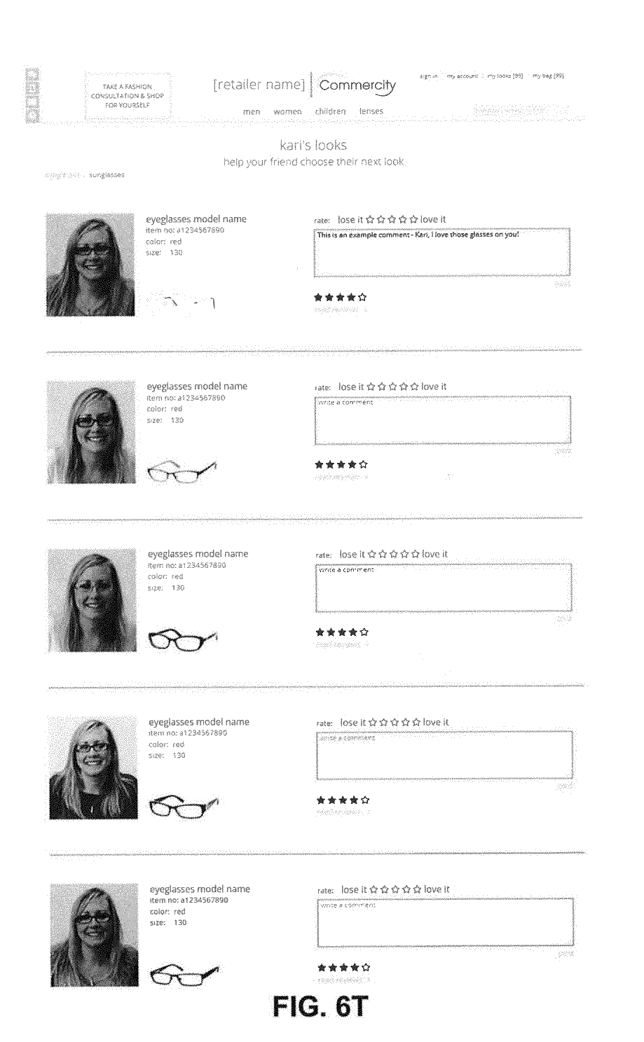

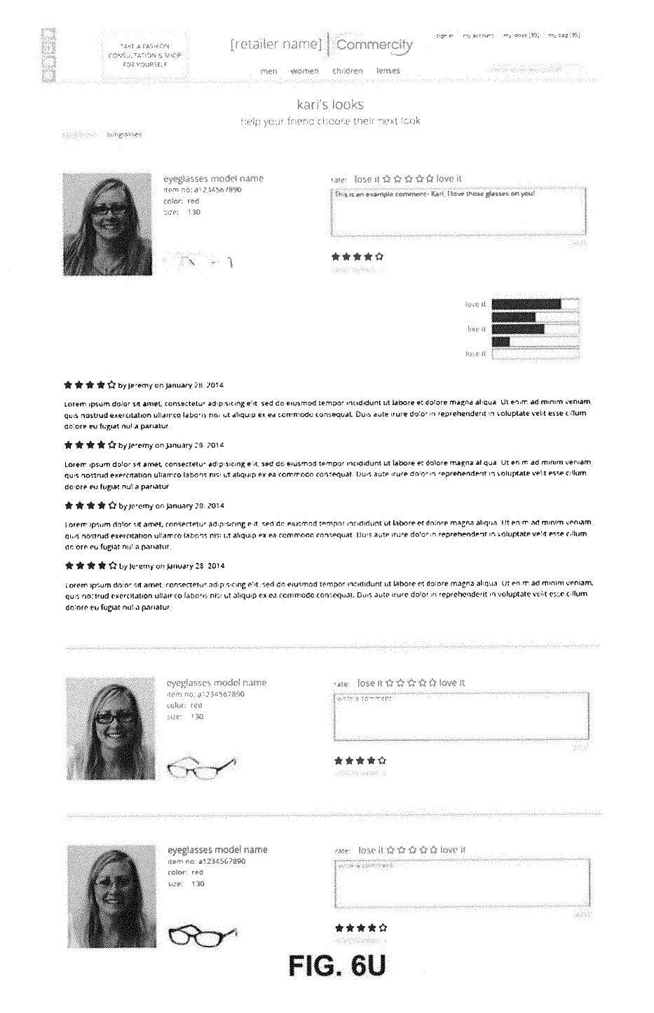

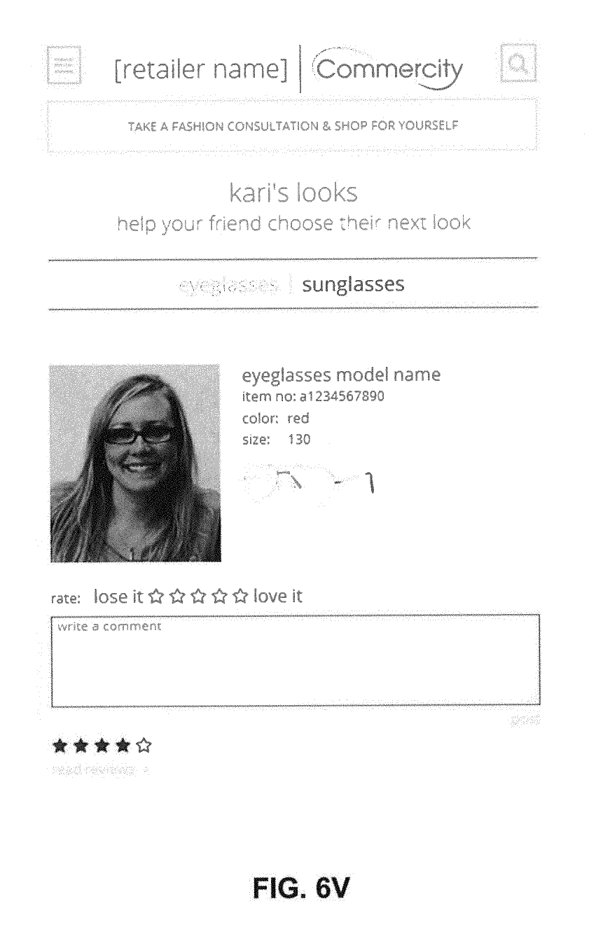

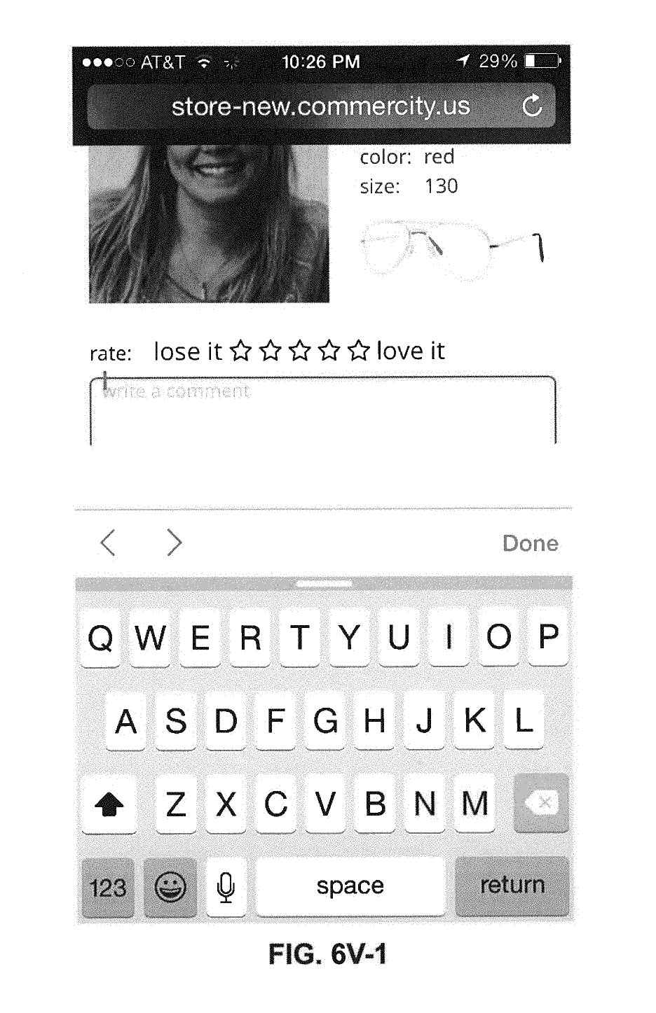

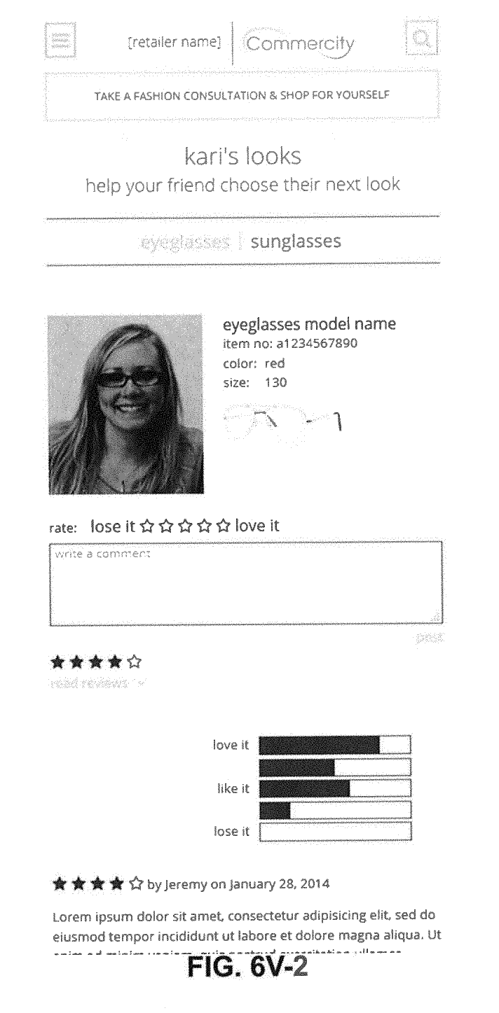

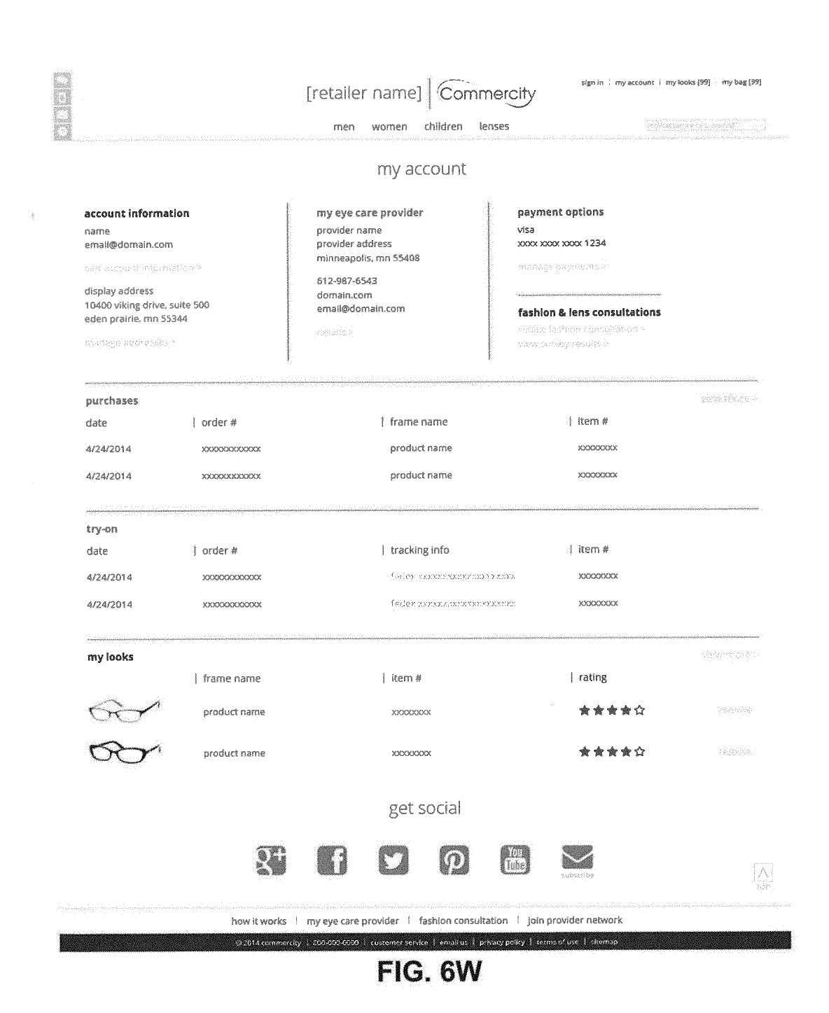

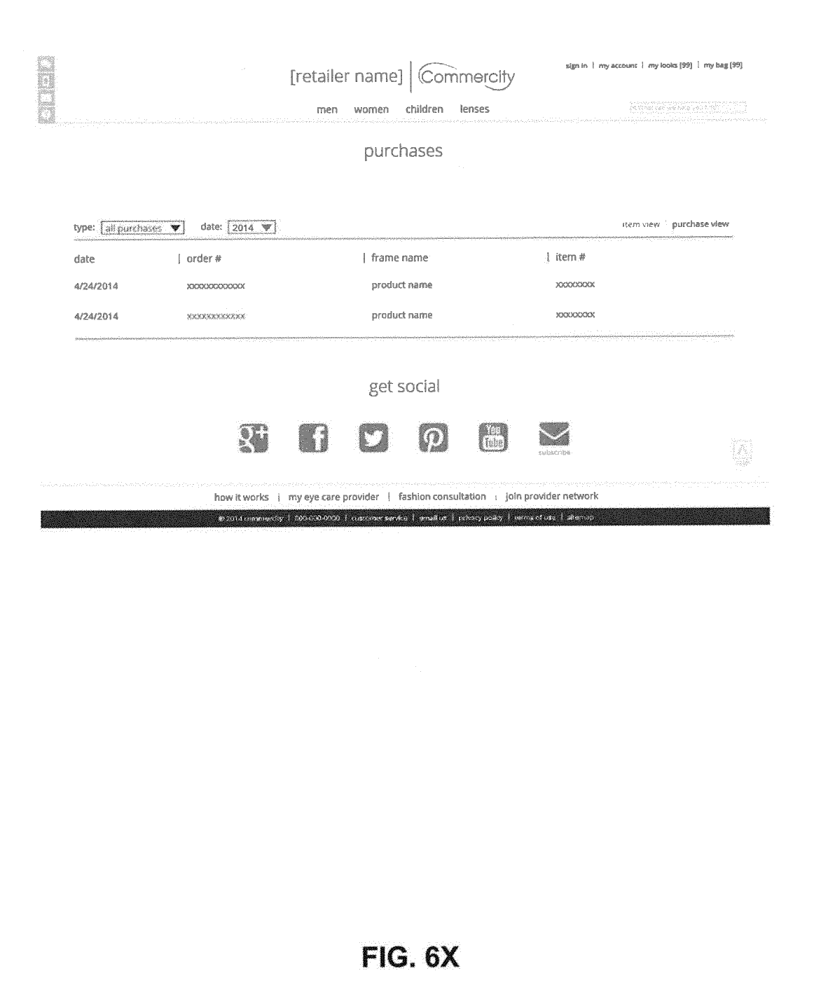

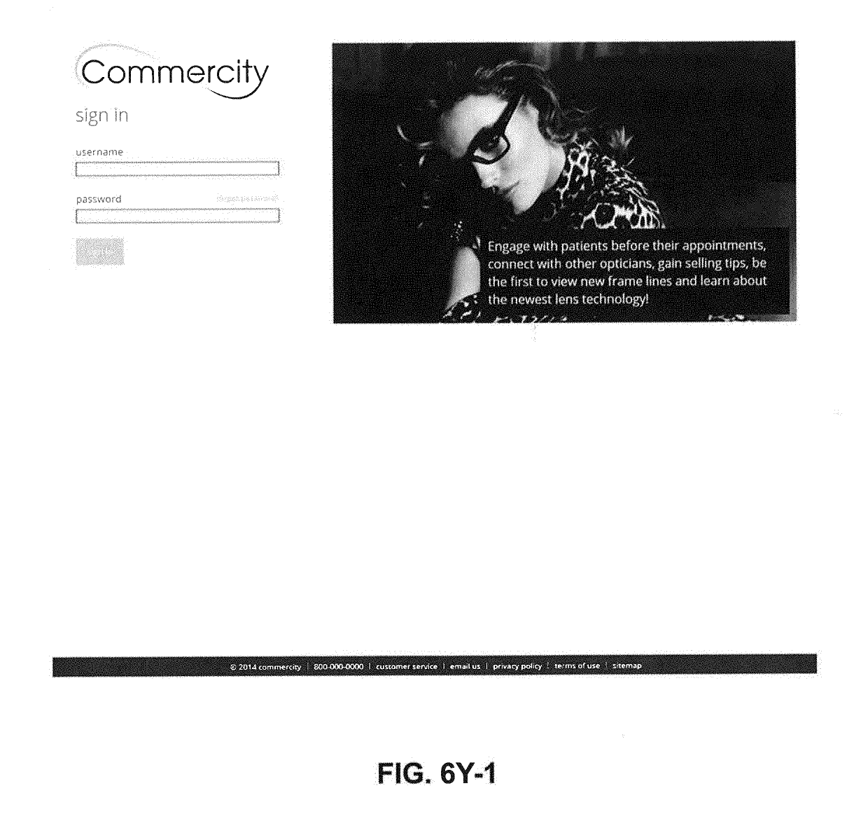

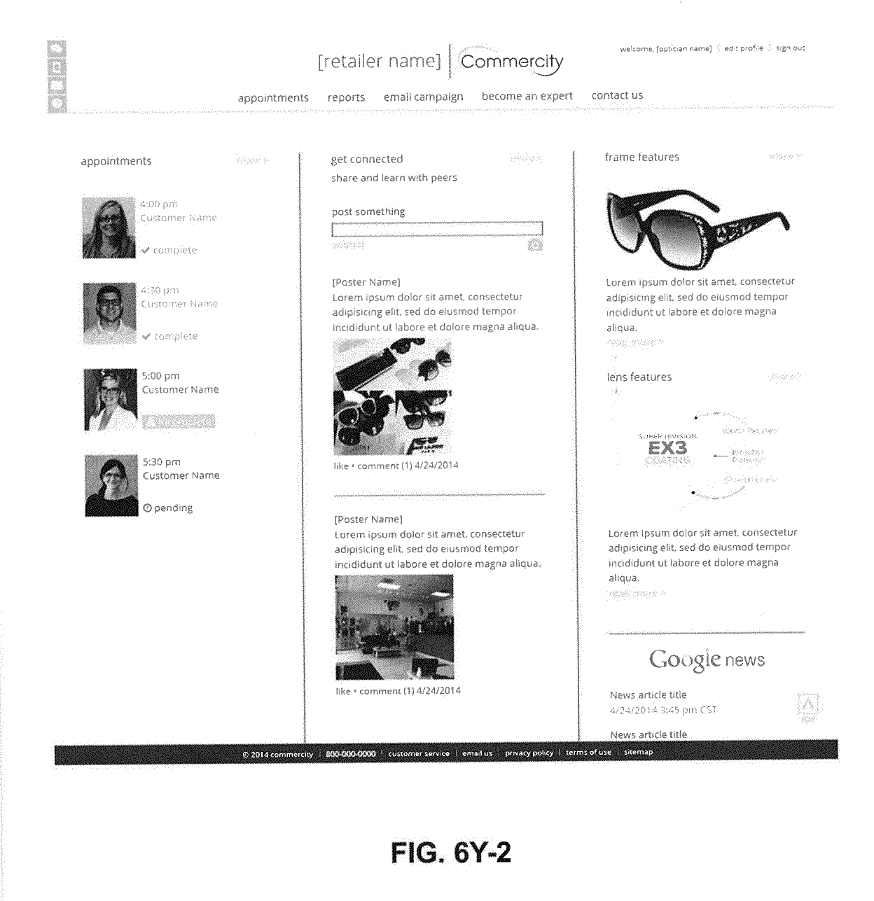

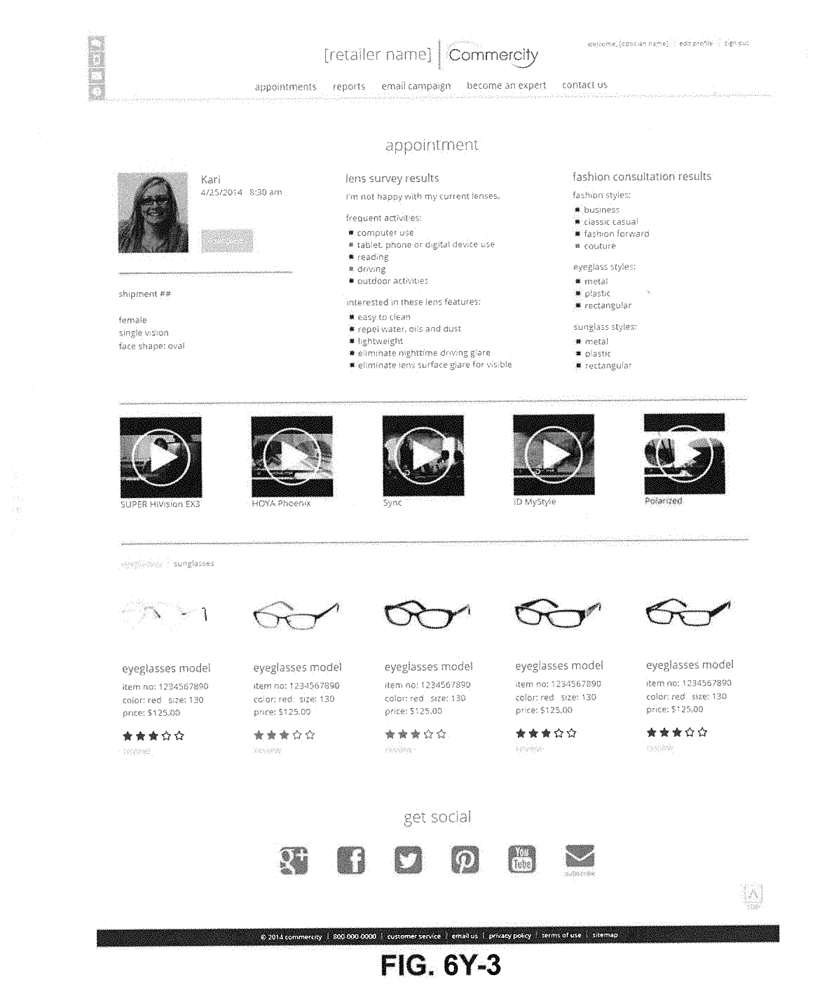

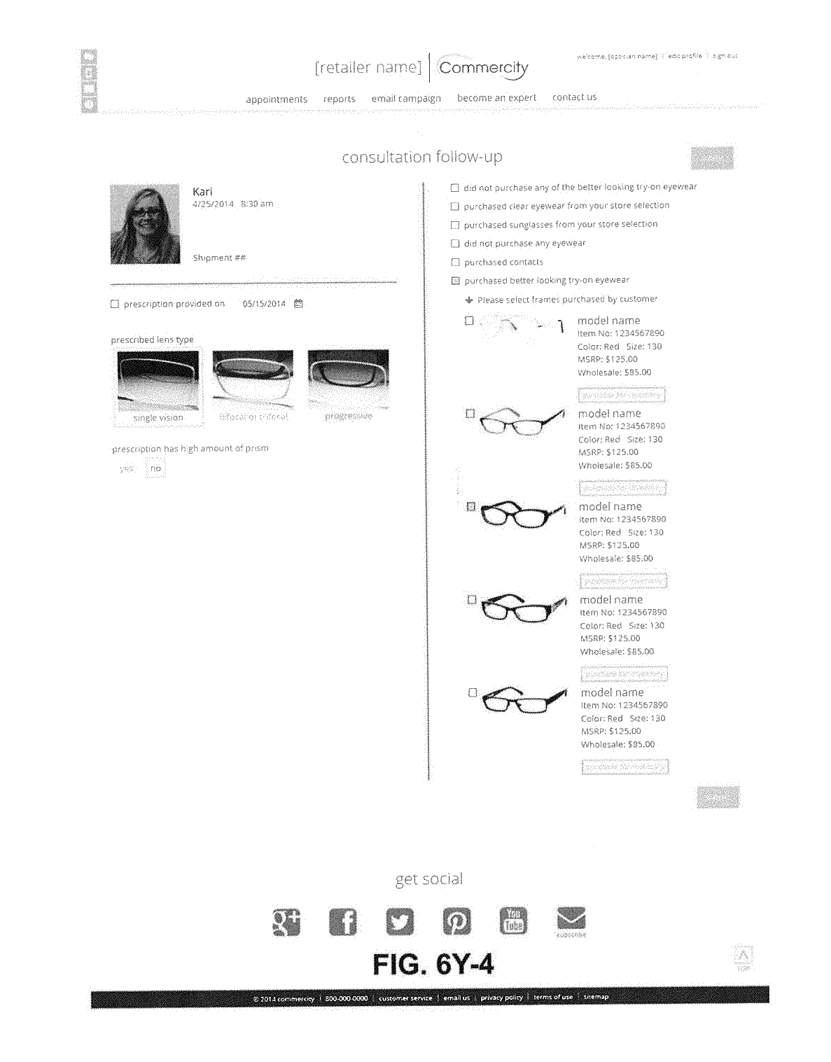

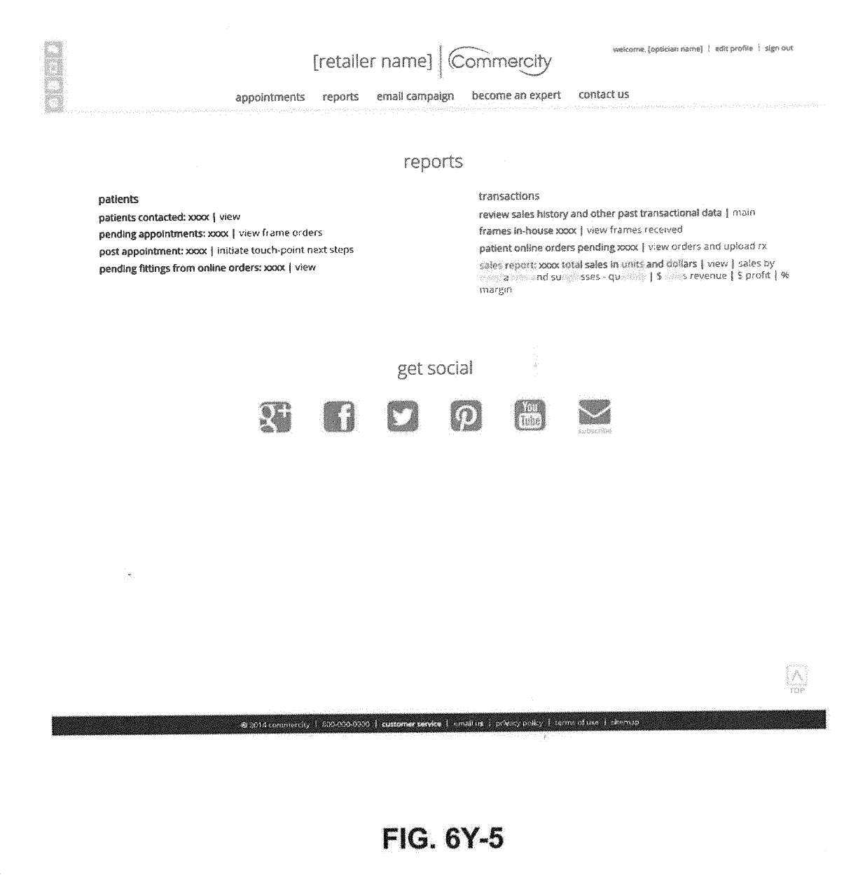

The communication may comprise a link to a hybrid e-commerce landing page and an invitation from the customer's ECP to visit the hybrid e-commerce page to select eyewear to be inspected at the customer's upcoming eye appointment. In many embodiments, the hyperlink within the appointment reminder navigates the customer's web browser to a URL associated with the hybrid e-commerce page at block 304. In other embodiments, customer may browse to the hybrid e-commerce page independently of any appointment reminder from their ECP. Alternatively, the URL may be printed on a mailed communication (e.g., postcard) and sent to the customer. Optionally, at block 306, customer may participate in a product consultation which helps (1) tailor the displayed products to the customer's preferences, and (2) narrow the amount of products displayed to the customer. In an embodiment, the product consultation may be provided via the hybrid e-commerce page, as described with reference to FIGS. 6B-6H.

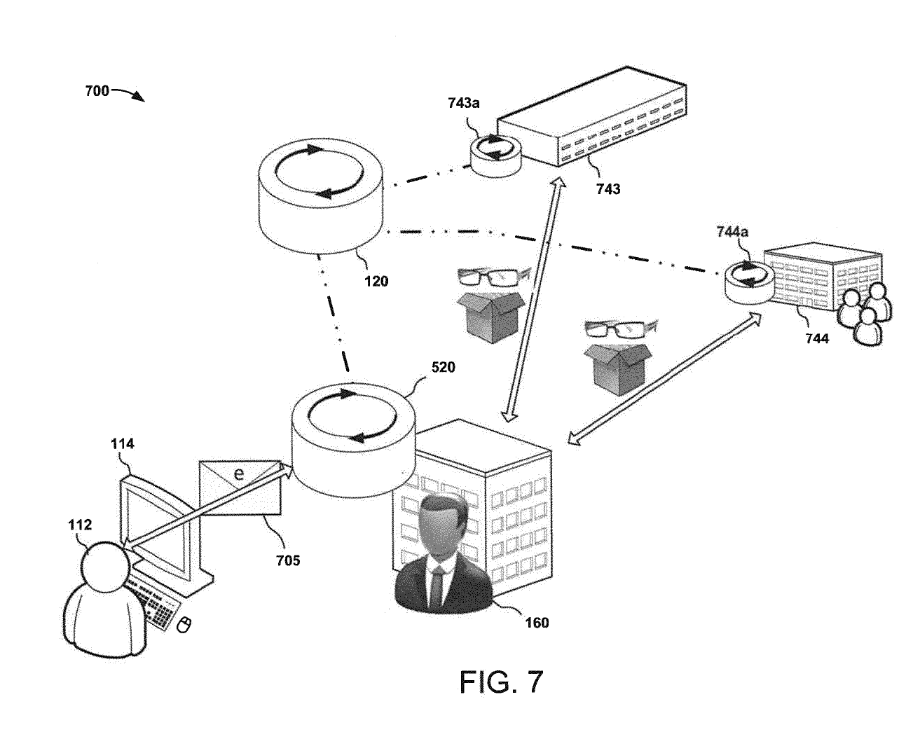

At block 308, the customer browses the displayed selection of eyewear frames, also shown in FIG. 1, at 110. At block 310, the customer selects the eyewear frames that he or she wants to inspect in-person. Optionally, the customer may purchase the eyewear, at step 310, and forego any further inspection and further consultation with the ECP. In these situations, the customer generally has the product shipped to his or her own address. At block 312, the customer may optionally enter any required administrative and payment information, if required. It should be understood that payment transaction processes may vary by industry and by vendor preferences. It may also be influenced by the relationship between the in-person provider 160, the product providers 141, 142, or 743, and/or a third party provider (e.g., the third party provider 744 of FIG. 7). Further, this information entry step may be performed prior to block 306 or block 308. In some embodiments, no payment information or deposit is required because the product(s) is shipped to an affiliate ECP. However, the customer may be required to provide a deposit for covering the cost of shipment of the product(s) and/or a handling fee, which may be applied to the final purchase price of the eyewear frame. By requiring a deposit, the customer is further incentivized to purchase the frame from the ECP. In some embodiments, customer may also select the frame lenses or lens preferences at block 314. Optionally, the customer may select accessories (e.g., cases, etc.) for shipment to the ECP, not shown.

After customer 112 has provided all necessary information and selected at least one product, the product provider(s) ships the frame(s) to the ECP selected by the customer at block 316. Upon receipt of a shipping notice, or alternatively, after receipt of the product(s), the ECP notifies the customer to schedule an appointment to inspect the product(s), not shown. In an embodiment, a hybrid e-commerce platform (e.g., the hybrid e-commerce platform 130 of FIG. 1) may be integrated with an appointment scheduling system of the ECP, and may coordinate shipment of the product(s) (e.g., the frame(s)) to the ECP and scheduling of the customer's appointment with the ECP. For example, the hybrid e-commerce platform may determine one or more available appointment times based on information provided by the appointment scheduling system of the ECP. The hybrid e-commerce platform may determine the one or more available appointment times by querying an appointment scheduling system of the ECP, or may provide the appointment scheduling system on behalf of the ECP. The query may include a preferred date and time for the appointment, or a range of preferred appointment dates and times, which may be specified by the customer using the hybrid e-commerce platform. The hybrid e-commerce platform may present the one or more appointments times to the customer for selection of a particular appointment date and time for the customer to inspect the product(s). Upon selection of the particular appointment date and time by the customer, the hybrid e-commerce platform may request that the product(s) be shipped by the product provider, such that the product(s) arrive at the ECP before the particular appointment date and time selected by the customer.

For example, the customer may select an appointment date and time that is three months away. The hybrid e-commerce platform may request that the product provider ship the product(s) to the ECP two weeks before the appointment date and time to ensure that the product(s) arrive at the ECP in advance of the appointment. Additionally, by requesting that the products be shipped two weeks in advance of the appointment, instead of immediately, the ECP is not required to store the product(s) for a long period of time, thereby limiting the amount of storage space the ECP needs to maintain. To illustrate, assuming the products are shipped via ground shipping, the product(s) may take one week to travel from the product provider to the ECP. Thus, the ECP may only be required to store the product(s) for one week prior to the appointment (e.g., when the product is shipped two weeks in advance of the appointment). In an embodiment, the hybrid e-commerce platform may be configured to estimate an amount of time required to ship the product(s) from the product provider to the ECP, and to request shipment of the product(s) with a buffer time. For example, if the hybrid e-commerce platform estimates that the product(s) will take six days to arrive at the ECP (e.g., one day to process the shipment of the product(s) by the product provider and five days to be delivered to the ECP), the hybrid e-commerce platform may request shipment of the product eight days prior to the appointment time (e.g., the six days for shipment processing and delivery and two days of buffer time). By adding buffer time to the requested ship date, the hybrid e-commerce platform may account for potential delays (e.g., bad weather) in the delivery of the product(s) to the ECP, while minimizing the amount of time that the ECP has to store the product(s) while still ensuring the product(s) arrive at the ECP in advance of the customer's appointment.

Additionally or alternatively, the hybrid e-commerce platform may have access to product information for one or more product providers. The product information may identify lead times, quantities on hand, or other information that may be representative of whether the product provider has the product(s) on hand, and if not, when the product provider will have the product(s) on hand. Thus, if the customer selects a product(s), such as eyeglass frames, that are not available from the product provider, the hybrid e-commerce platform may use the product information to determine when the product would be available from the product provider, and may suggest appointment times to the customer, where the product(s) will be available from the product provider during the suggested appointment times. The suggested appointment times may also account for any amount of time required to ship the product(s) to the ECP. For example, the hybrid e-commerce platform may estimate, based on the product information, that the product(s) will be available for shipment on a particular date, and may suggest appointment times that are two weeks from the particular date, where the two weeks account for processing of the shipment of the product(s) by product provider, and delivery of the product(s) to the ECP. Thus, the hybrid e-commerce platform may help ensure that the product(s) the customer has selected for in-person inspection are available during the appointment scheduled with the ECP.

In the optical industry, appointments are often scheduled far in advance. In such instances, a reminder may be sent to the customer who then selects frames for try-on. In an embodiment, the hybrid e-commerce platform may send the reminder to the customer a pre-determined amount of time in advance of the scheduled appointment. For example, the hybrid e-commerce platform may have access to the scheduling information for the ECP, or may provide an interface that is accessible to the ECP for scheduling appointments (e.g., the hybrid e-commerce server may manage appointment scheduling for the ECP). The hybrid e-commerce platform may periodically analyze the scheduling information to identify scheduled appointments that are a predetermined amount of time away (e.g., three weeks). The predetermined amount of time away may be static (e.g., three weeks before the scheduled appointment) or may be dynamic (e.g., a varying number of weeks/days before the scheduled appointment depending on the particular industry, location of the ECP, etc.). The predetermined amount of time may account for an average estimated shipping time (e.g., an average amount of time for the product provider to process a shipment request and for the product to be delivered to the ECP) and a selection period. The selection period may correspond to a number of days or weeks for the customer to visit the hybrid e-commerce platform to select the product(s) for in-person inspection. By including the selection period in the predetermined amount of time, the product(s) can be shipped from the product provider to the ECP in advance of the appointment, as described above, while allowing the customer time to thoroughly browse the available products, read product reviews, and utilize additional features provided by the hybrid e-commerce platform to assist the customer in selecting the products for in-person inspection, such as the virtual try on features described with reference to FIGS. 6K, 6L, 6N, and 6V-6V-2. Such additional features may provide the customer with a meaningful way of selecting products for in-person inspection, thereby increasing the likelihood that the customer will find a product that meets the customer's needs and interests, and increasing the customer's satisfaction with the purchase of the product after the in-person inspection.

At block 318, the customer 112 meets with their ECP to inspect and try on their selected eyewear frame(s). Additionally, the customer 112 may also inspect (i.e., shop) other eyewear frames that the ECP has in stock, if any, whether such inspection is during the scheduled appointment, or alternatively, without an appointment (i.e., “walk-in”, etc.). At block 320, the customer 112 selects at least one eyewear frame for purchase. The customer 112 also selects the lenses to be installed in the selected eyewear frame(s) at block 322, although the lens selection step may have been completed during the online consultation or browsing, blocks 306-310, or upon arrival at the customer 112's ECP, before or after block 318 or block 320. In most cases, and after the customer 112 selects the eyewear frame and lenses for purchase, the ECP submits the request for the selected lenses to the lens provider, block 324. It is noted that many small ECPs/optical retailers do not process lenses internally. Instead, they generally send the frames and lens order to a lens processing lab. The lens processing lab may be owned by a lens manufacturer, or it may be operated independent of the lens manufacturer and the ECP. In such instances, the customer 112 may provide payment for the selected lenses to the ECP, and the ECP may subsequently arrange for the lens processing lab to prepare and provide the lenses, which may or may not include shipping the selected eyewear frames to the lens provider to insert the selected lenses and then ship the completed eyewear frames to the ECP or the customer 112. However, some instances, the ECP may process the lenses internally, and, in such instances, the ECP may prepare the selected lenses and insert the selected lenses into the selected eyewear frames before providing the completed eyewear to the customer 112. In many embodiments, and as exemplarily shown at block 326, the customer 112 completes the purchase of the selected eyeglass frame and lenses. It should be understood that the completion of the sale/purchase of the product may be completed at various steps, which is dependent upon factors such as the particular industry and/or the relationship between the parties. The payment transaction may occur online at the hybrid e-commerce website, at the in-person provider, at a third party payment provider (e.g., Paypal, bank-provided payment services, etc.), or any combination thereof.

In an aspect, the customer 112 may provide payment information (e.g., credit card information, name, address, etc.) to the hybrid e-commerce platform at the time of product selection, but the payment information may not be processed until the customer has had an opportunity to inspect the product(s) in person, such as during the scheduled appointment, and to select the particular product(s) for purchase. In an aspect, the ECP may provide information indicating the selection of a particular product to the hybrid e-commerce platform. To illustrate, the customer 112 may select three eyewear frames for in-person inspection and provide payment information to the hybrid e-commerce platform. During the scheduled appointment, the customer 112 may select a first eyewear frame for purchase. The ECP may request lenses for the first eyewear frame, as described above, and may provide information to the hybrid e-commerce platform indicating that the customer 112 selected the first eyewear frame. Upon receiving the information from the ECP, the hybrid e-commerce platform may process the payment information with respect to the first eyewear frame. For example, the hybrid e-commerce platform may charge an amount to the credit card account associated with the payment information, where the amount corresponds to a purchase price of the first eyewear frame. The amount may, in some embodiments, also include the price of the lenses and/or any additional accessories and services purchased by the customer 112, such as lens treatments, eyewear frame cases, etc. At block 328, the customer 112 may optionally return to the ECP for another fitting and final inspection of the eyewear frame with the selected lenses inserted.

Some industries, such as the eye care industry, have recurring purchase lifecycles. For example, a customer typically has at least one eye exam every two years to verify the customer has a prescription that provides the appropriate vision correction for the customer's vision needs. Thus, the customer may initially visit the ECP for an eye exam, and the customer may try-on, inspect, and purchase eyewear during this initial visit. Upon completion of the initial visit, or sometime thereafter, the ECP may direct the customer to register with the hybrid e-commerce platform. Additionally, the ECP may direct customers with existing prescriptions to the hybrid e-commerce platform at any time, and, as long as a customer's prescription is current, the ECP will encourage the customer to shop at the hybrid e-commerce platform regardless of whether the customer's next eye exam is a few months or a year out. Once registered, the customer may receive reminders prompting the customer to schedule a follow-up appointment, or to schedule in-person inspection of new eyewear frames. Additionally, the ECP may target advertisements for eyewear and eyewear accessories to the customer via the hybrid e-commerce platform, as described elsewhere herein. By prompting the customer to register with the hybrid e-commerce platform, the ECP is able to maintain contact with the customer during periods of time when the customer is not in need of the ECP's services, such as during the two years in between eye exams. This may enable the ECP to drive sales of eyewear despite not seeing the customer for an eye exam or other issue related to the customer's eye care needs. For example, the customer may purchase eyewear from the hybrid e-commerce platform directly (e.g., without an in-person inspection) regardless of whether the customer has scheduled an in-person inspection using the hybrid e-commerce platform

In a further embodiment, the hybrid e-commerce platform may provide an interface through which the ECP may ask the customer vision questions prior to an eye exam. For example, the hybrid e-commerce platform may provide the ECP with a web page or interface that the ECP may configure with vision questions (e.g., a Snellen chart, questions asking the customer to describe problems the customer is experiencing, etc.) designed to obtain information about the customer's vision needs prior to an in-person eye exam. When a customer schedules an eye exam with the ECP, the customer may be directed to visit the hybrid e-commerce platform to answer the vision questions, and the results of the vision questions may be provided to the ECP prior to the in-person eye exam. By providing vision information to the ECP prior to the in-person eye exam, the ECP may have a better understanding of the customers eye care needs prior to the in-person eye exam, and may be able to detect problems with the customer's vision early on, such as when the customer's lens prescription no longer provides adequate vision correction. The vision questions may be changed periodically and/or may be tailored to each customer by the ECP using the hybrid e-commerce platform. In an embodiment, the vision questions may be answered by the customer while visiting the ECP, such as using a kiosk located in a lobby of the ECP, as a pre-screening for the ECP, and may assist the ECP in determining additional eye exams that may be required to diagnose changes in the customer's vision since a last time the customer had an eye exam, if any. Additionally or alternatively, the vision questions may be sent to the customer independent of a scheduled eye exam. For example, the customer may be prompted to visit the hybrid e-commerce platform once every six months or once a year to answer the vision questions. Because the customer can answer the vision questions without having to visit the ECP, the customer may be more likely to answer the vision questions, and the ECP may maintain contact with the customer during periods of time when the customer would not otherwise interact with the ECP.

It is noted that, in some aspects, the hybrid e-commerce platform may not capture payment information prior to sending the selected product for in-person inspection. Instead, the customer may inspect the product, and, if the customer desires to purchase the product, may provide the payment information to the in-person provider (e.g., the ECP). The in-person provider may then provide payment for the product purchased by the customer 112 to the vendor that shipped the product for in-person inspection and return any unpurchased products to the vendor. If any unpurchased products are not returned to the vendor, the in-person provider may also provide payment for the unpurchased/unreturned products. In an aspect, the in-person provider may provide information associated with the purchase to the hybrid e-commerce platform, and the hybrid e-commerce platform may charge an account associated with the in-person provider and facilitate payment to the vendor for the purchased product (and any unreturned/unpurchased products). The hybrid e-commerce platform may also charge the in-person provider a fee for facilitating the in-person inspection, and such fee may be charged to the account of the in-person provider or billed to the in-person provider, who then provides payment to the hybrid e-commerce platform. The fee charged to the in-person provider may be charged to the account of the in-person provider or billed in real-time (e.g., at the time the product is requested and/or shipped for in-person inspection) or on a periodic basis (e.g., once a week, once a month, etc.). In yet another additional or alternative aspect, the hybrid e-commerce platform may charge vendors for products sold to customers via the hybrid e-commerce platform. For example, a frame and lens/lab vendor may pay a fee (e.g., a percentage of sales transaction fee) for the sale of the vendor's products via the hybrid e-commerce platform, which may include products that are purchased following an in-person inspection facilitated through the hybrid e-commerce platform, and/or products purchased (e.g., complete prescription eyewear) through the hybrid e-commerce platform without an in-person inspection.

Alternatively or additionally, other purchasing processes are disclosed, and further depicted in FIGS. 13A-E. As shown in FIG. 13C, a customer may purchase a product directly from the hybrid e-commerce platform. For example, a customer affiliated with a partnering optical retailer and possessing a current prescription, but not requiring special measuring or fitting from their eye care professional, may purchase complete eyewear from the hybrid e-commerce platform. As yet another additional or alternative embodiment, and as shown in FIG. 13D, a customer may order directly from the hybrid e-commerce platform, but may still seek assistance from their in-person provider. For example, a customer affiliated with a partnering optical retailer and possessing a current prescription which does require special measuring or fitting from their eye care professional may purchase eyewear frames at the hybrid e-commerce platform and meet with their optical retailer for fitting and measuring. The eyewear frames could be shipped to the optical retailer or potentially directly to the customer. Thus, an in-person visit/consultation could occur first, where information is collected during the in-person visit and is shared with a hybrid e-commerce server that provides the hybrid e-commerce platform.

In situations where the customer does not purchase a product while visiting their in-person provider, the customer may later be contacted by the hybrid e-commerce platform or by the independent retailer's separate platform (e.g., email marketing software), or both. The communication may prompt customer to shop at the hybrid e-commerce platform (e.g., commercity.us or commercity.co). When the communication is sent from the hybrid e-commerce server, the communication may include information about any products previously selected for in-person inspection that were not purchased, and may include additional products that were not selected. The additional products may be identified by the hybrid e-commerce server as being complementary to or similar to the products selected by the customer. For example, the communication may identify the products selected by the customer, and may suggest that others that selects those products were interested in or ended up purchasing one or more of the additional products instead. This may provide an increased opportunity to cause the customer to purchase a product via the hybrid e-commerce server, and, if a product is purchased, to schedule an additional appointment with the in-person provider. When the customer purchases a complete product (e.g., eyewear) from the hybrid e-commerce platform, the hybrid e-commerce platform (including HECP) may directly manage third party lens processing vendors and/or coordinates with the in-person provider for assistance in gathering customer information to process the final product (e.g., lens manufacturer for eyewear, customer-chosen options, accessories, etc.).

Another additional or alternative purchasing process may include a “reverse” process, in which an in-person provider provides customer-related data (generally collected during a customer visit with the in-person provider) to the hybrid e-commerce server (or HECP, who then enters it into the hybrid e-commerce server) in order to assist in the selection of at least one product displayed to the customer on the hybrid e-commerce platform. Generally, this process begins with an appointment between the customer and the in-person provider. Alternatively, the in-person provider may be providing the data from the customer's file (e.g., medical file or optical file). If the customer's file is stored in electronic form (e.g., an electronic medical record or electronic optical file), the in-person provider may provide all or a portion of the customer's electronic file to the hybrid e-commerce server. During the appointment, the customer will decide whether or not to purchase a product(s). At some point following the appointment, the in-person provider may share any customer data with the hybrid e-commerce server regarding any vision needs and/or any recent transaction(s), or lack of transaction(s). Such data could include prescription, type of lens design needed, and any information gathered during the customer's appointment/visit with in-person provider. The hybrid e-commerce server may subsequently use such data to limit the product(s) presented to the customer during a later visit to the hybrid e-commerce platform by the customer. Thus, the in-person appointment may function as an in-person consultation used to refine product selection for the customer on the hybrid e-commerce platform. At some point following the appointment, the hybrid e-commerce server may notify the customer to visit the hybrid e-commerce platform. Such notification may include email message notifications, text message notifications (e.g., simple message service (SMS) notifications and multimedia message service (MMS) notifications, etc.), automated voice response message notifications, other messaging/notification systems, or a combination thereof.

Upon visiting the hybrid e-commerce platform, the customer may choose to use or not use the consultation tool. Further, the customer may choose to use (or not use) any social media functionality (e.g., “My Looks”). As a result, the customer is able to purchase a complete product (e.g., “complete eyewear”) due to the data previously shared by the in-person provider. In another additional or alternative embodiment, the customer may purchase the frame(s) and lenses, but may still need to return to the in-person provider for additional measurements to complete the processing. As previously described, the hybrid e-commerce server may manage the completion of lens processing and/or final completion of the eyewear.

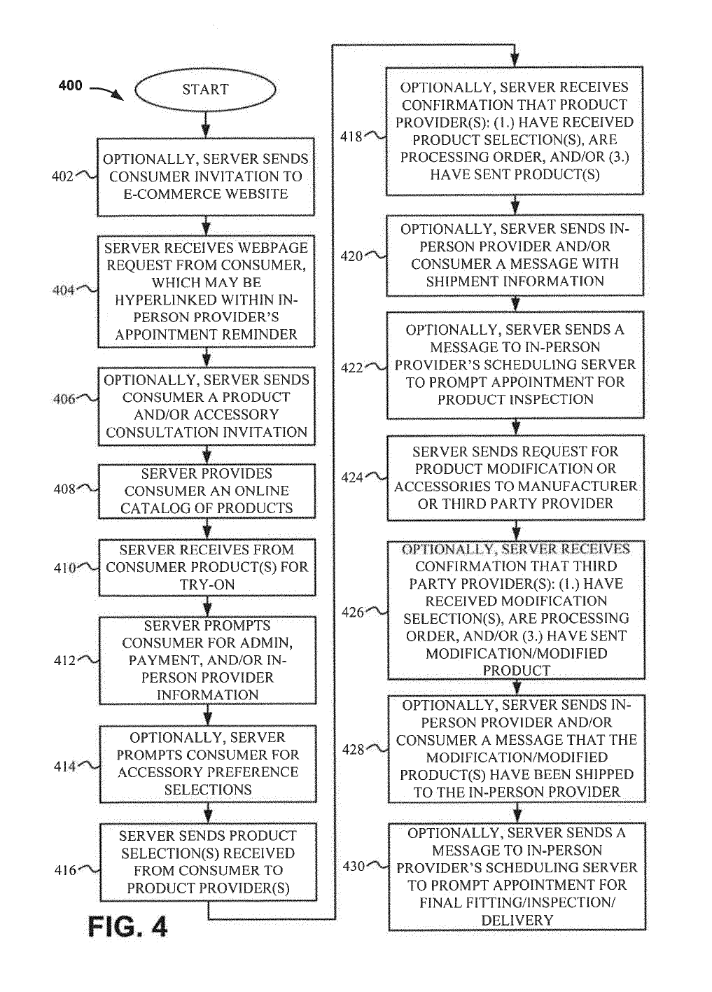

FIG. 4 is a flow chart, illustrating a method executed by an e-commerce server for integrating e-commerce and retail commerce, according to one embodiment of the disclosure. The method 400 may begin at block 404, where the hybrid e-commerce server 120 receives a request from customer 112 for a landing page of the hybrid e-commerce platform. In many embodiments, the customer's request is prompted by a hyperlink embedded in the in-person provider's appointment reminder, which may be provided to the customer 112 via an email message or a text message. Optionally, the hybrid e-commerce server may be used to prompt customer 112 to navigate to the hybrid e-commerce platform, shown at block 402. This optional step may be used in situations where the in-person provider does not have the ability to send electronic appointment reminders. It may also be used as a reminder in situations where the customer 112 was non-responsive to the in-person provider's original appointment reminder and hyperlink to the hybrid e-commerce platform. At block 406, the hybrid e-commerce server 120 prompts the customer 112 to complete a frame and/or lens consultation, in some embodiments.

In an additional or alternative embodiment, consultations may be separated during the customer's flow through the website; especially for products comprised of multiple components with distinct attributes. For example, prescription eyeglasses and sunglasses are made up of a frame, for which people have fashion preferences, and a prescription lens, for which people have medical vision correction need. For jewelry, the consultation may be split up during the customer's flow through the website into a design/fashion consultation and a quality (e.g., cut, clarity, color, carat weight, a.k.a. the diamond 4Cs) and/or cost consultation. The product consultation may collect customer preference information that may be used by the hybrid e-commerce platform to narrow and tailor the product(s) displayed to the customer 112 by the hybrid e-commerce platform in order to help the customer 112 efficiently choose the product best tailored to their preferences. At block 408, the hybrid e-commerce server 120 provides the customer 112 a catalog of products, preferably tailored to customer's preferences. At block 410, the hybrid e-commerce server 120 receives, from the customer 112, the selection(s) of product(s) for shipment to the in-person provider 160. At block 412, the hybrid e-commerce server 120 prompts the customer 112 for selection of an in-person provider for shipment of the selected product(s). The hybrid e-commerce server 120 may also prompt the customer 112 to provide administrative or payment information, as required.

In some embodiments, the hybrid e-commerce server 120 may prompt the customer 112 for preferences related to the further processing of the selected product(s) or related accessories, at block 414. For example, as related to eyewear, the hybrid e-commerce server 120 may prompt the customer 112 for any preferences related to lenses (e.g., i.) design preferences, such as single vision, progressive, bifocal, trifocal, computer use, everyday use, etc.; ii.) material preferences, such as high index, polycarbonate, plastic, glass, etc.; and/or iii.) treatment preferences, such as anti-reflective, scratch coatings, tints, polarized, photochromic, etc.). At block 416, the hybrid e-commerce server 120 sends notification of the product(s) selected by customer 112 to the product provider(s)'s server, along with the shipment information (e.g., requested ship date, requested delivery date, shipping method, shipping address, etc.) and information associated with the in-person provider 160. Optionally, at block 418, the hybrid e-commerce server 120 receives a confirmation from product provider(s) that they have received the product selection, are processing the order, and/or have sent the product(s) to the in-person provider 160. In most embodiments, the hybrid e-commerce server 120 sends the in-person provider 160 a message with shipment information for the selected product(s), as shown at block 420. The shipment information may be a notice that the product(s) is about to ship, the product(s) has shipped, or the expected delivery date of the product(s). When the hybrid e-commerce server 120 is configured to communicate with an in-person provider's scheduling server 520, the hybrid e-commerce server 120 may send a message to the scheduling server 520 to cause the scheduling server to prompt the customer 112 to schedule an appointment for an in-person inspection of the product(s). In some embodiments, block 420 and block 422 may be combined in a single message format.

After block 422, the customer 112 inspects 180 the shipped product(s) with the in-person provider 160. At block 424, any further modification of the product(s) selected for purchase by the customer 112 may be monitored and/or managed by the hybrid e-commerce server 120. This includes modifications (or accessories) completed by the original product manufacturer or modifications completed by a separate third party provider. For example, as related to eyewear, the hybrid e-commerce server 120 may communicate with a lens provider regarding a lens order for the customer 112's selected eyewear frame. Similar to blocks 418, 420, and 422, the hybrid e-commerce server 120 may also monitor and/or manage any final product modifications, including accessories, as shown at blocks 426, 428, and 430. For example, the hybrid e-commerce server 120 may receive a confirmation from the third party provider(s) (or original manufacturer, depending upon who is performing the follow-on modification) that they have received the modification selection (e.g., lens order), are processing the order, and/or have sent the modification or modified product(s) back to the in-person provider. It should be understood that the modification may include accessories that are to be installed by the in-person provider. For example, in some situations, the ECP may be responsible for installing the lenses into the eyeglass frame. Similar to blocks 420 and 422, blocks 428 and 430 may be combined within a single message format from the hybrid e-commerce server 120. Alternatively, it should be understood that further processing of the product(s) or third party products (e.g., prescription lenses) may be managed by the hybrid e-commerce platform 130, or it may be managed independently. As an additional or alternative example, an ECP may process the lenses at their preferred lens lab separate from any affiliation with the hybrid e-commerce system. In various embodiments, the HECP may encourage an in-person provider (e.g., ECP) to complete the order (e.g., eyewear) using a HECP-affiliated provider (e.g., lens lab); however, the product transaction may end with the initial product (e.g., frames only).

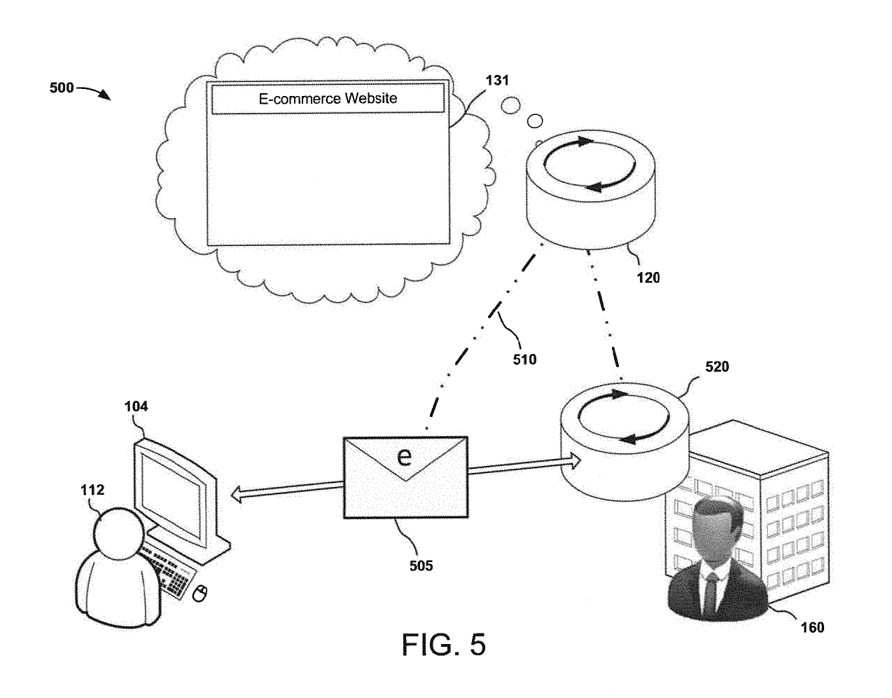

FIG. 5 is a diagrammatic view, illustrating a method 500 for coordinating an appointment reminder with at least one hybrid e-commerce platform, according to at least one embodiment of the disclosure. In many embodiments, in-person provider 160 already has a server/software 520 for scheduling appointments (and/or billing and other administrative functions). In such embodiments, in-person provider 160 sends the customer 112 an appointment scheduling reminder, 505. The appointment reminder comprises a hyperlink to an e-commerce landing page (e.g., a landing page of the hybrid e-commerce platform 130 of FIG. 1) and an invitation from the customer's ECP to visit the e-commerce landing page to select eyewear to be inspected at their upcoming eye appointment. The hyperlink within the appointment reminder, when selected, navigates 510 the customer 112's web browser to the hybrid e-commerce platform 130. The customer 112 may browse the hybrid e-commerce platform 130 independently of any appointment reminder from their in-person provider 160.

In some embodiments, the hybrid e-commerce server(s) 120 may incorporate the scheduling functions of in-person provider server(s) 520. In such embodiments, the hybrid e-commerce server(s) 120 may manage the hybrid e-commerce platform 130 and product tracking functions as described in the paragraphs above, and may provide the administrative, scheduling, and/or billing functions for in-person provider 160, including appointment scheduling reminders 505, not shown.

FIGS. 6A-6P are diagrammatic views, illustrating methods of providing a customer consultation within an e-commerce system, according to at least one embodiment of the disclosure. FIG. 6A outlines broadly a consultation method 600, where the customer 112 navigates to an e-commerce landing page, hosted by the hybrid e-commerce server 120. Upon arrival at landing page 631, or alternatively, upon beginning a product search from page 631, the hybrid e-commerce server 120 prompts the customer 112 with a consultation invitation 632. A consultation invitation allows the customer 112 the ability to tailor the displayed products to their personal preference, and thereby, narrow the displayed products. The consultation webpage(s) 633 queries the customer 112 using a series of questions to determine the customer 112's preferences. The hybrid e-commerce server 120 applies the customer 112's preferences to the product catalog in order to determine a customer-specific product page.

FIG. 6B-FIG. 6H are exemplary webpages for a consultation invitation related to eyewear. FIG. 6B is an example of an invitation to begin a consultation for eyewear. FIG. 6B also serves as an example of an invitation from the customer 112's affiliated Eye Care Provider to use the hybrid e-commerce platform 130 to select frames for in-person inspection/try-on at the ECP. Although in this example the fashion consultation initiates immediately after this invitation, the invite is to engage the customer 112 to use the hybrid e-commerce platform 130 to select frames for in-person inspection/try-on. FIG. 6C is a webpage providing the customer 112 an outline of what to expect during the shopping process. It provides an introduction and overview of the hybrid e-commerce method and system to the customer 112. FIG. 6D is a webpage containing the initial consultation queries. Such questions may include gender, which may be used to narrow the style and color of the displayed products. It may also include technical questions, such as lens type, which may limit the frames selections available. FIG. 6E is a webpage with exemplary products from distinct product categories, allowing the hybrid e-commerce server 120 to narrow the product catalog to distinct product categories based upon selections from the customer 112. It should be noted that the webpage may show more than just exemplary products. For example, the webpage may include a photo of a model with exemplary eyeglasses and other corresponding fashion style apparel and possibly hair style. Alternatively, the displayed photos may not actually show eyewear, but instead may display apparel (or other accessories) to display various categories. For example, a bust of man in a business suit may be used to depict a “business category.” As a further example, a surfboard or skateboard may be used to depict a “surf-skate” category. Although not shown, another webpage may include a fashion consultation for preferred brands.

FIGS. 6F-6H are webpages that allow the customer 112 to further define themselves and/or their preferences, such as the shape of their face or their eyeglass style preference. Exemplary eyewear and sunglass styles may be depicted. FIG. 6I is a webpage showing an exemplary display of products based upon the customer 112's consultation responses. FIG. 6J is a webpage showing that the customer 112 may further customize the search results provided by the consultation. FIG. 6K is a product detail page with virtual try-on functionality, which may use the camera linked to or integrated with the customer 112's computer, tablet, etc. in order to upload an image of the customer 112. FIG. 6L is a shopping bag (or shopping cart) webpage with an exemplary summary of the customer 112's product selection for in-retail try-on or purchase. This webpage may have the additional functionality of selecting product(s) for in-person inspection/try-on. This selection of try-on frames could be from the online “consultation”, or the customer could have searched and selected frames on their own. Additionally, the exemplary shopping cart webpage of FIG. 6L may enable a customer to designate products in the virtual “shopping cart” for purchase or try-on. For example, the customer may select a first product for in-store try-on/inspection using the “try-on” icon, while selecting a second product for purchase (e.g., without first performing an in-person try-on/inspection) by selecting the “purchase” icon. This feature may be beneficial for several industries, such as the optical industry. Further, in the clothing industry, customers tend to be hesitant to purchase articles of clothing (e.g., jeans, shoes, shirts, etc.) without having the ability to first try them on. However, once the customer found an article of clothing that is satisfactory (e.g., fits how the customer would like it to, is comfortable, etc.), the customer may be more comfortable purchasing additional items of the same time from the same manufacturer.

For example, the customer may visit a retail store and try-on several different brands of jeans or even different styles of jeans (e.g., boot-cut, slim-fit, etc.) of the same brand, and, upon finding a pair of jeans that has a desired fit, may be comfortable purchasing additional pairs of jeans of the same style and of the same brand, only in different finishes or colors. In such instances, the customer may be comfortable purchasing the additional pairs from the hybrid e-commerce platform 130, but may be more hesitant to purchase a different brand of jeans or a different style of jeans. Thus, the customer may use the hybrid e-commerce platform 130 to purchase items that do not require in-person inspection directly, while requesting in-person inspection for other items, using a single checkout process. This feature may further benefit the customer because it is often difficult for some customers, such as customers with uncommon sizes or customers with a popular size, to find a store that has their size in stock. Thus, the hybrid e-commerce platform 130 and the shopping cart page of FIG. 6L provided by the hybrid e-commerce server 120 may reduce or a eliminate the need for customers to visit multiple stores to find a product in a desired size, color, etc.

FIG. 6M illustrates an exemplary sign in, create an account, and/or shop as a guest webpage. The webpage is not necessarily part of the product selection process. FIG. 6N is an exemplary summary of the customer's product selection for in-retail try-on. This selection of try-on frames could be from the online “consultation” (e.g., as described with reference to FIG. 6B-FIG. 6H), or the customer could have searched for and selected frames on their own (e.g., without the online “consultation”).

FIG. 6O is an exemplary subsequent survey and/or consultation. In this exemplary illustration, the subsequent consultation is a lens consultation. It should be understood that multiple consultations and/or surveys may be incorporated, depending upon industry and product. It should also be understood that the consultations/surveys may vary in method and/or scope. In the exemplary illustration of FIG. 6O, the lens consultation differs from the fashion survey (consultation) in that the lens survey is done online and the survey results are provided to the in-person provider along with the lens and lens treatment recommendations. Thus, unlike the fashion consultation, where the survey and results are experienced online, the customer will receive the results or recommendation from their affiliated in-person provider during the customer's visit to inspect the selected try-on product. Depending on the industry, they may, or may not have a variation of the survey online and receive consultation from the in-person provider. In many embodiments, the fashion and lens consultations are linked to an in-person provider web application which shares survey results, product recommendations, try-on selections, and/or social ratings with the in-person provider for an improved and informed in-person visitation.

FIG. 6P illustrates an exemplary webpage for check-out, as shown on the top half of the page. In many embodiments, the checkout may differ depending on the purchase process, wherein the product(s) are shipped to try-on/inspect at the in-person provider. In some embodiments, the second survey/consultation for lenses is located within the checkout page. The location of any subsequent survey/consultation may change depending on usage results, and further, may vary in user flow placement by industry.

FIG. 6Q illustrates an exemplary method of locating an in-person provider. The illustrated embodiment affiliates the customer with the retailer needed to complete the transaction, and therefore is different from a typical store locator. The customer along with try-on selections and information gathered may be affiliated and shared with the selected in-person provider. In an embodiment, the interface illustrated in FIG. 6Q may include additional options (not shown in FIG. 6Q), such as a preferred appointment date and time, or a range of appointment dates and times, a type of appointment (e.g., in-person try-on, in-person consultation, such as an eye exam, etc.), or a combination thereof. To facilitate such functionality, a hybrid e-commerce platform and/or a hybrid e-commerce server (e.g., the hybrid e-commerce platform 130 and/or the hybrid e-commerce server 120 of FIG. 1) may be integrated with or have access to appointment information associated with affiliated in-person providers (e.g., in-person providers that utilize the services provided by the hybrid e-commerce platform and the hybrid e-commerce server). The in-person provider locations presented via the interface illustrated in FIG. 6Q may correspond to in-person providers that have appointments available that satisfy the options selected by the customer (e.g., an available appointment on the preferred appointment date and time or an available appointment within the range of appointment dates and times, etc.). The customer may then select one of the in-person provider locations for scheduling an appointment. Additional interfaces may be presented to facilitate the scheduling of the appointment, or additional options for scheduling the appointment may be presented within the interface illustrated in FIG. 6Q. Thus, the in-person provider locator interface illustrated in FIG. 6Q may provide the customer with a simplified way of locating an in-person provider and scheduling an appointment with the in-person provider.

FIG. 6Q-1 illustrates an exemplary webpage presenting information associated with an in-person provider that affiliated with a customer. In an aspect, the exemplary webpage shown in FIG. 6Q-1 may be shown in response to a search conducted using the interface illustrated in FIG. 6Q. In an additional or alternative aspect, the webpage illustrated in FIG. 6Q-1 may be shown instead of the interface of FIG. 6Q, and may list in-person providers that are affiliated with the customer. Affiliation of a customer with an in-person provider may occur when the in-person provider uploads their customers to the hybrid e-commerce platform, such as by uploading a list of customers that the in-person provider has previously provided services to and/or sold products to. Additionally or alternatively, affiliation of a customer and an in-person provider may occur when the customer schedules an appointment with an in-person provider using the interface of FIG. 6Q. In an aspect, a customer may be affiliated with an in-person providers that operates multiple locations (e.g., a multi-store in-person eye care provider), and the customer may be affiliated to only one store location or the customer may be affiliated with multiple store locations within the in-person provide chain. Thus, in an aspect, the in-person providers listed in the interface of FIG. 6Q-1 may be affiliate in-person providers that the customer has previously interacted with or visited, which may include a single store for some in-person providers (e.g., for in-person providers that the customer has only visited a single store) or may include multiple stores for an in-person provider (e.g., for in-person providers that the customer has visited multiple stores). Upon selection of a particular in-person provider from the list, the webpage may be updated wo show the information shown in FIG. 6Q-1.

As shown in FIG. 6Q-1, the customer may be presented with information associated with an in-person provider (e.g., St. Anthony Eye Clinic) that is affiliated with the customer. An in-person provider may be affiliated with the customer when the customer has previously used the in-person provider for services and/or made purchases or inspected products at a location operated by the in-person provider. The information associated with the affiliated in-person provider may include a section providing a brief summary of the in-person provider (e.g., the about us section), a section that identifies one or more employees employed at the in-person provider (e.g., the doctors section), and a section that provides information associated with services provided by the in-person provider (e.g., the services section). For non-affiliated in-person providers, or for customers searching for an in-person provider and who do not have an in-person provider for a particular service, the interface of FIG. 6Q may be used to search for and locate an in-person provider.

In an aspect, the one or more employees listed in the employees section may correspond to employees that the customer has interacted with during a previous visit to the in-person provider. For example, in FIG. 6Q-1, the customer may have previously interacted with or scheduled an appointment with one or more of the doctors listed in the “doctors” section. The hybrid e-commerce platform may access appointment information to identify the employees with whom the customer has interacted with or is scheduled to interact with. Alternatively or additionally, the in-person provider may provide information to the hybrid e-commerce platform to identify the employees that the customer has interacted with, and that information may be used to determine the employees identified in the exemplary interface of FIG. 6Q-1. Presenting information (e.g., biographical information, education information, etc.) associated with the employees of the in-person that the customer has previously interacted with may help create a stronger relationship between the customer and the in-person provider, since the customer will be familiar with the employees. Additionally, if it is a first appointment, the employee information may enable the customer to identify the employee that the customer is to see during the upcoming appointment with the in-person provider, which may make the customer more comfortable about the visit.

FIG. 6R illustrates an exemplary webpage for “My Looks” that combines typical product wish list functionality with unique social media affirmation and rating functionality. The social media functionality may be provided by a hybrid e-commerce platform (e.g., the hybrid e-commerce platform 130 of FIG. 1), integrated using an API with known social media (Facebook, Twitter, Instagram, etc., or any combination thereof). Standard wish list functionality is the ability to save products for purchase, or try-on/inspection selection. In contrast, and as illustrated in the exemplary embodiment of FIG. 6R, the “My Looks” page allows the customer to request feedback from friends and family and to rate and comment on product(s) (e.g., frames). The customer may also include images of themselves wearing the product (e.g., frames) created by the virtual try-on functionality of the product detail page. It should be understood that the virtual try-on feature may be used in various locations within the website, not just part of the product detail page. Such known methods of virtual try-on include TryLive and Fitting Box. It is noted that the hybrid e-commerce systems described in the present disclosure provide improvements over existing virtual try-on systems. For example, existing virtual try-on systems allow a customer to see what a particular product may look like on the customer, however, the appearance of the product, as shown in the virtual try-on, may not accurately reflect the way the product actually fits or looks when tried-on in person, such as during an in-person inspection scheduled using the hybrid e-commerce system of the present disclosure. Furthermore, by not requiring the customer to commit to purchasing the product before having an opportunity to inspect the product in-person, the customer may verify that the virtual try-on accurately reflects the way the product looks, feels, fits, etc. prior to being charged for the purchase of the product.

In many embodiments, the in-person provider will also be able to rate and comment on the customer's frame selection using the in-person provider web application. Additionally, and in most embodiments, the in-person provider will be able to recommend additional frames for the customer to consider for try-on/inspection. This may be beneficial because the in-person provider may be aware of particular circumstances associated with the customer that may not be particularly suited to one or more of the selected frames. For example, the in-person provider may have knowledge that the customer is involved in sports, and may also have knowledge that one of the eyewear frames selected by the customer for in-person inspection or rating and comment, is not well suited for sporting activities, such as when the eyewear frames block the customer's peripheral vision. The in-person provider may be able to comment on the eyewear frames to inform the customer that such frames are not suited for aspects of the customers lifestyle, such as the customer's participation in sporting activities. This may help the customer select product(s) for in-person inspection that will be more satisfactory for the customers lifestyle, thereby increasing the customer's satisfaction with any subsequent product purchase. FIG. 6S illustrates an exemplary webpage for Kari's Looks, which is the view of an exemplary customer's (e.g., a customer named Kari) “my looks” selections, as viewed by the customer's friends and family. In most embodiments, the friends and family of the customer can rate and comment on the customer's frame selection on this page. Further, the friends and family may also recommend other frame selections. Such webpage may also allow customer's friends and family to take their own fashion consultation as well as to shop using the hybrid e-commerce platform 130.

FIG. 6T illustrates exemplary rate and comment features of the Kari's Looks webpage, which is an expanded view of rating and commenting functionality of Customer Looks page. FIG. 6U illustrates exemplary ratings of the Kari's Looks webpage, which is an expanded view of others ratings and reviews functionality of Customer Looks page. FIG. 6V illustrates an exemplary mobile version of the webpage of FIG. 6S, which may further include the expanded view of rating and commenting functionality (FIG. 6V-1) and/or the expanded view of others ratings and reviews functionality (FIG. 6V-2). In an embodiment, the hybrid e-commerce server may be configured to generate feedback for product manufacturers based on the comments and ratings provided via the “my looks” web pages of customers utilizing the hybrid e-commerce platform. This feedback may enable the product manufacturers to identify products that are highly rated and likely to be better selling products, and to identify products that are poorly rated and likely to not be well received by customers. Additionally, the feedback may provide the product manufacturer with information regarding the reasons for the ratings, whether high or low, which may enable the manufacturer to refine or redesign subsequent versions of the product to increase the likelihood that the subsequent version of the product will be better received by customers.

FIG. 6W illustrates an exemplary account section, where customers may manage account settings and look up order history. In most embodiments, the account section will include product try-on and/or “my looks” history. FIG. 6X illustrates an exemplary purchases section, which shows the purchase history page of the My Account section.

FIG. 6Y-1 illustrates an exemplary in-person provider login page for an in-person provider web application. Such web application may include its own branding (e.g., using a white label or customized website tailored to include branding information associated with the in-person provider). FIG. 6Y-2 illustrates an exemplary in-person provider “dashboard.” In most embodiments, the dashboard serves as the landing page of the in-person provider web application, which displays an overview of information to assist the in-person provider with managing their Commercity™ business and in-person visits/appointments. Exemplary information managed by this function may include pending customer visits; social media functionality to connect frame and lens vendors to industry peers; frame features; lens features; and industry news.

FIG. 6Y-3 illustrates an exemplary in-person provider customer consultation webpage, which provides the in-person provider with information on the customer to be used during a visit, appointment, and/or inspection. Exemplary information managed by this feature may include customer answers from the fashion survey/consultation; customer answers and recommendations from the lens survey/consultation; and information on the frames selected by the customer for try-on/inspection. FIG. 6Y-4 illustrates an exemplary in-person provider customer consultation follow up webpage, which may provide an in-person provider the ability to share the results of the in-person visit, appointment, inspection, etc. with the hybrid e-commerce database. In most embodiments, the in-person provider may record the purchase results, including if a try-on frame was purchased, if eyeglasses or sunglasses from their retail selection were purchased, and the type of lenses purchased. The in-person provider may also enter the customer's current prescription, which may be performed by an in-person provider portal. Additionally, other information may also be entered through the portal, e.g., the customer's birthdate, gender, any children information, etc. The portal may be a professional web application, which may support the sharing of customer information between the hybrid e-commerce platform and the in-person provider.

FIG. 6Y-5 illustrates an exemplary in-person provider reports webpage, which is the landing page for the reports section of the in-person provider web application. In most embodiments, customer and transaction reporting will be provided, including but not limited to customer contacts, customer appointments, post appointment results, sales history, try-on inventory, pending online orders, and/or sales reporting.

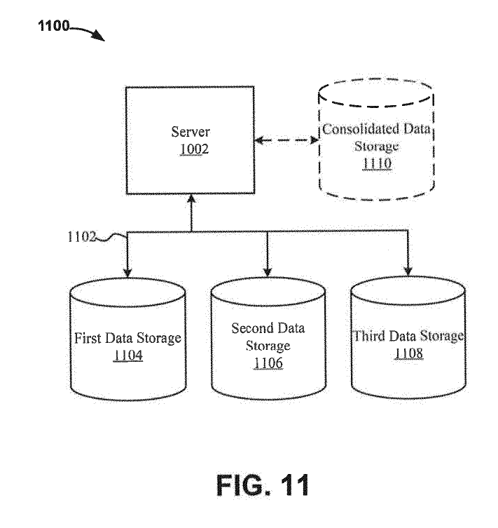

The hybrid e-commerce platform may include advertisements and/or marketing from vendors and/or other third parties. The advertising/marketing may be directed at the customers on the hybrid e-commerce platform/website, but may also include advertising/marketing directed at the in-person providers on the in-person provider web application. Additionally, in-person providers (e.g., an ECP) and vendors (e.g., lens manufacturers) may also target advertisements to customers via the HECP. In terms of embodiments configured for the optical industry, both frame and lens vendors may be offered multiple banner advertising placements, features and news articles on both the HECP (e.g., Commercity) customer and professional websites. The advertising may be managed as a separate business function with vendors, or it may be included with licensing or usage agreements. The hybrid e-commerce server and/or the hybrid e-commerce platform may provide interfaces and options that enable the in-person providers and/or product providers to create and customize the advertising and marketing campaigns. This may include configuring the frequency at which the advertising is transmitted to the customers, creating the content included in the advertising transmitted to the customers, specifying demographics or other information that may be used to identify a class of customers that are to receive the advertising or a particular advertisement, etc. Additionally or alternatively, the hybrid e-commerce server, the hybrid e-commerce platform, and/or the HECP may create advertising or marketing campaigns on behalf of the in-person providers or product providers. Furthermore, an in-person provider (or product provider) may provide information identifying the customers (or in-person providers) to which the advertising may be sent, and the information may be reserved by the hybrid e-commerce server and/or the hybrid e-commerce platform for use only with advertising or marketing campaigns for the in-person provider that provided the information, as described further with reference to FIG. 11. The in-person providers may be charged a fee for using the features provided by the hybrid e-commerce server and/or for creating advertising and marketing campaigns facilitated by the hybrid e-commerce platform, or such features may be provided at no additional charge. The advertising and marketing campaigns may be provided, at least in part, via e-mail, text messages, social media, print media (e.g., direct mailers), or any other form of advertising/marketing. Additionally, the in-person providers may be charged a fee when the HECP creates the advertising and marketing campaigns, or the HECP may create the advertising and marketing campaigns at no charge (or no additional charge above and beyond any licensing and usage agreement between the HECP and the in-person provider or the product provider).

The hybrid e-commerce platform/HECP may include a rewards and/or loyalty program for in-person providers. The program may be established for the customer sales representatives of the in-person providers. There may also be a rewards and/or loyalty program for the in-person providers' owner/ownership. The hybrid e-commerce platform/HECP may also offer rewards and/or loyalty programs for the customers. Rewards and/or loyalty programs may be managed and/or funded by the hybrid e-commerce platform/HECP, by the product vendors, by other third parties, or any combination thereof.

FIG. 7 is a diagrammatic view, illustrating a method 700 of coordinating further modification or processing of a product(s) with third party providers, according to at least one embodiment of the disclosure. In many embodiments, the product(s) selected by the customer 112 requires further processing and/or modification. Frequently, this processing and/or modification cannot be completed by the customer 112 or the in-person provider 160. In such situations, requests for further processing and/or modification (including accessories) are sent to an original equipment manufacturer 743 or a third party provider 744. For example, in the case of eyewear frames, the third party provider 744 may be a lens manufacturer, a lens processing lab, or any combination thereof (whether commonly or individually owned). Frequently, the third party provider 744 may be a lens processing lab owned by a lens manufacturer, or it may be an independent lab. In most embodiments, the selected product(s) are made available to the manufacturer 743 or the third party provider 744 for processing/modification. The specific product selected by the customer 112 following the in-person inspection may be sent to the third party provider 744 from the in-person provider 160, or alternatively, the same model (but not the specific example inspected) may be sent to the third party provider 744, possibly from a party other than the in-person provider 160 (e.g., manufacturer, fulfillment center/warehouse, etc.). In other embodiments, the selected product(s) may not need to be sent to the manufacturer 743 or the third party provider 744. In such cases, only an order request needs to be sent. For example, if third party provider 744 is a lens provider, the lens provider may be able to manufacture the required lenses without receiving the eyewear frame from the ECP. In such case, the lens provider would only need the lens order and the details of the frame(s) selected.

The hybrid e-commerce server 120 may monitor and/or manage the further processing of any selected product(s). In such embodiments, the hybrid e-commerce server 120 may be configured to communicate with the manufacturer's server(s) 743a, any third party provider's server(s) 744a, and/or fulfillment center/servers, thereby allowing the hybrid e-commerce server 120 to monitor and/or manage the follow-on processing/modification of the selected product(s), as described in paragraph 31 above and elsewhere herein. When the hybrid e-commerce server 120 is configured to communicate with in-person provider server(s) 520, the hybrid e-commerce server 120 may notify in-person provider 160 that the selected product(s) are (1.) complete with modification, and/or (2.) ready to ship. In-person provider server(s) 520 may use the product shipment information as a prompt to schedule (as shown by sending an email, 705, but may also include without limitation social media messaging, SMS/MMS text, printed media via network-connected printing service, etc.) with the customer 112 either delivery or another inspection of the selected product(s).

When another inspection is to occur, the hybrid e-commerce server 120 may obtain available appointment information from the in-person provider server(s) 520 (or another server of the in-person provider 160 configured to manage appointment dates and times), and may use the available appointment information to schedule the inspection. In an embodiment, the hybrid e-commerce server 120 may coordinate the available appointment information and shipping information (e.g., estimated ship date information, estimated arrival date information, etc.), such that the inspection appointment is scheduled on a date and time when the product(s) has been received by the in-person provider 160. If the product(s) was shipped to the customer 112, the hybrid e-commerce server 120 may coordinate the available appointment information and shipping information (e.g., estimated ship date information, estimated arrival date information, etc.), such that the inspection appointment is scheduled on a date and time when the product(s) has been received by the customer 112. By coordinating the scheduling of the subsequent appointment/inspection using the hybrid e-commerce server 120, the experience for the customer 112 may be simplified, as the customer is not responsible for tracking shipping dates, estimated arrival dates, etc. Additionally, coordinating the scheduling of the subsequent appointment/inspection using the hybrid e-commerce server 120 may simplify the appointment scheduling process for the in-person provider 160, since the in-person provider 160 does not have to coordinate the shipping information with the customer's schedule and the available appointment dates and times.

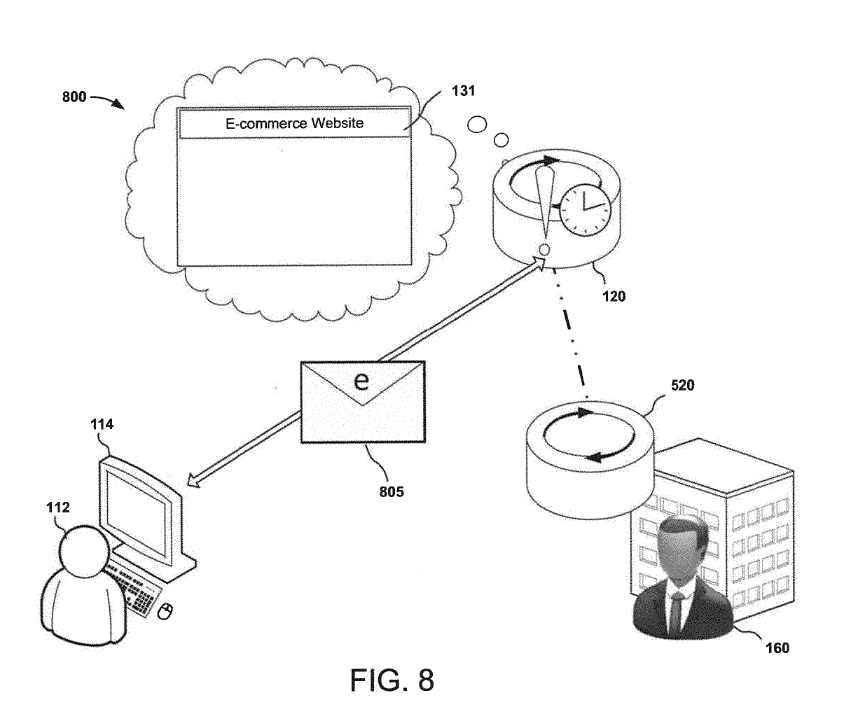

FIG. 8 is a diagrammatic view, illustrating a method 800 for reminding a customer to visit the hybrid e-commerce website, according to at least one embodiment of the disclosure. In most embodiments, the hybrid e-commerce server(s) 120 may track whether the customer 112 has visited a hybrid e-commerce website 131. Additionally, hybrid e-commerce server(s) 120 may receive a message from in-person provider 160 indicating that the customer 112 has not (1.) visited the hybrid e-commerce website 131 and/or (2.) selected product(s) for purchase or in-person inspection. The hybrid e-commerce server(s) 120 may determine, after a designated length of time, that a reminder 805 should be sent to the customer 112 reminding the customer 112 to visit the hybrid e-commerce website 131. The designated length of time may be measured, without limitation, from when the initial appointment invitation 505 was sent or when the customer 112 had an appointment with in-person provider 160. In most embodiments, the hybrid e-commerce server(s) 120 sends the customer 112 a communication 805 (e.g., email, social media messaging, SMS/MMS text, printed media via network-connected printing service, etc.) reminding them to visit the hybrid e-commerce website 131 in order to select the product(s). In additional or alternative embodiments, the hybrid e-commerce server(s) 120 may prompt the in-person provider server(s) 520 to remind the customer 112, not shown. The communication 805 may include incentives (e.g., discounts, rewards points, etc.) for purchasing the product(s) from the hybrid e-commerce website 131 and/or in-person provider 160.

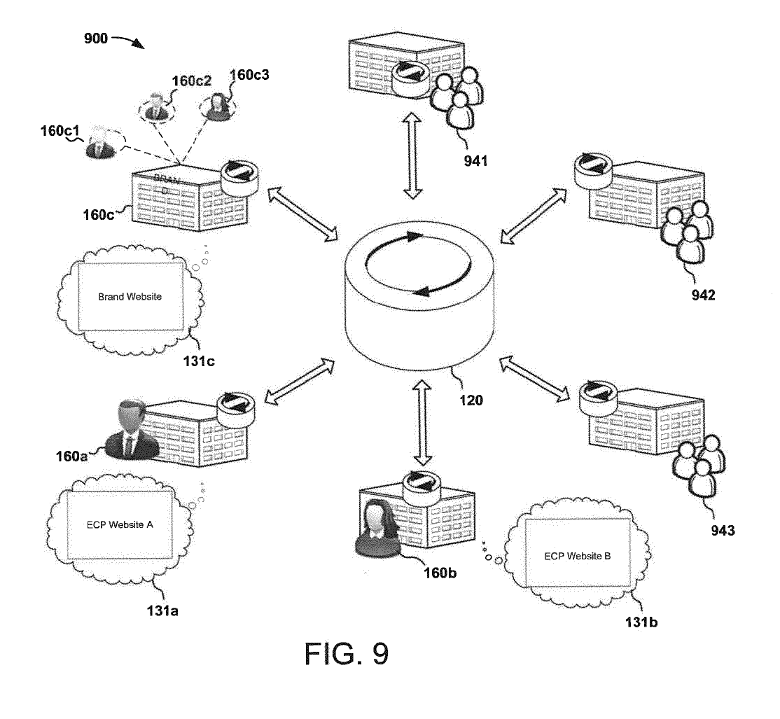

FIG. 9 is a diagrammatic view, illustrating a hybrid e-commerce server network, according to at least one embodiment of the disclosure. The hybrid e-commerce server(s) 120 may be configured to simultaneously provide multiple hybrid e-commerce websites, as shown as 131a-c, all with different appearances. Each of the hybrid e-commerce websites 131a-c may be associated with a single hybrid e-commerce platform (e.g., the hybrid e-commerce platform 130 of FIG. 1) or may be associated with separate hybrid e-commerce platforms (e.g., a different hybrid e-commerce platform 130 for each of the hybrid e-commerce websites 131a-c). In such embodiments, in-person providers 160a, 160b, and 160c all have their own websites, 131a, 131b, and 131c, respectively, with their own website design and layout. Further, the in-person provider 160c, using website 131c, may be a national or regional provider with multiple employees and locations, 160c1, 160c2, and 160c3. The hybrid e-commerce server(s) 120 may be configured to provide branded in-person provider 160c a consolidated website 131c for use by all branded locations (160c1, 160c2, and 160c3), but may be configured to track orders for the individual in-person provider locations, 160c 1, 160c 2, and 160c3 separately. Alternatively or additionally, some embodiments may limit the number of websites used for a particular industry, as described in paragraph 023 or elsewhere herein. For example, a single, industry-branded website may be used instead of multiple in-person provider websites, which may improve branding through increased credibility and customer loyalty. As yet another additional or alternative example, an industry-branded website may be provided for some in-person providers (e.g., small to mid-sized in-person providers), and in-person specific branded websites (e.g., a website branded for a particular in-person provider) may be provided for other in-person providers (e.g., mid-sized to large in-person providers). An in-person provider receiving an in-person specific branded website may be charged a higher fee than another in-person provider utilizing the industry-branded website.

The websites 131a, 131b, and 131c may be single page or multi-page websites, and may include social media content. The social media content may be associated with a social media platform provided via the hybrid e-commerce server 120 and the hybrid e-commerce platform 130, and/or the in-person provider web application. For example, the in-person provider web application may include or integrate a social media network that is specific to an industry (e.g., an eye care provider social media network). Members of the social media network may be in-person providers that use the services provided by the hybrid e-commerce server 120. In an embodiment, the industry specific social media network provided by the hybrid e-commerce server 120 and the in-person provider web application may be accessible to any member of the particular industry for which the social media network is tailored, such as the eye care industry. This may provide the HECP operating the hybrid e-commerce server 120 and the in-person provider web application with an opportunity to market the HECP's services to in-person providers that are not presently using the in-person provider web application or directing their customers to the hybrid e-commerce platform 130. For example, the hybrid e-commerce server 120 may direct e-mails to such in-person providers indicating that “on average, in-person providers that utilize our service X see increased sales in the amount Y,” or other marketing information that illustrates the benefits that the in-person providers may receive if they use and offer the services provided by the HECP. Additionally or alternatively, the social media content may be integrated with, obtained from, or provided to social media portals provided by a third party.

In most embodiments, the hybrid e-commerce server(s) 120 may be configured to communicate with the server(s) of any manufacturer 743, distributor 941, wholesaler 142, fulfillment center 141, third party provider 744, warehouse/storage 942, and/or shipper 943. This may assist the hybrid e-commerce server 120 in obtaining shipping information, product availability information, etc. that may be used to provide appointment scheduling services to the customer 112 on behalf of the in-person provider 160.

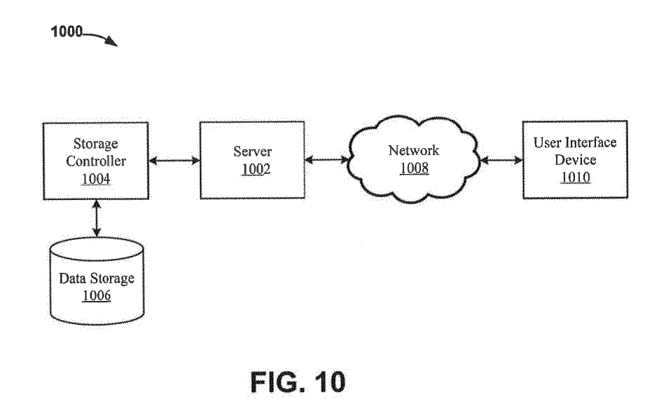

FIG. 10 illustrates at least one embodiment of a system 1000 for an information system, such as a hybrid e-commerce integration system. The system 1000 may include a hybrid e-commerce server 1002, a data storage device 1006, a network 1008, and a user interface device 1010. In an embodiment, the server 1002 may serve as a hybrid e-commerce server (e.g., the hybrid e-commerce server 120) that provides e-commerce services that have been integrated with brick-and-mortar retail services, such as by providing the try-on features, and by scheduling an appointment for in-person inspection before the customer 112 is committed to purchasing the product(s). Additionally, it should be understood that any in-person provider scheduling server, e.g., 520, or any product provider server, e.g., 141a and 142a, may be structured similar to FIGS. 10-12, and may include any or all of the features of the server 1002 discussed below. Additionally, it is noted that, although many embodiments disclosed herein illustrate the hybrid e-commerce server 120 as being separate from the servers 141a, 142a, 520, etc., the functions of the hybrid e-commerce server 120 may be integrated with or provided by the servers 141a, 142a, 520, etc., and may have a structure similar to the server 1002 The server 1002 may be a dedicated server or one of many servers in a cloud computing system. In a further embodiment, the system 1000 may include a storage controller 1004, or storage server configured to manage data and communications between the data storage device 1006 and the server 1002 or other components in communication with the network 1008. In an alternative embodiment, the storage controller 1004 may be coupled to the network 1008.

The user interface device 1010 is referred to herein broadly and is intended to encompass a suitable processor-based device such as a desktop computer, a personal computer (PC), a laptop computer, a personal digital assistant (PDA), tablet computer, smartphone, smart TV, or any other mobile communication device having access to the network 1008. In a further embodiment, the user interface device 1010 may access the Internet or other wide area or local area network to access a web application or web service hosted by the server 120 and provide a user interface for enabling a user to enter or receive information. The user interface device 1010 may further include one or more additional devices, such as input/output devices, that may be used to provide inputs to the user interface device 1010 for interacting with the system 100. The input/output devices may include a keyboard, a keypad, a mouse, a trackball, a barcode scanner, a touchscreen device, a microphone, a speaker, or any other device that may be used to provide input to the user interface device 1010 for interacting with the system 100. Additionally, the user interface device 1010 may include a voice recognition capability for providing inputs to the user interface device 1010.

The network 1008 may facilitate communication of data between the server 120 and the user interface device 1010. The network 1008 may include any type of communications network including, but not limited to, a direct PC-to-PC connection, a local area network (LAN), a wide area network (WAN), a metropolitan area network (MAN), a storage area network (SAN), a modem-to-modem connection, a public network (e.g., the Internet), a private network, a combination of the above, or any other communications network now known or later developed within the networking arts which permits two or more computers to communicate, with one another.

In various embodiments, the user interface device 1010 accesses the server 120 through an intermediate server (not shown). For example, in a cloud application the user interface device 1010 may access an application server. It should be understood that any network connection may include a secure connection using various methods, including without limitation secure socket layer/transport layer security (SSL/TLS) or secure shell (SSH) tunneling. The application server fulfills requests from the user interface device 1010 by accessing a database management system (DBMS). In this embodiment, the user interface device 1010 may be a computer (or any device capable of accessing the internet) executing a Java application (or HTML5/JavaScript application running in a browser, Android/iOS/Windows Mobile-based native mobile application, etc.) making requests to a java bean open source software (JBOSS) server executing on a Linux server (or personal home page (PHP) on Linux or Windows, an active server page (ASP) on Windows, Ruby on Linux, etc.), which fulfills the requests by accessing a relational database management system (RDMS) on a mainframe server.

In various embodiments, the server 1002 is configured to store databases, pages, tables, and/or records. Additionally, scripts on the server 1002 may access data stored in the data storage device 1006, which, may include accessing a SAN, a LAN, or a data bus. The data storage device 1006 may include, for example, a hard disk, including hard disks arranged in a redundant array of independent disks (RAID) array, a tape storage drive comprising a physical or virtual magnetic tape data storage device, or an optical storage device. The data may be arranged in a database and accessible through structured query language (SQL) queries, or other data base query languages, markup languages, scripting languages, or operations.

FIG. 11 illustrates one embodiment of a data management system 1100 configured to store application parameters and documentation. In one embodiment, the data management system 1100 may include the server 1002. The server 1002 may be coupled to a data-bus 1102. In one embodiment, the data management system 1100 may also include a first data storage device 1104, a second data storage device 1106, and/or a third data storage device 1108. In further embodiments, the data management system 1100 may include additional data storage devices (not shown). In such an embodiment, each data storage device 1104, 1106, and 1108 may each host a separate database that may, in conjunction with the other databases, contain redundant data. Alternatively or additionally, all or a portion of a database may be spread across storage devices 1104, 1106, and 1108 using database partitioning or some other mechanism. Alternatively or additionally, the storage devices 1104, 1106, and 1108 may be arranged in a RAID configuration for storing a database or databases that may contain redundant data. Data may be stored in the storage devices 1104, 1106, 1108, 1110 in a database management system (DBMS), a relational database management system (RDMS), an object oriented database management system (OODMS), an indexed sequential access method (ISAM) database, a multi-sequential access method (MSAM) database, a conference on data systems languages (CODASYL) database, or other database system.

In an embodiment, the server 1002 may be the hybrid e-commerce server 120 of FIG. 1, and data for third parties using the services provided by the hybrid e-commerce server 120 may be stored in a particular one of the data storage devices 1104, 1106, 1108. For example, the first data storage device 1104 may store data (e.g., patient information, appointment information, product information, etc.) associated with a first in-person provider, the second data storage device 1106 may store data (e.g., patient information, appointment information, product information, etc.) associated with a second in-person provider, and the third data storage device 1108 may store data (e.g., product information, stock on hand, shipping information, etc.) associated with a product manufacturer or distributor. By storing the data for each of the respective third parties in a different storage device, each of the respective third parties' data may be kept private. Additionally, should one of the third parties decide to cease use of the services provided by the hybrid e-commerce server 120, that third party's data may be easily located and deleted, or alternatively isolated and made inaccessible by the hybrid e-commerce server 120 when providing information to customers (e.g., via the in-person provider locator, during appointment scheduling, etc.). Thus, the server 1002, when operating as the hybrid e-commerce server 120, may maintain information obtained from the third parties such that the information remains the property of the respective third parties, as opposed to the property of the provider of the hybrid e-commerce server. Stated another way, information provided to the hybrid e-commerce server 120 by a third party remains the property of the third party, and is not maintained by the hybrid e-commerce server 120 should the third party terminate use of the services provided by the hybrid e-commerce server 120.

To illustrate, the information obtained from the third parties may include customer information (e.g., a customer's home or work address, e-mail address, telephone number, vision prescription, medical information, birth date, age, gender, number of children, children's names, children's age, marital status, spouse's name, spouse's age, purchase history, etc.) that may be used by the hybrid e-commerce server 120 to target advertising/marketing information and appointment reminder/scheduling information to customers. Isolating each of the third parties' information into a separate storage device (or multiple storage devices depending on the size of the information) or into a separate database may preclude the hybrid e-commerce server 120 from transmitting advertising/marketing information associated with a first third party (e.g., a first eye care provider) to customers identified by customer information obtained from another third party (e.g., customer information obtained from a second eye care provider). This may be beneficial for ensuring compliance with data privacy laws and other government and industry regulations regarding the dissemination and use of private information.

In an embodiment, the hybrid e-commerce server 120 may store electronic records (e.g., electronic medical and optical records) on behalf of the in-person providers. The hybrid e-commerce server 120 may include APIs that provide office management systems, calendaring systems, prescription management systems, Electronic Medical Records (EMR) systems, etc. to the in-person providers. Such features may be provided via the in-person provider web application. Additionally or alternatively, some in-person providers may utilize third party office management systems, calendaring systems, prescription managements systems, EMR systems, etc. The hybrid e-commerce server 120 may include APIs that integrate the hybrid e-commerce server 120 with, and provide the hybrid e-commerce server 120 with access to such systems to facilitate communications (e.g., appointment reminders, appointment scheduling, advertising, etc.) to customers on behalf of the in-person providers. Exemplary systems that the hybrid e-commerce server 120 may be integrated with using various APIs include OfficeMate®, ReportWriter®, and ExamWriter® by eyefinity®, Advantage practice management software by Compulink, MaximEyes® by First Insight®, RevolutionEHR™ by Health Innovation Technologies, and Crystal Practice Management Software™. By integrating third party office management and other systems into the hybrid e-commerce platform, the in-person providers may easily merge existing information (e.g., existing medical records, customer information, etc.) to the hybrid e-commerce platform, and manage all office functions (e.g., marketing, sales, office management, document management, etc.) from the hybrid e-commerce platform, thereby streamlining operations. It is noted that other systems may be integrated with the hybrid e-commerce server 120, and the exemplary systems listed above are provided by way of illustration, rather than by way of limitation.

Additionally, the hybrid e-commerce server 120 may include APIs that integrate the hybrid e-commerce server 120 with insurance benefits management systems, thereby enabling the hybrid e-commerce server 120 and the hybrid e-commerce platform 130 to provide accurate cost information in view of any insurance benefits the customer is entitled to, and to assist the in-person provider with insurance provider billing, deductible monitoring (e.g., has the customer met his deductible), etc. This may include verifying insurance coverage of the customer, locating an in-person provider that accepts a customer's insurance plan, processing insurance claims on behalf of customers who purchase products directly from the hybrid e-commerce platform (e.g., without using an in-person provider or in-person inspection), etc. Additionally, the hybrid e-commerce platform may provide explanations of insurance benefits information to the customer. In an embodiment, the customer may be required to pay full price for the eyewear (or other medical treatment), and the hybrid e-commerce platform may provide receipt information and links that the customer may utilize to seek reimbursement from their insurance provider. In an additional or alternative embodiment, the payment information may be received via the hybrid e-commerce platform at the time of product selection for in-person try-on, and the payment information may be provided to the ECP, who may then process the payment information and insurance information. The hybrid e-commerce platform and hybrid e-commerce server may then receive information from the ECP regarding the amount of the payment, the amount of the insurance benefits, etc. and may make such information available to the customer via the hybrid e-commerce platform.

In one embodiment, the server 1002 may submit a query to select data from the storage devices 1104 and 1106. The server 1002 may store consolidated data sets in a consolidated data storage device 1110. In such an embodiment, the server 1002 may refer back to the consolidated data storage device 1110 to obtain a set of records. Alternatively, the server 1002 may query each of the data storage devices 1104, 1106, and 1108 independently or in a distributed query to obtain the set of data elements. In another alternative or additional embodiment, multiple databases may be stored on a single consolidated data storage device 1110.

In various embodiments, the server 1002 may communicate with the data storage devices 1104, 1106, and 1108 over the data-bus 1102. The data-bus 1102 may comprise connections to SAN, a LAN, or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 1002 may communicate indirectly with the data storage devices 1104, 1106, 1108, and 1110 by first communicating with a storage server (not shown) or the storage controller 1004 of FIG. 10. The server 1002 may execute software for the LMS and the CRO or the LMS and CRO applications may execute on two or more different servers (not shown) coupled by the network 1008.

The server 1002 may include modules for interfacing with the data storage devices 1104, 1106, 1108, and 1110, may include modules for interfacing with the network 1008, and/or modules for interfacing with a user through the user interface device 1010. In a further embodiment, the server 120 may host an engine, application plug-in, or an API.

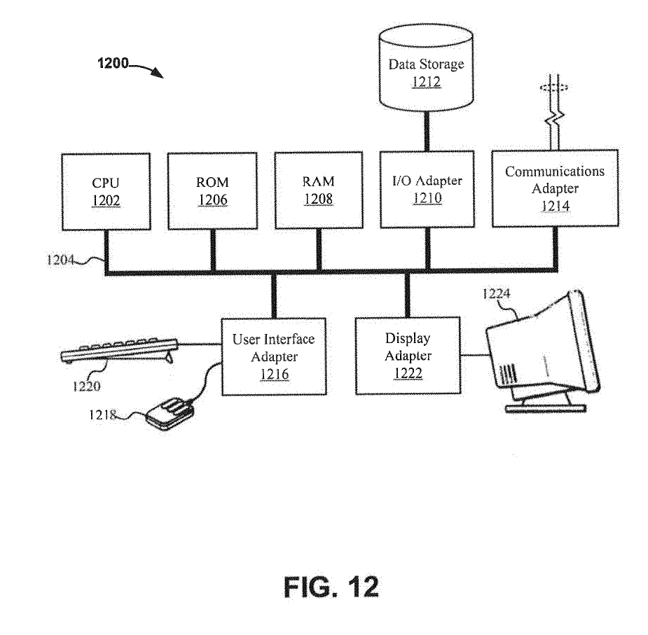

FIG. 12 illustrates a computer system 1200 adapted according to certain embodiments of the server 1002 and/or the user interface device 1010 of FIG. 10. As shown in FIG. 12, the central processing unit (“CPU”) 1202 is coupled to the system bus 1204. The CPU 1202 may be a general purpose CPU or microprocessor, graphics processing unit (“GPU”), and/or microcontroller. The present embodiments are not restricted by the architecture of the CPU 1202 so long as the CPU 1202, whether directly or indirectly, supports the modules and operations as described herein. The CPU 1202 may execute the various logical instructions according to the present embodiments.

The computer system 1200 also may include random access memory (RAM) 1208, which may be synchronous RAM (SRAM), dynamic RAM (DRAM), synchronous dynamic RAM (SDRAM), or another memory device configured to store data in a persistent or non-persistent state. The computer system 1200 may utilize RAM 1208 to store the various data structures used by a software application such as databases, tables, and/or records. The computer system 1200 may also include read only memory (ROM) 1206 which may be programmable read only memory (PROM), erasable programmable read only memory (EPROM), electrically erasable programmable read only memory (EEPROM), optical storage, or the like. The ROM 1206 may store configuration information for booting the computer system 1200. The RAM 1208 and the ROM 1206 may also hold user and system data.

The computer system 1200 may also include an input/output (I/O) adapter 1210, a communications adapter 1214, a user interface adapter 1216, and a display adapter 1222. The I/O adapter 1210 and/or the user interface adapter 1216 may, in certain embodiments, enable a user to interact with the computer system 1200. In a further embodiment, the display adapter 1222 may display a graphical user interface (GUI) associated with a software or web-based application on a display device 1224, such as a monitor or a touch screen.

The I/O adapter 1210 may couple one or more storage devices 1212, such as one or more of a hard drive, a flash drive, a compact disc (CD) drive, a floppy disk drive, and a tape drive, to the computer system 1200. The communications adapter 1214 may be adapted to couple the computer system 1200 to the network 1008, which may be one or more of a LAN, WAN, and/or the Internet. The communications adapter 1214 may be adapted to couple the computer system 1200 to a storage device, such as a network attached storage device (not shown). The user interface adapter 1216 couples user input devices, such as a keyboard 1220, a pointing device 1218, voice recognition, motion recognition, and/or a touch screen (not shown) to the computer system 1200. The display adapter 1222 may be driven by the CPU 1202 to control the presentation of information and GUIs on the display device 1224.

The applications of the present disclosure are not limited to the architecture of the computer system 1200. Rather the computer system 1200 is provided as an example of one type of computing device that may be adapted to perform the functions of a server 1002 and/or the user interface device 1010. For example, any suitable processor-based device may be utilized including, without limitation, personal data assistants (PDAs), tablet computers, smartphones, smart TV, game consoles, and multi-processor servers. Moreover, the systems and methods of the present disclosure may be implemented on application specific integrated circuits (ASIC), very large scale integrated (VLSI) circuits, a field programmable gate array (FPGA), or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer-readable storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions described above, and as outlined in the claims.

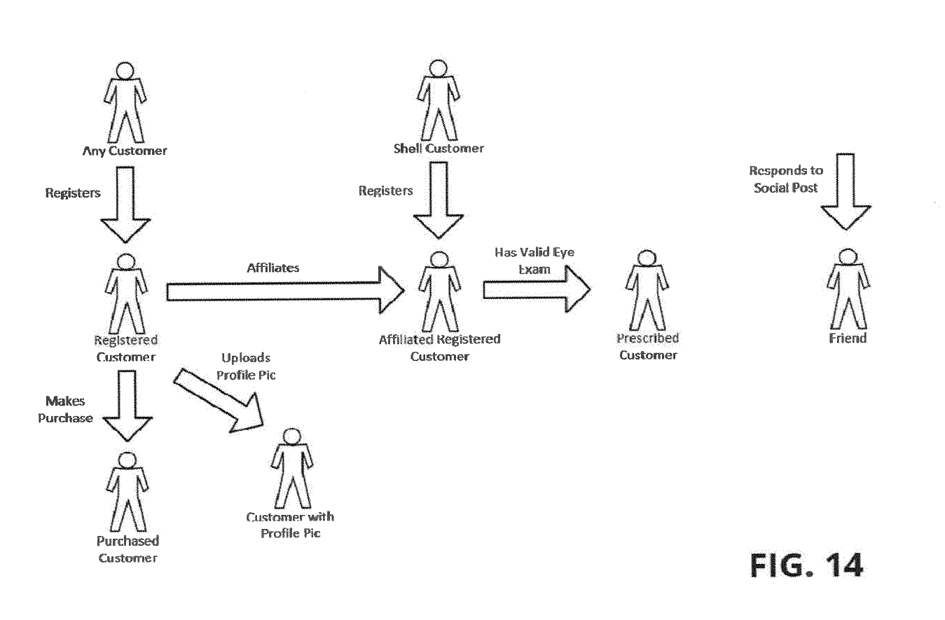

Referring to FIG. 14, a diagram illustrating various aspects of customer personas utilized by a hybrid e-commerce platform according to embodiments is shown. As shown in FIG. 14, any customer may register (e.g., create an account) with a hybrid e-commerce platform (e.g., one or more of the hybrid e-commerce platforms described above). It is noted that, although a customer may register with the hybrid e-commerce platform, and therefore be associated with a registered customer persona, that customer may also be considered an unaffiliated customer (e.g., because the customer has not designated any in-person providers/retailers). In an embodiment, association of a customer with a registered customer persona may include updating a profile associated with the customer to indicate that the customer is associated with the registered customer persona.

The registered customer may make a purchase via the hybrid e-commerce platform (e.g., Commercity), become affiliated with one or more entities (e.g., retailers that provide sales and services via the hybrid e-commerce platform), or upload a profile picture to the hybrid e-commerce platform. When a registered customer makes a purchase, the customer may further be associated with a purchased customer persona. In an embodiment, associating a customer with a purchased customer persona may include updating the profile associated with the customer to indicate that the customer has made at least one purchase via the hybrid e-commerce platform.

The customer may also become associated with an affiliated customer persona in response to affiliating with the one or more entities. For example, the customer may use the hybrid e-commerce platform to designate one or more providers or retailers as their preferred provider/retailer, as described and illustrated with reference to FIG. 6Q. The customer's designation of a provider or retailer may affiliate the customer with the designated provider or retailer. During subsequent interactions between the customer and the hybrid e-commerce platform, information associated with the customer's affiliated providers and/or retailers may be pre-populated into various views provided by the hybrid e-commerce platform, simplifying navigation of the hybrid e-commerce platform and eliminating the need for the customer to identify the affiliated providers and retailers each time that the customer interact with the hybrid e-commerce platform. In an embodiment, associating a customer with an affiliated customer persona may include updating the profile associated with the customer to indicate that the customer has designated at least one provider or retailer as a preferred provider or retailer via interaction with the hybrid e-commerce platform.

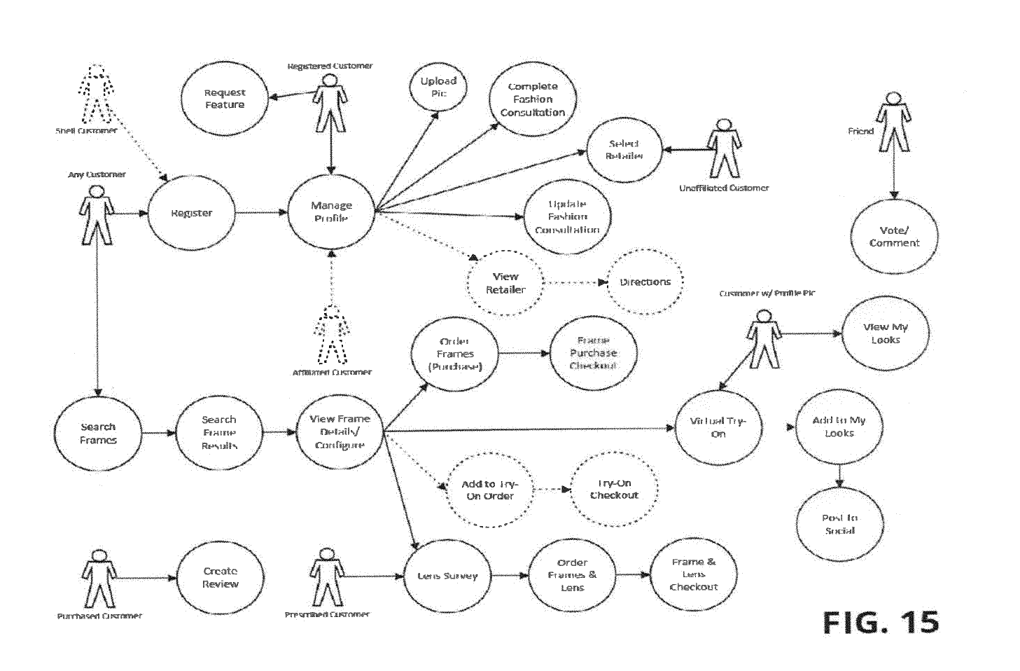

Additionally, in response to the customer uploading a profile picture to the hybrid e-commerce platform, the customer may become associated with a customer with profile picture persona. In an embodiment, associating a customer with a customer with profile picture persona may include updating the profile associated with the customer to indicate that the customer has uploaded a profile picture to the hybrid e-commerce platform. Customers associated with the customer with profile picture persona may be provided with additional functionality that would otherwise not be available to the customer (i.e., if a profile picture had not been provided to the hybrid e-commerce platform), as described with reference to FIG. 15.

A customer associated with an affiliated registered customer persona may schedule and attend an eye exam (e.g., for an in-person inspection of eyewear or frames, or periodic exam). As a result of the eye exam, a prescription for eyewear lenses may be created and the customer may further become associated with a prescribed customer persona. In an embodiment, associating a customer with prescribed customer persona may include updating the profile associated with the customer to indicate that the customer has interacted with at least one affiliated provider or retailer, such as attending an eye exam, or performed in-person inspection of a product of interest. It is noted that a customer's profile may also become associated with a prescribed customer persona in other ways. For example, a provider may upload or provide the customer's information or data to the hybrid e-commerce platform (e.g., a shell customer). If the uploaded information includes prescription information, upon registering, the customer's profile may be associated with the prescribed customer persona.

Further, the hybrid e-commerce platform may have an integrated social media platform for distributing social media content to customers (e.g., both registered and non-registered customers). For example, as explained above, the hybrid e-commerce platform provides “My Looks” functionality (and the wish list with social commenting application) that allows customers to request rating and comment for products that the customer is contemplating purchasing. When using the “My Looks” functionality, the customer may request specific persons provide ratings and/or comment. Individuals that a customer requests rate and/or comment may be considered friends of the customer, and may be associated with a friend customer persona.

A customer may further be associated with a shell customer persona. For example, in an embodiment, a customer that is not a registered customer may visit a provider or retailer that is affiliated with the hybrid e-commerce platform, such as during a periodic eye exam. During the visit, the customer may make a purchase, perform an in-person inspection, or other activities. The provider or retailer may then provide information associated with the customer to the hybrid e-commerce platform, and this information may be used to create a profile for the customer. The profile may be associated with a shell customer persona to indicate that the profile was created from information received from an affiliated provider or retailer, rather than the customer. Subsequently, the customer may register with the hybrid e-commerce platform. In response to the customer registering with the hybrid e-commerce platform, the customer's profile (e.g., the profile associated with the shell customer persona) may be updated to be associated with a registered customer persona and the affiliated customer persona (e.g., because the customer has interacted with the affiliated provider or retailer that provided the information previously used to associate the customer's profile with the shell customer persona). In an additional or alternative embodiment, shell customer personas may be generated when an in-person provider/retailer uploads (or syncs) a customer list to the hybrid e-commerce platform using an API or as a comma separated value (CSV) file.

Associating customers and customer profiles with various personas may facilitate management of various aspects of the hybrid e-commerce platform. For example, depending on the personas associated with a particular customer's profile, the hybrid e-commerce platform may provide varying functionalities, as described in more detail below with reference to FIG. 15. It is noted that the various customer personas illustrated in FIG. 14 are provided for purposes of illustration, rather than by way of limitation, and that other customer personas may be used by hybrid e-commerce platforms in accordance with one or more of the embodiments disclosed herein.

Referring to FIG. 15, a flow diagram illustrating various functionalities that may be provided to customers based on customer personas associated with the customer according to embodiments is shown. As shown in FIG. 15, any customer (e.g., registered customers or non-registered customers) may search the hybrid e-commerce platform (e.g., search for eyewear frames or other products). This search may result in one or more search results being presented to the customer, and the customer may then search the returned results to narrow their search. Additionally, the customer may view details (e.g., product specifications, descriptions, images, etc.) associated with one or more of the search results, and/or configure (e.g., select a color, size, etc.) products associated with one of more of the search results. The customer may also may make place orders and check out (e.g., provide payment for the order) via the hybrid e-commerce platform. Some customers (e.g., non-registered customers and shell customers) may register (e.g., create a profile) with the hybrid e-commerce platform. In an embodiment, online purchase of products from the hybrid e-commerce platform may be restricted. As an example, the hybrid e-commerce platform may restrict the purchase of any product to customers having profiles associated with the affiliated customer persona. That is to say that, in an embodiment, a customer is permitted to purchase a product via the hybrid e-commerce platform if the customer is affiliated with an in-person provider that sells that product. For example, a customer may not purchase complete prescription eyewear online unless the customer is affiliated with an in-person provider that provider prescription eyewear, such as an optometrist. This may promote stronger relationships between the customer and the in-person providers, and may further provide sales opportunities for the in-person providers, to ensure that the in-person providers receive credit and compensation for online purchases of products they offer from their affiliated customers. In an additional or alternative embodiment, only some sales may be restricted to affiliated customers. For example, purchases of prescription eyewear may be restricted to affiliated customers, and purchases of non-prescription eyewear may not be restricted.

Registered customers (e.g., customers having profiles associated with the registered customer persona) may manage their profile. Managing the customer's profile may include uploading a profile picture, completing or updating a consultation, as described with reference to FIGS. 6D-6F, and selecting a retailer (e.g., designating an affiliate provider or retailer). It is noted that prior to selecting a retailer, the registered customer may be associated with the unaffiliated customer persona, and after selecting a retailer, the customer may be associated with the affiliated customer persona. When the registered customer is associated with the affiliated customer persona, the customer may view retailer information and directions, as described with reference to FIG. 6Q-1, and may designate an order for in-person inspection. Thus, in an embodiment, a customer's registration with the hybrid e-commerce platform and affiliation with a provider or retailer enables the customer to place orders for products, where the orders are designated for in-person inspection, and where checkout/payment for the order does not occur until after the customer has performed the in-person inspection. In additional or alternative embodiments, the customer may pay a nominal fee (e.g., shipping costs) for the in-person inspection, but may not be required to pay for the product itself until after the in-person inspection.

Customers associated with the purchased customer persona may be provided with functionality to create reviews for one or more products purchased via the hybrid e-commerce platform. In an embodiment, the purchased customers may be limited to only creating reviews for products that the customer has purchased. Operating the hybrid e-commerce platform in this manner (e.g., limiting reviews of products to only customer that have purchased those products) is unconventional in the field of e-commerce. For example, conventional e-commerce platforms permit anyone to create a review of a product without verifying that the customer has actually purchased and/or used the product. This conventional approach leads to customers being skeptical of customer reviews, and decreases the reliability of such reviews. In contrast, the unconventional operations of the hybrid e-commerce platform may increase the reliability of the customer reviews (e.g., because only customers that have purchased a particular product are allowed to create reviews fora that product).

The hybrid e-commerce platform may provide customer associated with a prescribed customer persona with interfaces that enable the customer to complete surveys, order prescribed products (e.g., eyewear lenses) and accessories (e.g., eyewear frames), and perform a checkout for the prescribed products and accessories. Additionally, the hybrid e-commerce platform may enable customers associated with the friend persona to vote and/or comment on social media content distributed by the hybrid e-commerce platform.

Customers associated with the customer with profile picture persona may be provided with additional functionality, such as virtual try-on features, as described above. Products viewed using the virtual try-on features may be added to the customer's my looks information, as described with reference to FIGS. 6R-6V-2, posted to social media, as described with reference to FIGS. 6V-1 and 6V-2, and manage the customer's my looks content.

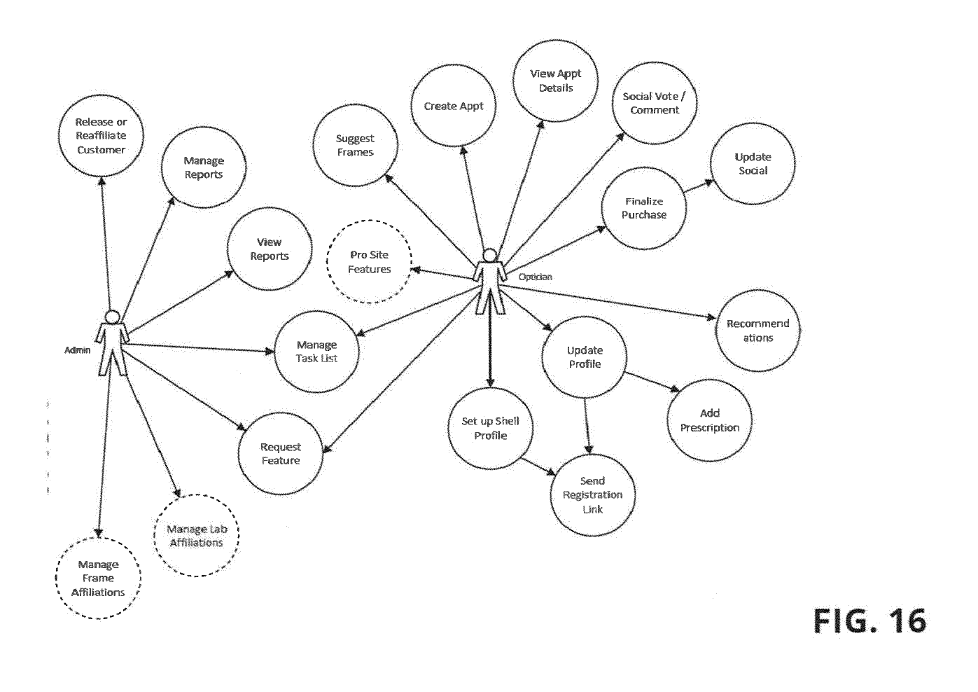

Referring to FIG. 16, a diagram illustrating various functions and interactions between personas of an in-person provider according to embodiments is shown. As shown in FIG. 16, an administrator of an in-person provider may manage affiliation information associated with providers, retailers, and labs that provide goods and services to customers via the hybrid e-commerce platform. The administrator may also interact with the hybrid e-commerce platform to release or re-affiliate customers (e.g., remove an affiliation between the customer and the vendor, or affiliate the customer with a different location of the vendor). Additionally, the administrator may manage reports (e.g., modify, create, remove various reports), view reports, manage task lists (e g, manage task lists associated with employees of the vendor), and request features (e.g., a tool that allows administrators and other personnel to communicate with each other).

Personnel of the in-person provider may utilize features of the in-person provider's systems to interact with customers. For example, if the in-person provider is associated with an optometrists office, the personnel may suggest eyewear frames, create appointments, view information associated with appointment details (e.g., appointment dates, times, etc.), vote, comment, or update social media content, finalize purchases, make recommendations to customers, update customer profiles (e.g., with purchase information, prescription information, etc.), send registration links to customers (e.g., shell customers), and set up shell customer profiles. Further, the personnel may interact with the hybrid e-commerce platform to utilize features of a professional site (e.g., the in-person provider portal described above) created for the in-person provider and provided by the hybrid e-commerce platform.

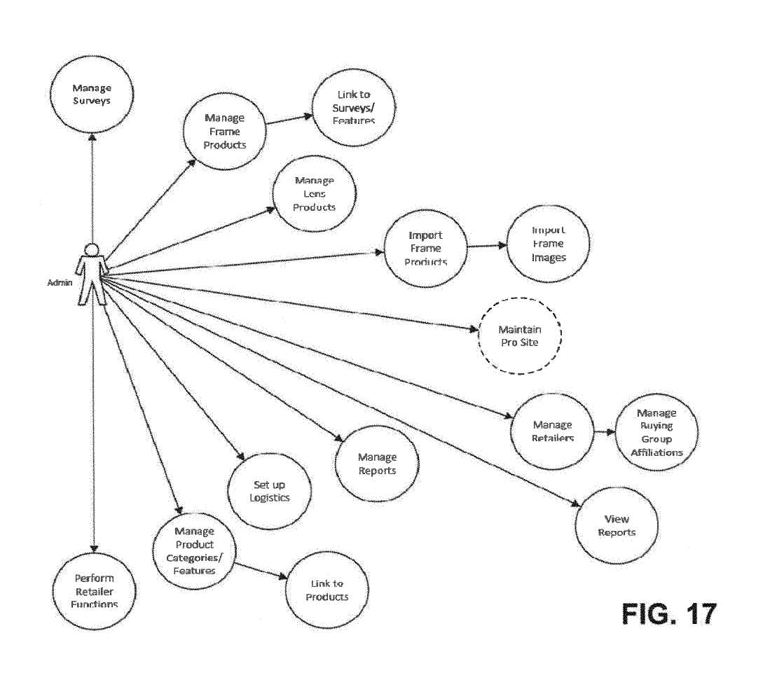

Referring to FIG. 17, a diagram illustrating various functions and actions that may be performed by an administrator of a manufacturer according to embodiments is shown. It is noted that the administrator may be an employee of the manufacturer, or may be an employee of an operator of the hybrid e-commerce platform (e.g., Commercity), or both, depending on how the systems (e.g., the hybrid e-commerce platform and the manufacturer's systems) are configured and permissions are managed. As shown in FIG. 17, an administrator for a manufacturer may manage information captured, presented, or otherwise utilized in providing the hybrid e-commerce platform. Managing the information may include managing survey information (e.g., reviewing survey results and creating surveys) and product information (e.g., product details, images, etc.). Additionally, the administrator may manage retailers, buying group affiliations, view and manage reports, set up logistics information (e.g., logistics information that coordinates interactions between manufacturers, retailers, labs, etc.), manage product categories and features (e.g., for the hybrid e-commerce platform), and perform retailer functions. Additionally, the administrator may maintain the professional site (e.g., an in-person provider web application) that provides a portal for the manufacturer to interact with the hybrid e-commerce platform, and more particularly, a portal for the manufacturer to interact with the providers.

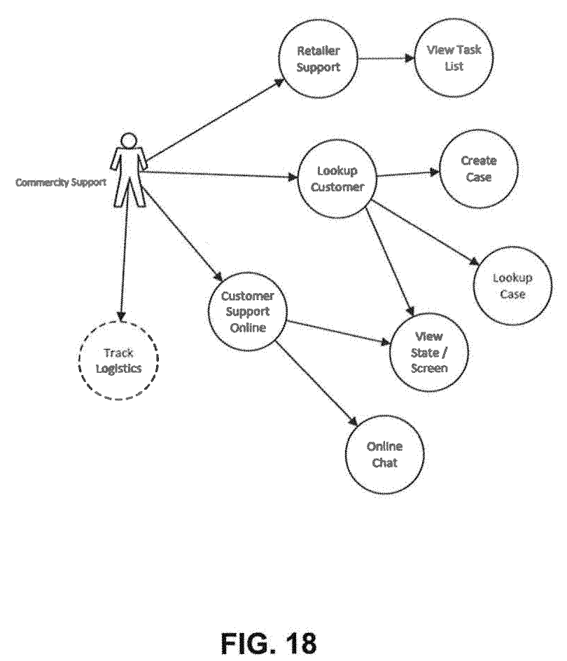

Referring to FIG. 18, a diagram illustrating various functions that may be performed by support staff of an operator of a hybrid e-commerce platform according to embodiments is shown. As shown in FIG. 18, the support staff may provide online support, which may include online chat support, provide retailer support, which may include viewing retailer task list information, lookup customer information, which may include creating or looking up customer support case information, and may view state and screen information regarding the status of any pending support cases. Additionally, the support staff may track logistics information.

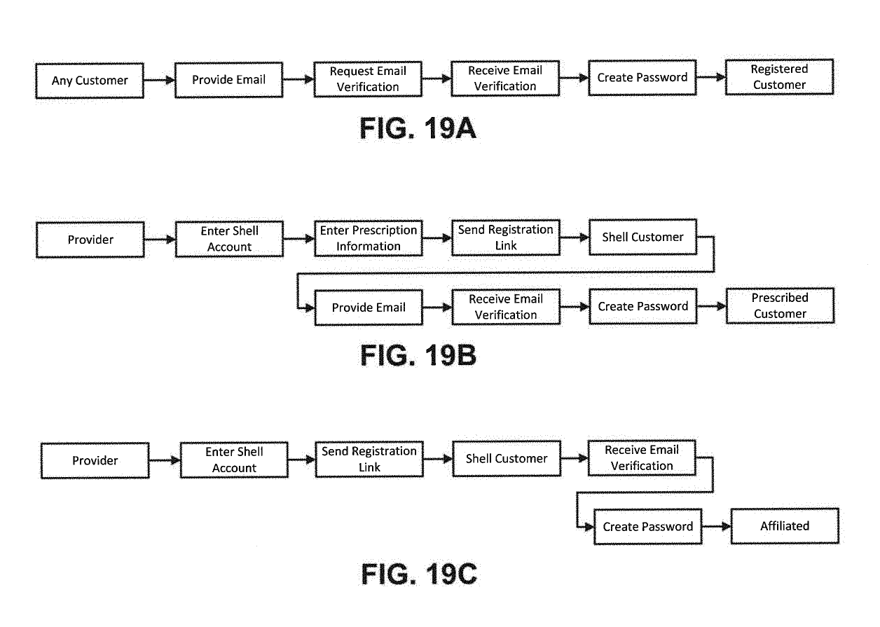

Referring to FIGS. 19A-19C, various flow diagrams illustrating operations for associating a customer with a customer persona according to embodiments are shown. In FIG. 19A, a flow diagram illustrating operations for associating a customer with a registered customer persona is shown. The operations include the customer providing an e-mail address to a hybrid e-commerce platform. In an embodiment, the e-mail address may be provided to the hybrid e-commerce platform using an interface of a web page. For example, the customer may select a create account button to register an account with the hybrid e-commerce platform, as illustrated in FIG. 6M. In response to receiving the e-mail address information (and possibly the username information), the hybrid e-commerce platform may request e-mail verification. In an embodiment, the e-mail verification may be provided to the customer as an e-mail sent to the provided e-mail address. In an additional or alternative embodiment, other forms of verification may be performed, such as text message verification, telephone number verification, or another technique.

The customer, in response to receiving the validation request, may provide validation to the hybrid e-commerce platform. For example, when e-mail verification is used, the customer may click a link included in the e-mail to confirm that the customer is authorized to access the e-mail account associated with the e-mail address provided to the hybrid e-commerce platform. As another example, when text message verification is used, a text message including a code may be provided to the customer, and the customer may enter the code via the interface to provide verification. As another example, when telephone verification is performed, the customer may be prompted with an automated voice messaging system to press one or more keys to confirm that the registration information (e.g., the e-mail address) is valid. After verification is performed, the customer may be prompted to create a password for the account. In an embodiment, the customer may provide password information at the same time the customer provides the e-mail address, and may be prompted to login to the hybrid e-commerce platform using the password in response to validating the registration information. Once the registration information is validated, the customer's profile may be associated with the registered customer persona.

In FIG. 19B, a flow diagram illustrating operations for associating a customer with a prescribed customer persona is shown. The operations include a provider providing shell account information to a hybrid e-commerce platform. It is noted that the provider may be referred to as a clinician in some contexts, such as when the provider is an optometrist. In an embodiment, the shell account information may be provided in the form of a customer list (e.g., a list including information associated with customers of the provider). In an additional or alternative embodiment, the shell information may be provided for a single customer. The provider may then provide prescription information to the hybrid e-commerce platform. The prescription information may be provided as part of a batch processing, such as during periodic updates of prescription information for all customers of the provider, or may be provided for a specific customer, such as updating prescription lens information after an eye exam with the provider. An office management system of the provider may include an API for providing customer information to the hybrid e-commerce platform. In an embodiment, the customer information may be provided as one or more CSV files.

Subsequent to receiving the shell account and prescription information, the hybrid e-commerce platform may send registration links to the customer(s) associated with the shell customer personas. The shell customers may receive the registration link and may perform steps to register an account (e.g., provide e-mail address information, receive verification information, create a password, etc.) with the hybrid e-commerce platform, as described with reference to FIG. 19A. As illustrated in FIG. 19B, when a customer associated with a shell customer persona performs registration, the customer's profile, upon completing registration, may be associated with a prescribed customer persona if prescription information has been received for the customer. After registration, the customer's profile may be transitioned from being associated with the shell customer persona to being associated with the registered customer persona, and, if prescription information was provided, the prescribed customer persona. Further, because the shell customer accounts were provided by an affiliated provider (e.g., the provider), the customer's profile, upon registration, may be associated with the affiliated customer persona.

In FIG. 19C, a flow diagram illustrating operations for associating a customer with a prescribed customer persona is shown. The operations include a provider providing shell account information to a hybrid e-commerce platform. In an embodiment, the shell account information may be provided in the form of a customer list (e.g., a list including information associated with customers of the provider). In an additional or alternative embodiment, the shell information may be provided for a single customer. Subsequent to receiving the shell account and prescription information, the hybrid e-commerce platform may send registration links to the customer(s) associated with the shell customer personas. The shell customers may receive the registration link and may perform steps to register an account (e.g., provide e-mail address information, receive verification information, create a password, etc.) with the hybrid e-commerce platform, as described with reference to FIG. 19A. As illustrated in FIG. 19B, when a customer associated with a shell customer persona performs registration, the customer's profile, upon completing registration, may be associated with the affiliated customer persona (e.g., because the shell customer accounts were provided by an affiliated provider, such as the provider). It is noted that FIGS. 19B and 19C differ in that prescription information is provided by the provider in FIG. 19B while no prescription information is provided by the provider in FIG. 19C. These different scenarios may occur when the shell account information is provided to the hybrid e-commerce platform following a consultation with the customer(s) (e.g., FIG. 19B), and when the shell account information is provided prior to the consultation (e.g., FIG. 19C). The scenario illustrated in FIG. 19C may also occur when the shell account information is provided to the hybrid e-commerce platform following a consultation with the customer(s) but the provider chooses not to share the prescription information.

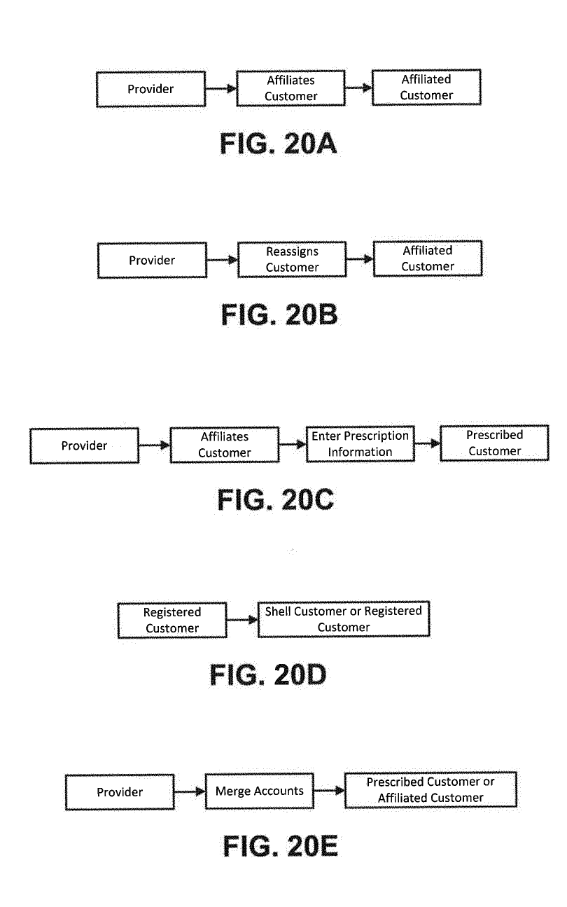

Referring to FIGS. 20A-20E, various flow diagrams illustrating operations for associating or modifying a customer's personas according to embodiments are shown. In FIG. 20A, a flow diagram illustrating an embodiment of affiliating a un-affiliated customer is shown. FIG. 20A illustrates an embodiment of transitioning a customer profile associated with an un-affiliated customer persona to an affiliated customer persona. As shown in FIG. 20A, a provider may provide information to a hybrid e-commerce platform to affiliate the un-affiliated customer with the provider, resulting in the customer's profile being associated with the affiliated customer persona, rather than the un-affiliated customer persona. This scenario may occur when an un-affiliated customer first visits a provider, such as an optometrist. FIG. 20B illustrates an embodiment of reassigning a customer profile to change an affiliation of the customer's profile. As shown in FIG. 20A, a provider may provide information to a hybrid e-commerce system to reassign a customer's affiliation. This may occur, for example, when a customer changes provider (e.g., the customer was previously affiliated with a first optometrist, and is now being affiliated with a second optometrist, or the customer is changing from a first branch of an optometrist's office to a second branch of the same optometrist).

FIG. 20C illustrates an embodiment of transitioning a customer profile associated with an un-affiliated customer persona to an affiliated/prescribed customer persona. As shown in FIG. 20C, a provider may provide affiliation information and prescription information for a customer to a hybrid e-commerce platform. In response to receiving this information, a customer's profile may become associated with the affiliated customer persona and the prescribed customer persona. This may occur when an un-affiliated/un-prescribed customer has an eye exam with an optometrist and receives a prescription for eyewear lenses.

FIG. 20D illustrates an embodiment of merging a customer profile associated with registered customer persona with a customer profile associated with either a shell customer persona or a registered customer persona. As shown in FIG. 20D, a customer profile associated with the registered customer persona may be merged with another profile associated with either the shell customer persona or the registered customer persona. This scenario may occur when a provider creates a shell customer account for the customer, but the customer then registers an account with the hybrid e-commerce platform without using a verification provided when the shell account was created. Thus, there may be multiple accounts for a single customer (e.g., a shell account and a registered account), and the provider may subsequently merge the two profiles, resulting in a single profile for the customer, where the profile is associated with the registered customer profile. Personas associated with the two profiles may also be merged. For example, FIG. 20E illustrates an embodiment of merging customer profiles to generate a customer profile associated with an affiliated customer persona and a prescribed customer persona. The provider may observe that a customer has two profiles (e.g., a profile associated with a shell account, and a profile associated with the registered customer persona, as described above with reference to FIG. 20D), and may merge the two profiles, as described above with reference to FIG. 20D. Additionally, the provider may update the profile to include affiliation information and prescription information, which causes the customer's profile to be associated with the prescribed customer persona and the affiliated customer persona.

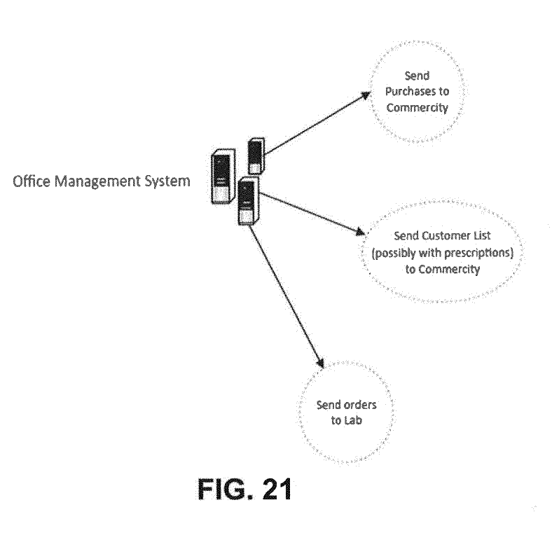

Referring to FIG. 21, a flow diagram illustrating how an office management system may be integrated with various systems operations in conjunction with a hybrid e-commerce platform according to embodiments is shown. The office management system may be operated by a vendor (e.g., a retailer, provider, and the like) that offers goods and/or services to customers via a hybrid e-commerce platform, and may be used to manage operations of various systems of the vendor. For example, the office management system may include tools to manage an e-mail system, a database system, a scheduling system, upload customer information to the hybrid e-commerce platform, and the like, that are utilized by the vendor in the vendor's ordinary course of business. As shown in FIG. 21, the office management system may be operated to send purchase and prescription information to the hybrid e-commerce platform (e.g., Commercity), and may be operated to send orders to third parties (e.g., an optometrist office may use the office management system to communicate with one or more external labs, such as to process an order for prescription eyewear lenses).

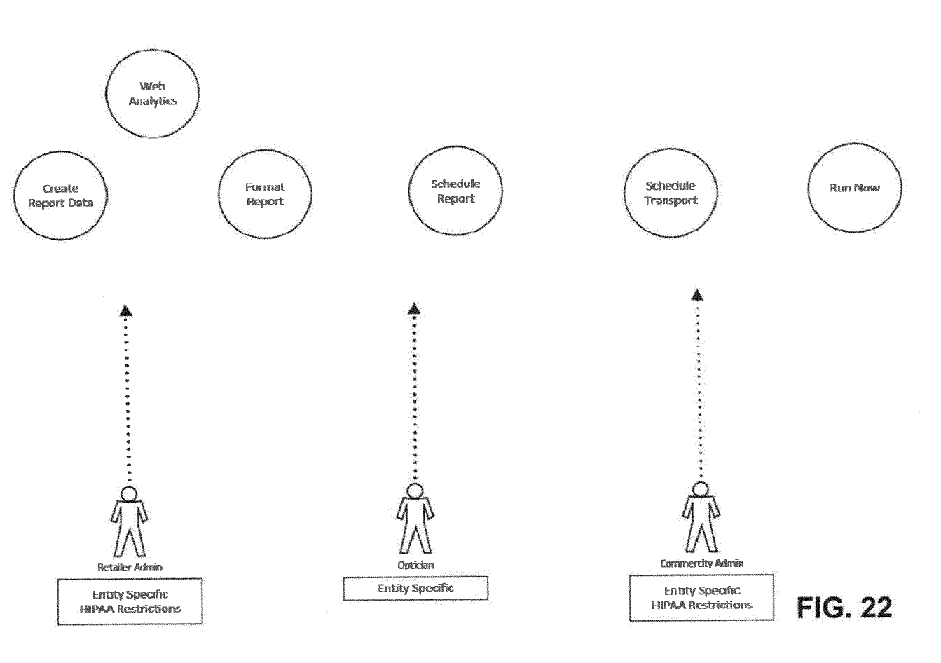

Referring to FIG. 22, a diagram illustrating various reporting features that may be utilized by entities cooperating to provide a hybrid e-commerce platform according to embodiments is shown. As shown in FIG. 22, a retailer (e.g., an administrator of the retailer or other personnel) may create report data, format reports, and use web analytic tools. Another party, which may be an employee of the retailer or personnel associated with a third party, may schedule reports. An administrator of the hybrid e-commerce platform may run reports, and schedule transport (e.g., schedule shipment of goods from a manufacturer to the retailer or lab for fulfillment of orders or for in-person inspection).

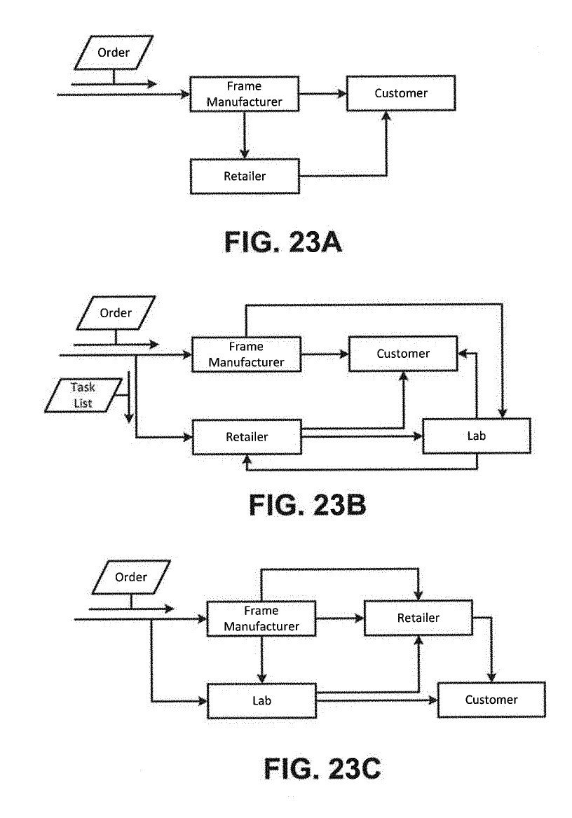

Referring to FIGS. 23A-23C, various diagrams illustrating order fulfillment workflows in a hybrid e-commerce system according to embodiments are shown. It is noted that FIGS. 23-23C are described herein as workflows for fulfillment of orders associated with eyewear frames, the workflows may readily be utilized to fulfill orders for other products, and reference to orders for eyewear frames is provided for purposes of illustration, rather than by way of limitation. In FIG. 23A, a first flow diagram illustrating an exemplary workflow for fulfillment of orders for eyewear frames in a hybrid e-commerce platform according to embodiments is shown. As shown in FIG. 23A, a customer may place an order for eyewear frames, and the order may be provided to an eyewear frame manufacturer. In an aspect, the manufacturer may receive the order, and may ship the eyewear frames directly to the customer, such as when the customer purchases the eyewear frames without requesting in-person inspection. In an additional or alternative aspect, the manufacturer may ship the eyewear frames to a retailer who may then ship the eyewear frames to the customer, or may provide the customer with an opportunity to inspect the eyewear frames, such as to determine whether any adjustment or fitting needs to be performed prior to providing the eyewear frames to the customer. In an embodiment, the retailer may make any necessary measurements and fitting prior to providing the eyewear frames to the lab. In an embodiment, the order may be automatically provided to the manufacturer upon the customer placing the order via the hybrid e-commerce platform. Although not illustrated in FIG. 23A, the eyewear frames may be provided to a lab (e.g., a lens processing lab) that may provide lenses for the eyewear frames. The lab may be associated with the retailer, or may be a third party lab that is distinct from the retailer.

In FIG. 23B, a second flow diagram illustrating an exemplary workflow for fulfillment of orders for eyewear frames in a hybrid e-commerce platform according to embodiments is shown. As shown in FIG. 23B, a customer may place an order for eyewear frames, and the order may be provided to an eyewear frame manufacturer. Additionally, in response to the order being placed, a task list may be provided to the retailer. The task list function may aid the retailer in providing in sales and service. For example, the task lists may remind the retailer to: 1) send a customer's prescription to lab (e.g., in the case when the frame is shipped directly to the lab); 2) schedule an appointment with customer for fitting and measurements (e.g., for progressive lenses); and 3) set an appointment with the customer to pick up completed prescription eyewear (e.g., when the frame is shipped directly to the lab and then the completed prescription eyewear is shipped to the provider). It is noted that other tasks may be performed/scheduled using the task list function, and that the exemplary tasks described above are provided for purposes of illustration, rather than by way of limitation. In an embodiment, the task list may be used by customer support personnel associated with an operator of the hybrid e-commerce platform to monitor tasks of providers, and, if necessary, contact the providers to prompt task completion. In an embodiment, the frame manufacturer may provide the eyewear frames to a third party lab. In an additional or alternative embodiment, the frame manufacturer may provide the eyewear frames to a lab of the retailer. In another additional or alternative embodiment, the manufacturer may have a lab, and the eyewear frames may be provided to the manufacturer's lab and then to the customer. The retailer may provide information associated with a prescription (e.g., a lens prescription for eyewear lenses) to the lab (e.g., third party lab, manufacturer's lab, or retailer's lab), which may then insert the lenses into the eyewear frames, and then provide the completed eyewear (e.g., eyewear frames with lenses inserted) to the retailer, and the retailer may then provide the completed eyewear to the customer. In an embodiment, the retailer may perform a fitting of the completed eyewear prior to providing the completed eyewear to the customer. In an additional or alternative embodiment, the completed eyewear may be provided to the customer directly from the third party lab or retailer's lab. In an embodiment, the order may automatically be provided to the frame manufacturer by the hybrid e-commerce platform, and the task list may automatically be provided to the retailer by the hybrid e-commerce platform.

In FIG. 23C, a third flow diagram illustrating an exemplary workflow for fulfillment of orders for eyewear frames in a hybrid e-commerce platform according to embodiments is shown. As shown in FIG. 23C, a customer may place an order for eyewear frames, and the order may be provided to an eyewear frame manufacturer. In an embodiment, if a third party lab is used, the order may also be provided to the third party lab. In this embodiment, the frame manufacturer may provide the eyewear frames to the third party lab, and the third party lab may then insert the lenses into the eyewear frames. In an embodiment, the third party lab may provide the completed eyewear to the retailer. In an additional or alternative embodiment, the third party lab may provide the completed eyewear to the customer directly. In an additional or alternative embodiment, the manufacturer may provide the eyewear frames to the retailer, and the retailer may provide the frames to the retailer's internal lab, which may then insert the lenses into the eyewear frames. The retailer, or the retailers internal lab, may then provide the completed eyewear to the customer. In an embodiment, the retailer may perform a fitting of the completed eyewear prior to providing the completed eyewear to the customer. In an embodiment, the order may automatically be provided to the frame manufacturer and the third party lab by the hybrid e-commerce platform.

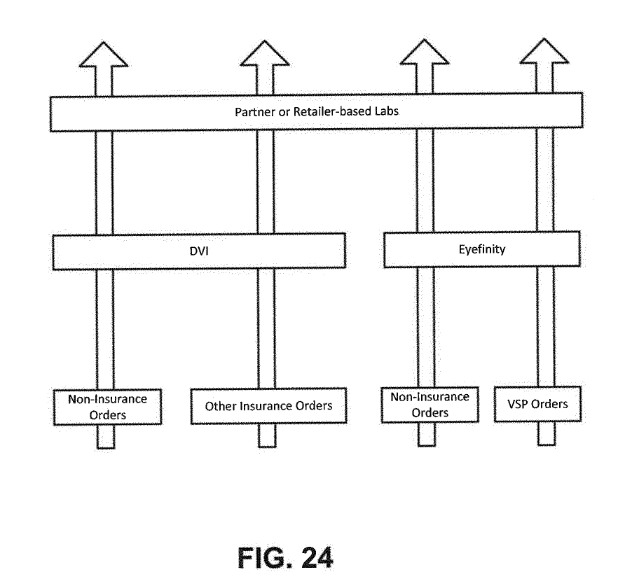

Referring to FIG. 24, a flow diagram illustrating processing of various lab ordering transactions in a hybrid e-commerce platform according to embodiments is shown. A total of 4 lab ordering transactions are shown, and include: 1) non-insurance orders placed to labs using software provided by Digital Vision, Inc. (DVI); 2) insurance orders to labs using DVI; 3) non-insurance orders to labs through Eyefinity; 4) Vision Service Plan (VSP) orders to labs through EyeFinity.

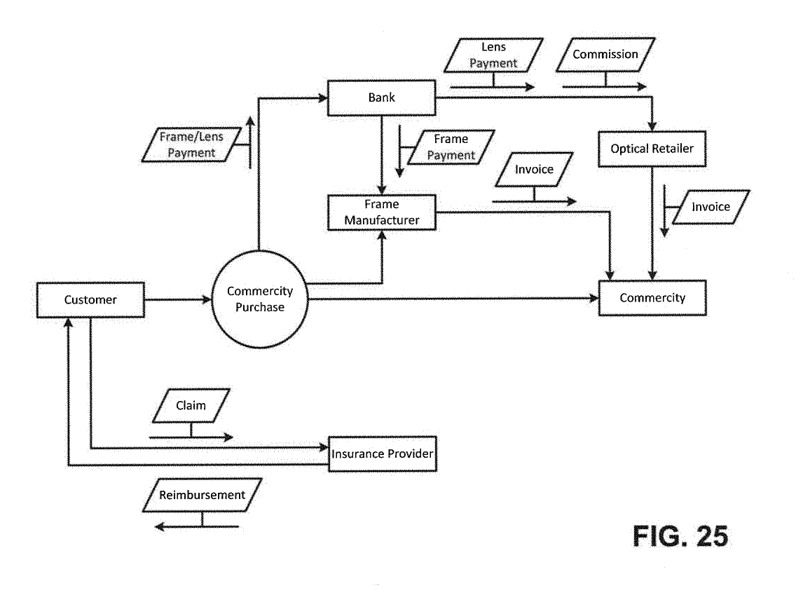

Referring to FIG. 25, a flow diagram illustrating a flow of financial information for a purchase made via a hybrid e-commerce platform according to embodiments is shown. As shown in FIG. 25, a customer may make a purchase via a hybrid e-commerce platform (e.g., Commercity). As part of the purchase, the customer may provide payment information. In an embodiment, the purchase may be associated with a purchase of complete eyewear (e.g., eyewear frames and lenses). The payment information may be provided to a bank, which provides payment for the eyewear frames to a frame manufacturer, and provide payment for the eyewear lenses to an optical retailer. Additionally, the bank may provide a commission payment to the optical retailer. Purchase information may be provided to the frame manufacturer. The frame manufacturer and the optical retailer may both provide invoices to the hybrid e-commerce platform, where the invoices include information identifying products (e.g., eyewear frames, lenses, etc.) and/or services (e.g., frame fitting, etc.) provided by the frame manufacturer and the optical retailer, respectively, in connection with the purchase. Additionally, the purchase information may be provided to the hybrid e-commerce platform. Further, the customer may provide claim information to an insurance provider, and may receive reimbursement, if any, from the insurance provider in connection with the purchase. It is noted that the exemplary flow of financial information in FIG. 25 is provide for purposes of illustration, rather than by way of limitation, and that other financial information flows may be used without departing from the scope of the present disclosure.

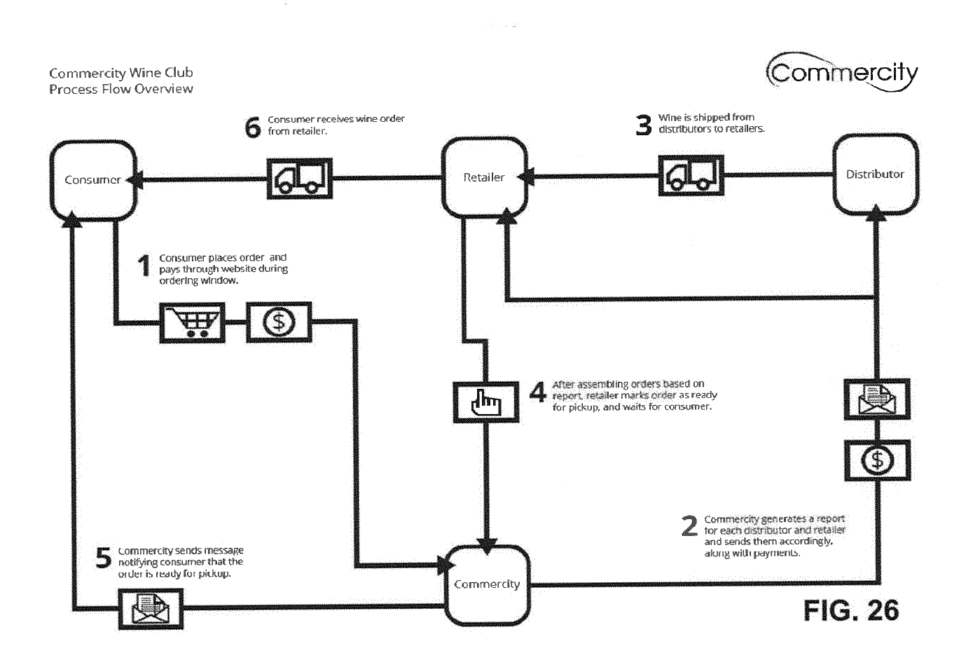

Referring to FIG. 26, a flow diagram illustrating an embodiment of providing a wine club membership and membership fulfillment using a hybrid e-commerce platform according to embodiments is shown. Initially, the customer may place an order for a wine club membership and pay for the membership via a hybrid e-commerce platform (e.g., Commercity). In an embodiment, the customer may provide preference information (e.g., favorite wines, wine types, etc.) as party of the registration/purchase of the wine club membership. After receiving the payment for the membership, the hybrid e-commerce platform may generate and send reports to one or more distributors and a retailer, respectively. The reports may indicate wine selections (and potentially other products, such as cheeses) to be provided to the customer under the membership. In an embodiment, the wine selections (and other products) may be determined by a sommelier associated with the hybrid e-commerce platform. The distributor may then ship the wine selections to the retailer (e.g. a retailer identified in the report sent to the distributor). In an embodiment, the retailer may use the report to assemble an order for the customer (e.g., assemble an order for a fulfilling the membership for a particular time period), where the order includes the wine selections. Once the order is assembled, the retailer may notify the hybrid e-commerce platform that the order is ready to be delivered to the customer and the customer may then be notified that the order is ready for pickup. The customer, after receiving notification that the order is ready, may then visit the retailer to pick up the order.

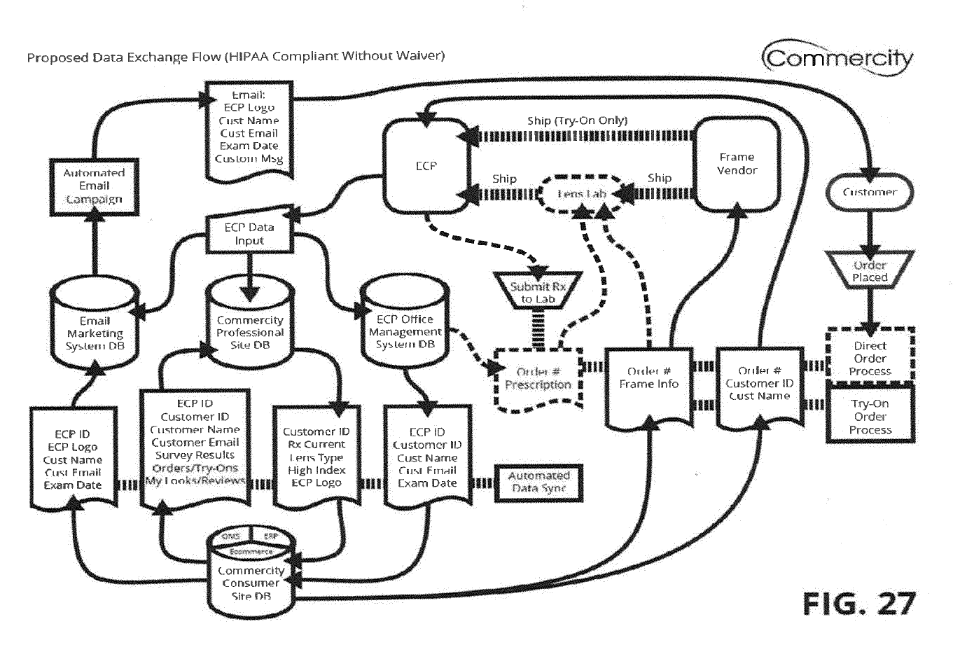

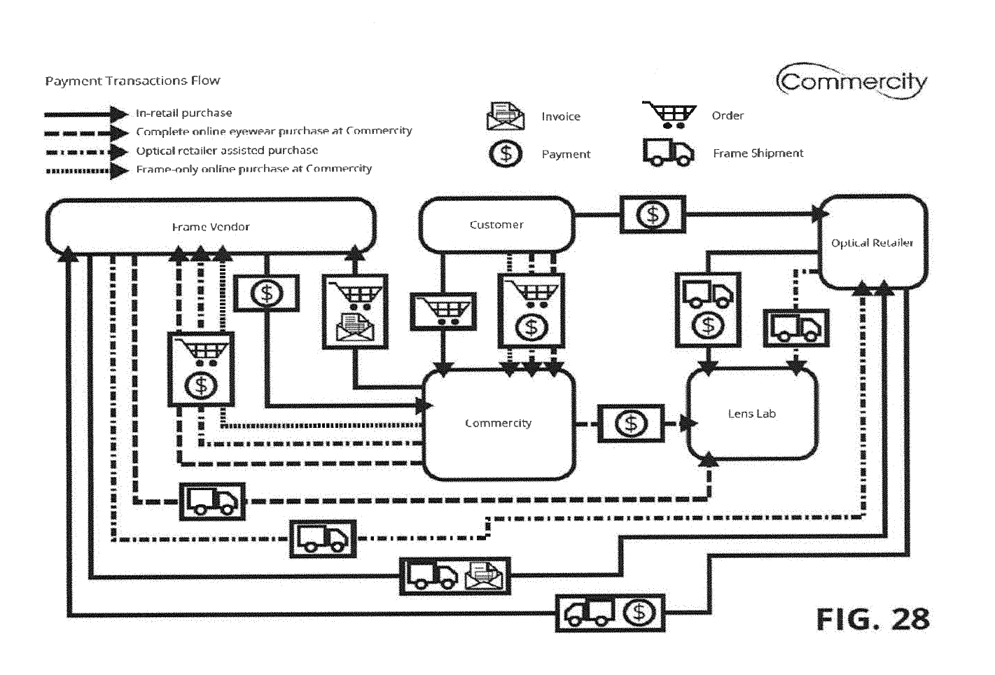

Referring to FIG. 27, a flow diagram illustrating a data flow for exchanging information between entities operating in coordination with a hybrid e-commerce platform according to embodiments is shown. It is noted that the data flow may begin at numerous points within FIG. 27, but for purposes of illustration, and not by way of limitation, FIG. 27 will be described with the data flow starting with an automated e-mail campaign. As shown in FIG. 27, a marketing automation system may store information for an automated e-mail marketing campaign, and may use marketing automation software to target one or more e-mail messages to a customer. When the targeted e-mail campaign is associated with an eye care provider (ECP), the targeted e-mail message may be sent to the customer's e-mail address, and may include a logo associated with the ECP, the customer's name, a custom e-mail message targeted to the customer, and an exam date (e.g., for an eye exam). The customer, in response to receiving the e-mail or otherwise, may visit a web page provided by a hybrid e-commerce platform (e.g., Commercity), and may place an order. In an embodiment, the order may be a direct order (i.e., the customer is purchasing eyewear frames and/or lenses without requesting in-person inspection. In FIG. 27, data flows specific to the direct order process are illustrated by dashed lines. For example, in response to placing the direct order, order information (e.g., order number, customer identification number, customer name) may be provided to the ECP, which then submits the order number and the customer's prescription information to a lab. Additionally, information associated with the ordered frames (e.g., order number and frame information) may be provided to the lab and the frame vendor. The frame vendor may then ship the frames to the lab, which then inserts the prescription lenses to complete the eyewear, and then the lab ships the completed eyewear to the ECP, or directly to the customer. When the lab ships the completed eyewear to the ECP, the ECP may schedule an appointment for the customer to pick the completed eyewear up from the ECP (e.g., after a final fitting, etc.).

If the customer's order includes a request to try-on the eyewear prior to purchase (e.g., an in-person inspection order), the ECP and the frame vendor may receive the order information described above, but the frame vendor may ship the eyewear frames to the ECP, rather than to the lab. Although not illustrated in FIG. 27, if, after the in-person inspection, the customer desires to purchase the eyewear, the ECP may ship the frames to the lab (or provide the frames to the ECP's lab) along with the prescription information.

Irrespective of whether the order is a direct order or an in-person inspection order, the ECP, in response to receiving the order information, may provide input (e.g., following an exam or appointment) to a professional site of the hybrid e-commerce platform. This input may be used to update one or more databases or systems, such as an office management system (e.g., the office management system of FIG. 21) of the ECP, a database associated with the professional site that is maintained as part of the hybrid e-commerce platform, and the marketing automation software (e.g., for tracking analytics and performance of e-mail marketing campaigns). The customer may further provide information the hybrid e-commerce platform, such as “My Looks” information, survey answers/responses, product review, etc. using a customer site provided by the hybrid e-commerce platform. The information associated with the customer may be stored at a customer database of the hybrid e-commerce platform. Information may be exchanged between the customer database and the database associated with the professional site. Additionally, the office management system may provide information to the customer database with information associated with interactions between the ECP and the customer, such as exam date information, exam results information, etc. Additionally, as shown in FIG. 27, information stored at the customer database may be provided to the marketing automation software, which may use that information (e.g., an upcoming exam appointment) to target e-mails to the customer. In an embodiment, information exchanged between the various databases and systems illustrated in FIG. 27 may be automatically synchronized.

Referring to FIG. 28, a flow diagram illustrating various payment transaction and processing flows in a hybrid e-commerce platform according to embodiments is shown. As illustrated in FIG. 28, a customer may purchase products using a hybrid e-commerce platform (e.g., Commercity) in a variety of ways, including: 1) in-retail purchase (shown by a solid line); 2) complete online eyewear purchase via the hybrid e-commerce platform (shown by a dashed line); 3) optical retailer assisted purchase (shown by a dotted/dashed line); or 4) frame-only online purchase via the hybrid e-commerce platform (shown by a dotted line).

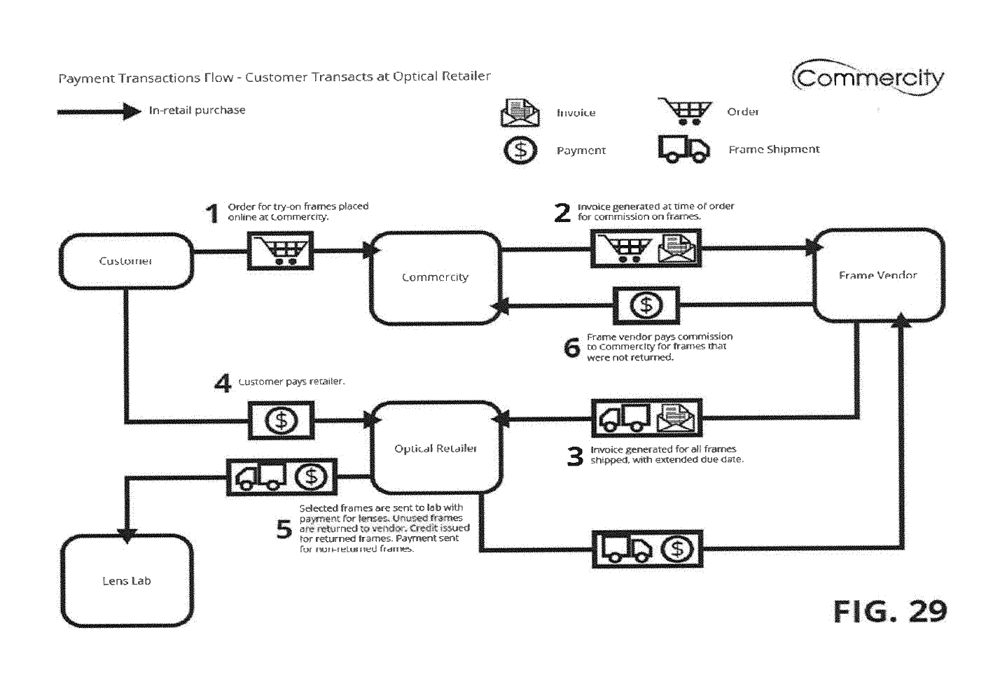

For purchase option 1 (e.g., in-retail purchase with in-person inspection), the customer may place the order via the hybrid e-commerce platform. The order may request in-person inspection of one or more eyewear frames. As shown in FIG. 28, payment may provide payment information to the retailer upon picking up the order from the retailer. The hybrid e-commerce platform may transmit order information and invoice information associated with the customer's order to a frame vendor, who may then ship the eyewear frame(s), along with an invoice, to the retailer. The customer may then visit the retailer and try-on/inspect the eyewear frame(s). If the customer decides to purchase one of the eyewear frames, the customer may provide payment information to the retailer, who may then ship the purchased eyewear frames to a lens lab along with payment for the lenses. The completed eyewear may be provided back to the optical retailer, and then picked up by the customer, or may be provided to the customer directly from the lens lab. Any eyewear frames that the customer elected not to purchase may be shipped back to the frame vendor and payment for the frame(s) purchased by the customer may also be provided. The frame vendor may then provide payment to the hybrid e-commerce platform for the frame(s) purchased by the customer. Additional aspects of payment transaction flows for in-retail purchases are described with reference to FIG. 29.

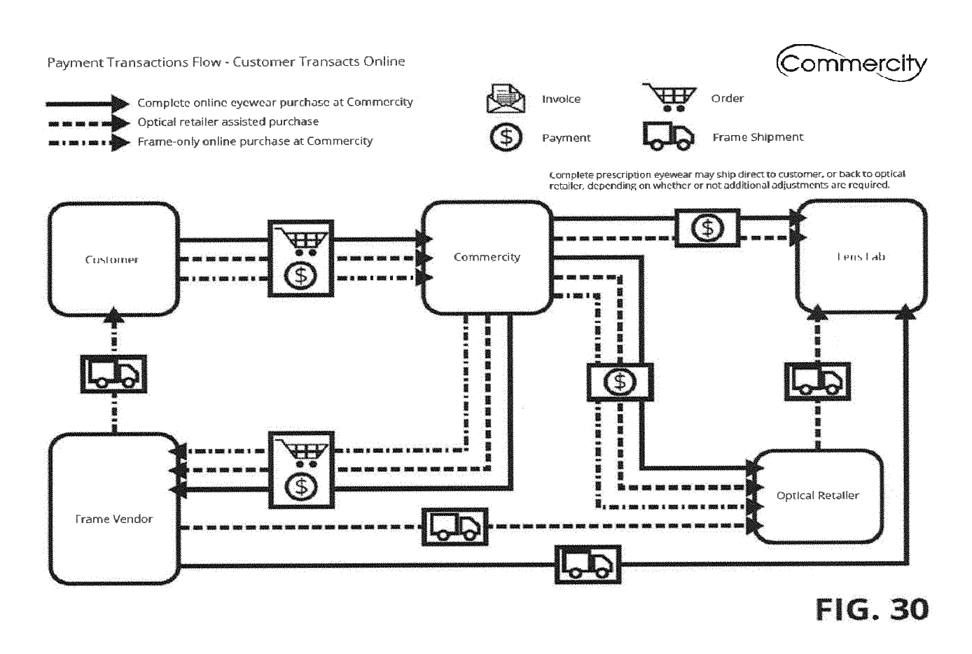

For purchase options 2-4 (e.g., complete online eyewear purchase via the hybrid e-commerce platform, optical retailer assisted purchase, or frame-only online purchase via the hybrid e-commerce platform), the customer may place the order and provide payment information via the hybrid e-commerce platform. The hybrid e-commerce platform may transmit order information and payment information associated with the customer's order to a frame vendor. Under purchase options 2 and 3, the frame vendor may provide the eyewear frames to the lens lab and optical retailer, respectively, whereas under purchase option 4, the eyewear frames may be shipped from the frame vendor to the customer directly. When the frame vendor provides the eyewear frames to the optical retailer (as in option 3), rather than the lab (as in option 2), the retailer may then ship the eyewear frames to the lens lab, and then the completed eyewear may be provided back to the optical retailer and picked up by the customer. Additionally, it is noted that under purchase option 2, the lens lab may receive payment for the lenses from the hybrid e-commerce platform. Additional aspects of payment transaction flows for in-retail purchases are described with reference to FIG. 30.

Referring to FIG. 29, a flow diagram illustrating various aspects of a payment transaction flow for an in-retail purchase using a hybrid e-commerce platform according to embodiments is shown. As shown in FIG. 29, and briefly described above with reference to FIG. 28, a customer may place an order for in-person inspection and try-on of one or more eyewear frames via a hybrid e-commerce platform (e.g., Commercity). The hybrid e-commerce platform may generate an invoice for the order (e.g., for a transactional fee to the hybrid e-commerce platform), and may provide the invoice, along with order information to a frame vendor. The frame vendor may then ship the frames to the retailer along with an invoice for all frames shipped. The customer then visits the retailer, tries-on the frame(s), and, if the customer decides to purchase any frames, provides payment to the retailer (e.g., payment for both the frames and any lenses to be inserted into the frames). The retailer then sends the purchased frames to a lab along with payment for the lenses. Finally, the unpurchased frames are returned to the frame vendor, along with payment for the purchased frames, and the frame vendor provides payment of the transactional fee to the hybrid e-commerce platform.

Referring to FIG. 30, a flow diagram illustrating various aspects of a payment transaction flows for purchases made using a hybrid e-commerce platform according to embodiments is shown. As shown in FIG. 30, and briefly described above with reference to FIG. 28, a customer may place an order and provide payment for the order via a hybrid e-commerce platform (e.g., Commercity). The order may be for complete eyewear (e.g., frames and lenses), shown with a solid line, for a retailer assisted purchase, shown with a dashed line, or may be a frame only online purchase, shown with a dotted/dashed line. For each of these purchases, the hybrid e-commerce platform may provide payment for the frames to a frame vendor, along with order information identifying the ordered frames. For a frame only purchase, the frame vendor may ship the ordered frames directly to the customer. For the complete eyewear purchase, the frame vendor may ship the frames to a lens lab for insertion of the lenses. For the retailer assisted purchase, the frame vendor may ship the frames to the retailer, who may subsequently provide the lenses to the lens lab to complete the eyewear. For each of these purchase types, payment may be provided to the retailer by the hybrid e-commerce platform. Additionally, for complete eyewear purchase and the retailer assisted purchase, the hybrid e-commerce platform may provide payment to the lens lab for the lenses that are to be inserted into the eyewear frames.

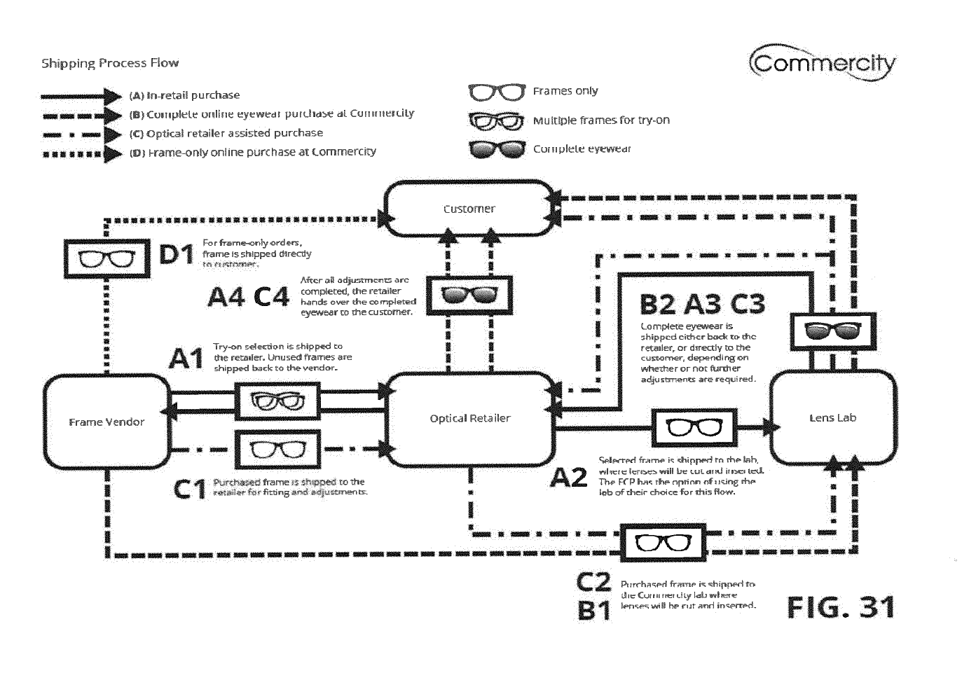

Referring to FIG. 31, a flow diagram illustrating various aspects of a shipping flows for purchases made using a hybrid e-commerce platform according to embodiments is shown. As shown in FIG. 31, a customer may place a variety of order types using a hybrid e-commerce platform (e.g., Commercity). These order types include: 1) an in-retail purchase; 2) a complete eyewear purchase; 3) a retailer assisted purchase; and 4) a frame only purchase. For an in-retail purchase, a selection of frames for try-on and in-person inspection may be shipped from the frame vendor to the retailer. As briefly described above, the customer may inspect and try-on the eyewear frames, and may select one or more for purchase. Frames selected for purchase may be shipped to a lens lab to have lenses inserted, and then the lens lab ships the completed eyewear to the retailer for delivery to the customer. Any frames not selected for purchase by the customer may be shipped back to the frame vendor. For a complete eyewear purchase via the hybrid e-commerce platform, the frame vendor may ship purchased eyewear frames to the lens lab for insertion of lenses, and then the completed eyewear may be shipped from the lens lab directly to the customer. For a retailer assisted purchase, one or more purchased eyewear frames are shipped to the retailer so that the frames, if necessary, may be fitted and measured on the customer before the frames are shipped to the lab. Once the measurement and fitting of the frames is complete, the ECP may ship the eyewear frames to a processing lab. Completed eyewear may be provided from the lens lab back to the retailer, who may then provide the completed eyewear to the customer (e.g., after a final fitting, etc.), or may be shipped directly from the lens lab to the customer. For frame only purchases via the hybrid e-commerce platform, the frame vendor may ship the frames directly to the customer.

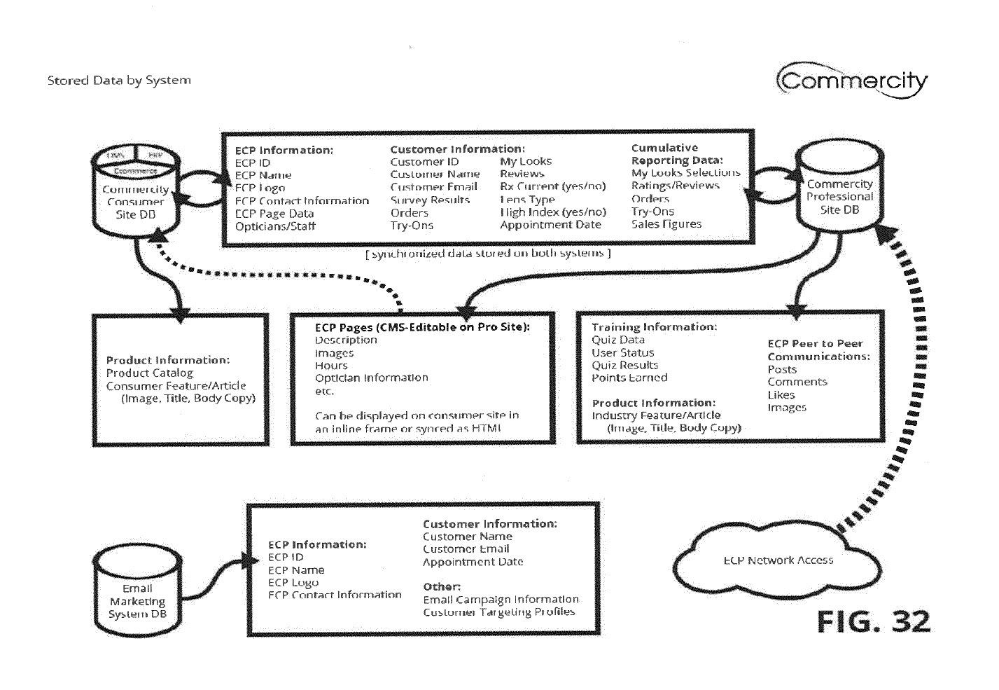

Referring to FIG. 32, a block diagram illustrating various data and data flows utilized by a hybrid e-commerce platform according to embodiments is shown. As shown in FIG. 32, a hybrid e-commerce platform (e.g., Commercity) may utilize various database platforms, including: 1) a customer site database; 2) a professional site database; and 3) a marketing automation database. In an embodiment, these database platforms may correspond to the databases briefly described above with respect to FIG. 27.

The customer site database may store information associated with customers, where the information is provided by the customers via a web page provided via the hybrid e-commerce platform, and the professional site database may store information provided via the professional website (e.g., the in-person provider web application) provided to retailers offering products and/or services to the customer via the hybrid e-commerce platform. Information may be synchronized between the customer site database and the professional site database. For example, information associated with an eye care provider (ECP), such as an ECP identifier, an ECP name, an ECP logo, ECP contact information, ECP page data, and ECP staff information may be synchronized between the customer site database and the professional site database, such that information presented to customers via the customer site web page accurately reflects information for the ECP. Additionally, information associated with customers, such as customer identifiers, names, e-mail addresses, survey results (which may include information gathered by the hybrid e-commerce platform during a consultation), orders, try-on information, a customer's “My Looks,” reviews, prescriptions, lens types, high index, and appointment date information, may also be synchronized between the customer site database and the professional site database. In an embodiment, the synchronization of customer data between the hybrid e-commerce website and the in-person provider application is used to match products to customer desires for improved conversion in both in-retail sales and online sales. In an additional or alternative embodiment, the synchronization of the data may be used for automated marketing campaigns (e.g., e-mail marketing campaigns, text message campaigns, direct mail campaigns, etc.). Additionally, cumulative reporting data may also be synchronized, and may include selections made from a customer's “My Looks,” ratings and review information, order information, try-on information, and sales figures. The customer site database may also store product information relating to products that are sold or offered for sale via the hybrid e-commerce platform. Information for ECP (or other types of retailers) web pages may also be stored in a database accessible to the customer site database. This information may be editable by the ECPs via the professional site (e.g., the in-person provider web application provided by the hybrid e-commerce platform). Further, training information, product information, and peer to peer communication information for the ECP may also be stored in a database accessible to the professional site database. In an embodiment, the professional site database may be accessible via a network of the ECP.

The marketing automation database may store information associated with various ECPs, customers, and e-mail marketing campaigns. For example, the e-mail marketing database may store information associated with an ECP identifier, name, logo, and contact information, and may store information associated with customer names, e-mail addresses, and appointment dates/time. Additionally, the e-mail marketing database may store information associated with one or more e-mail marketing campaigns and customer profiles. The customer profiles may be used to identify customers that are to receive targeted advertisements, promotions, recommendations, etc. as a result of an automated marketing campaign (e.g., an e-mail marketing campaign, a text message campaign, a direct mail campaign, etc.).

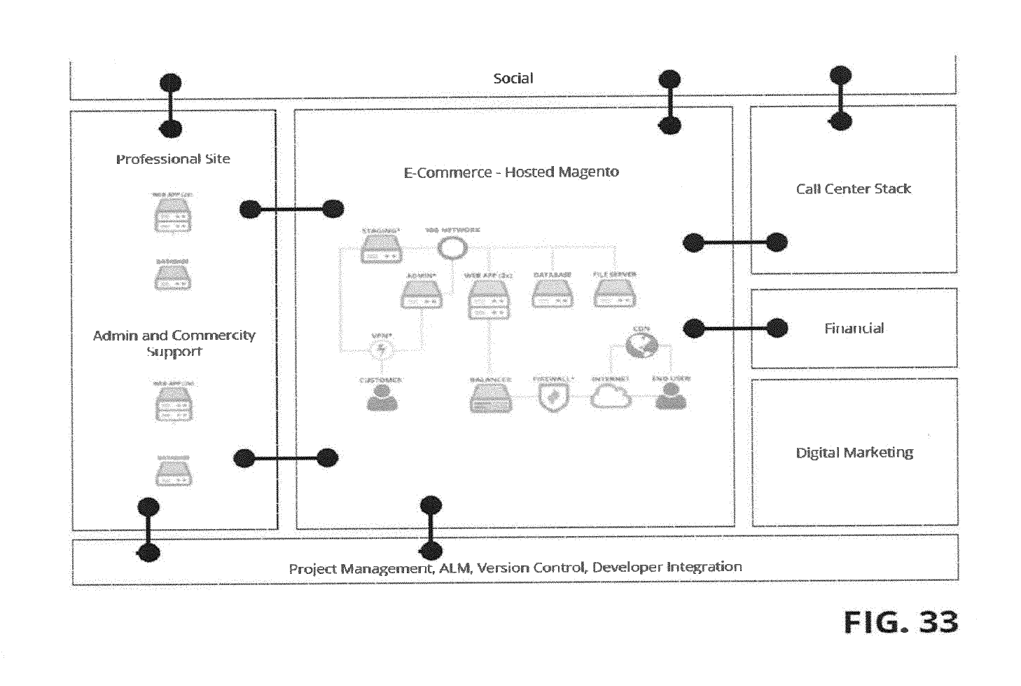

Referring to FIG. 33, a block diagram of an exemplary embodiment of a hybrid e-commerce platform architecture is shown. As shown in FIG. 33, the hybrid e-commerce platform architecture includes a social media platform, an e-commerce platform, a professional site platform, a call center stack platform, a financial platform, a digital marketing platform, and a developer platform. The e-commerce platform may integrate third party e-commerce software with the hybrid e-commerce platform and third party secure hosting services. In an embodiment, the e-commerce software and hosting provided by the hybrid e-commerce platform and the third party may be from the same software and hosting company. The e-commerce platform may further provide software for e-commerce functions provided by the hybrid e-commerce platform, such as online order processing. The social media platform may integrate the hybrid e-commerce platform with third party social media. The professional site platform may provide a website for the in-person providers to manage their engagement with customers (e.g., the in-person provider web application provided by the hybrid e-commerce platform). In an embodiment, the professional website platform and website (e.g., the in-person provider web application) may provide the in-person providers with web applications to: empower the sales process by matching customer preferences to product benefits; network for peer to peer communication between in-person providers, sharing of best-practices, manufacturer engagement, and the like; product sales and training, distribute and organize industry news information, marketing campaign management, establish and market retail events, appointment scheduling, and reporting. In an embodiment, some of the functionality and tools provided via the professional website may be used by the in-person provider during a customer visit, such as using the matching of products to customer preferences to identify products that the customer may be interested in.

The admin and Commercity support platform may provide administration functionality for Commercity, such as functionality and support for manufacturing vendor partners and in-person provider partners. The call center stack platform may provide functionality for customer service, as well as customer and order information and management. The financial platform may provide functionality for general management and accounting of the hybrid e-commerce platform, and may include software for financial/accounting, ERP (Enterprise Resource Planning), and OMS (Order Management System). The digital marketing platform may include marketing automation software for the management of automated marketing campaigns (e.g., e-mail campaigns, direct mail campaigns, text message campaigns, etc.) The developer integration platform may provide tools for ALM (Application Lifecycle Management), version control, and developer integration functionality and software that may be used to maintain and develop the hybrid e-commerce platform. Developers utilizing the develop integration platform may be employees and/or contractors at multiple locations or entities. Tools provided by the developer integration platform may include management of developer time and efforts, version control, code integration, and issue tracking.

In some embodiments, the method comprises providing, by a server (or processor, or any other similar hardware for computing instructions, etc.), a website displaying at least one product; receiving, by a server, at least one selection, from a customer, of at least one product for inspection by the customer; and submitting, by a server, at least one selection of at least one product to at least one product provider, wherein the product provider provides the at least one product for inspection by the customer; and wherein the purchase of at least one product occurs after an inspection of the at least one product by the customer. The method may further comprise sending, by a server, an invitation to visit the website to the customer. The method may further include wherein the at least one product is sent to an in-person provider for inspection. The method may further comprise providing, by a server, a list of an in-person provider in geographical proximity to the online viewer's location; and receiving, by a server, a selected in-person provider, wherein identification of the selected in-person provider is sent to at least one product provider. The method may further comprise providing, by a server, at least one consultation, wherein the at least one consultation limits the products displayed by the website. The method may further comprise submitting, by a server, at least one selection of at least one product to a social media platform, wherein the customer receives social feedback related to their at least one selection, and wherein the step of submitting at least one selection of at least one product to a social media platform is performed prior to the step of receiving at least one selection of at least one product for inspection. The method may further include wherein the at least one product is provided to a third party provider for final assembly after inspection by the customer.

In some embodiments, the system may comprise a computer program product, further comprising a non-transitory computer readable medium comprising code to perform the steps of providing, by a server, a website displaying at least one product; receiving, by a server, at least one selection, from a customer, of at least one product for inspection by the customer; and submitting, by a server, at least one selection of at least one product to at least one product provider, wherein the product provider provides the at least one product for inspection by the customer; and wherein the purchase of at least one product occurs after an inspection of the at least one product by the customer. The computer program product may further include medium further comprising code to perform the step of sending, by a server, an invitation to visit the website to the customer. The computer program product may further include wherein the at least one product is sent to an in-person provider for inspection. The computer program product may further include medium further comprising code to perform the steps of providing, by a server, a list of an in-person provider in geographical proximity to the online viewer's location; and receiving, by a server, a selected in-person provider, wherein identification of the selected in-person provider is sent to at least one product provider. The computer program product may further include medium further comprising code to perform the step of providing, by a server, at least one consultation, wherein the at least one consultation limits the products displayed by the website. The computer program product may further include the medium further comprising code to perform the step of submitting, by a server, at least one selection of at least one product to a social media platform, wherein the customer receives social feedback related to their at least one selection, and wherein the step of submitting at least one selection of at least one product to a social media platform is performed prior to the step of receiving at least one selection of at least one product for inspection.

In some embodiments, the system may include an apparatus, further comprising a memory; and a processor coupled to the memory, the processor configured to execute the steps of providing, by a server, a website displaying at least one product; receiving, by a server, at least one selection, from a customer, of at least one product for inspection by the customer; and submitting, by a server, at least one selection of at least one product to at least one product provider, wherein the product provider provides the at least one product for inspection by the customer; and wherein the purchase of at least one product occurs after an inspection of the at least one product by the customer. The apparatus may further include the processor being further configured to execute the step of sending, by a server, an invitation to visit the website to the customer. The apparatus may further include wherein the at least one product is sent to an in-person provider for inspection. The apparatus may further include the processor being further configured to execute the steps of providing, by a server, a list of an in-person provider in geographical proximity to the online viewer's location; and receiving, by a server, a selected in-person provider, wherein identification of the selected in-person provider is sent to at least one product provider. The apparatus may further include the processor being further configured to execute the step of providing, by a server, at least one consultation, wherein the at least one consultation limits the products displayed by the website. The apparatus may further include the processor being further configured to execute the step of submitting, by a server, at least one selection of at least one product to a social media platform, wherein the customer receives social feedback related to their at least one selection, and wherein the step of submitting at least one selection of at least one product to a social media platform is performed prior to the step of receiving at least one selection of at least one product for inspection.

In some embodiments, the method may comprise providing, by at least one hybrid e-commerce server, a website displaying at least one available product; receiving, by at least one e-commerce server, at least one selection of at least one product for inspection at an in-person provider; and submitting, by at least one e-commerce server, at least one selection of at least one product to at least one product provider; receiving, by the in-person provider, at least one product from at least one product provider; prompting, by either the in-person provider, an in-person provider scheduling server, or at least one e-commerce server, or combination thereof, the scheduling of an initial appointment with the in-person provider; conducting with a customer, and hosted by the in-person provider, an initial inspection of at least one product; sending, by the in-person provider, at least one product to a third-party provider for further processing of at least one product; and prompting, by either the in-person provider, an in-person provider scheduling server, or at least one e-commerce server, or combination thereof, the scheduling of at least one subsequent appointment with the in-person provider; wherein the initial appointment establishes the final production characteristics of at least one product; and wherein the purchase of at least one product occurs after the initial inspection. The method may further comprise conducting with the customer, and hosted by the in-person provider, at least one subsequent inspection of at least one product. The method may further comprise receiving, by at least one e-commerce server, at least one status message from the in-person provider scheduling server, a third-party server, or a combination thereof; sending, by at least one e-commerce server, at least one status message to the in-person provider scheduling server, the third-party server, or a combination thereof; wherein at least one status message sent by at least one e-commerce server prompts the in-person provider or the in-person provider server to schedule an appointment with the customer. The method may further comprise providing, by at least one e-commerce server, at least one consultation, wherein at least one consultation is used by at least one e-commerce server to tailor the products provided in the step of providing to an online viewer website displaying at least one available product. The method may further comprise submitting, by at least one e-commerce server, at least one selection of at least one product to a social media platform, wherein the customer receives social feedback related to their at least one selection, and wherein the step of submitting at least one selection of at least one product to a social media platform is performed prior to the step of receiving, by at least one e-commerce server, at least one selection of at least one product for inspection at an in-person provider. The method may further include wherein the website displaying at least one available product, provided by at least one e-commerce server, uses the color and layout of the in-person provider's website or brand. The method may further comprise providing, by at least one e-commerce server, a list of in-person providers in geographical proximity to the online viewer's location; and receiving, by at-least one e-commerce server, a selected in-person provider, wherein at least one e-commerce server provides the shipping information of the selected in-person provider to at least one product provider.

In some embodiments, the system may include a computer program product, further comprising a non-transitory computer readable medium comprising code to perform the steps of providing, by at least one e-commerce server, a website displaying at least one available product; receiving, by at least one e-commerce server, at least one selection of at least one product for inspection at an in-person provider; and sending, by at least one e-commerce server, at least one selection of at least one product to at least one product provider; sending, by at least one e-commerce server to the in-person provider, notification that at least one product is shipping from at least one product provider; prompting, by an in-person provider scheduling server or at least one e-commerce server, or combination thereof, the scheduling of an initial appointment with the in-person provider; sending, by at least one e-commerce server to a third-party provider server, the final production characteristics of at least one product for further processing by the third-party provider; and prompting, by an in-person provider scheduling server or at least one e-commerce server, or combination thereof, the online viewer to schedule at least one subsequent appointment with the in-person provider; wherein the initial appointment establishes the final production characteristics of at least one product. The computer program product may further include medium further comprising code to perform the steps of receiving, by at least one e-commerce server, at least one status message from the in-person provider scheduling server, a third-party server, or a combination thereof; sending, by at least one e-commerce server, at least one status message to the in-person provider scheduling server, the third-party server, or a combination thereof; wherein at least one status message sent by at least one e-commerce server prompts the in-person provider or the in-person provider server to schedule an appointment with the customer. The computer program product may further include medium further comprising code to perform the step providing, by at least one e-commerce server, at least one consultation, wherein at least one consultation is used by at least one e-commerce server to tailor the products provided in the step of providing to an online viewer website displaying at least one available product. The computer program product may further include medium further comprises code to perform the steps of submitting, by at least one e-commerce server, at least one selection of at least one product to a social media platform, wherein the customer receives social feedback related to their at least one selection, and wherein the step of submitting at least one selection of at least one product to a social media platform is performed prior to the step of receiving, by at least one e-commerce server, at least one selection of at least one product for inspection at an in-person provider. The computer program product may further include wherein the website displaying at least one available product, provided by at least one e-commerce server, uses the color and layout of the in-person provider's website or brand. The computer program product may further include medium further comprising code to perform the step of providing, by at least one e-commerce server, a list of in-person providers in geographical proximity to the online viewer's location; and receiving, by at-least one e-commerce server, a selected in-person provider, wherein at least one e-commerce server provides the shipping information of the selected in-person provider to at least one product provider.

In some embodiments, the system may comprise an apparatus, further comprising a memory; and a processor coupled to the memory, the processor configured to execute the steps of providing, by at least one e-commerce server, a website displaying at least one available product; receiving, by at least one e-commerce server, at least one selection of at least one product for inspection at an in-person provider; and sending, by at least one e-commerce server, at least one selection of at least one product to at least one product provider; sending, by at least one e-commerce server to the in-person provider, notification that at least one product is shipping from at least one product provider; prompting, by an in-person provider scheduling server or at least one e-commerce server, or combination thereof, the scheduling of an initial appointment with the in-person provider; sending, by at least one e-commerce server to a third-party provider server, the final production characteristics of at least one product for further processing by the third-party provider; and prompting, by an in-person provider scheduling server or at least one e-commerce server, or combination thereof, the online viewer to schedule at least one subsequent appointment with the in-person provider; wherein the initial appointment establishes the final production characteristics of at least one product. The apparatus may further include the processor being further configured to execute the steps of receiving, by at least one e-commerce server, at least one status message from the in-person provider scheduling server, a third-party server, or a combination thereof; sending, by at least one e-commerce server, at least one status message to the in-person provider scheduling server, the third-party server, or a combination thereof; wherein at least one status message sent by at least one e-commerce server prompts the in-person provider or the in-person provider server to schedule an appointment with the customer. The apparatus may further include the processor being further configured to execute the steps of providing, by at least one e-commerce server, at least one consultation, wherein at least one consultation is used by at least one e-commerce server to tailor the products provided in the step of providing to an online viewer website displaying at least one available product. The apparatus may further include the processor being further configured to execute the steps of submitting, by at least one e-commerce server, at least one selection of at least one product to a social media platform, wherein the customer receives social feedback related to their at least one selection, and wherein the step of submitting at least one selection of at least one product to a social media platform is performed prior to the step of receiving, by at least one e-commerce server, at least one selection of at least one product for inspection at an in-person provider. The apparatus may further include wherein the website displaying at least one available product, provided by at least one e-commerce server, uses the color and layout of the in-person provider's website or brand. The apparatus may further include the processor being further configured to execute the steps of providing, by at least one e-commerce server, a list of in-person providers in geographical proximity to the online viewer's location; and receiving, by at-least one e-commerce server, a selected in-person provider, wherein at least one e-commerce server provides the shipping information of the selected in-person provider to at least one product provider.

It is noted that, although the operations of the hybrid e-commerce server and the hybrid e-commerce platform have been described above with particular reference to the eye care industry, the hybrid e-commerce server and the hybrid e-commerce platform may be utilized to provide additional advantages and benefits in other industries as well. For example, alcoholic beverage manufacturers and distributors may partner with a hybrid e-commerce provider (HECP) to provide for the sale of alcoholic beverages using the hybrid e-commerce platform.

To illustrate, a customer may visit the hybrid e-commerce platform (e.g., a web page) provided by the hybrid e-commerce server to select alcoholic beverages (e.g., beers, wines, liquors, etc.) for purchase. The customer may browse a large selection of alcoholic beverages via the hybrid e-commerce platform, and may make selections of particular alcoholic beverages for purchase. In an embodiment, during checkout, the hybrid e-commerce server may access inventory information associated with partnering alcoholic beverage retailers, distributors, and manufacturers to identify a location that has all of the selected alcoholic beverages in-stock, or, for any alcoholic beverages that are not in-stock, may schedule shipping of the out-of-stock alcoholic beverages to a particular retailer near the customer's location. When one or more of the particular alcoholic beverages is to be shipped to the particular retailer, information indicating an expected shipping date, and expected arrival date, and an estimated pick-up date may be provided to the customer. The customer may then visit the particular retailer to pick-up the particular alcoholic beverages. In an additional or alternative embodiment, the customer may be affiliated with a particular location, and the hybrid e-commerce server may schedule shipping of the alcoholic beverages selected for the customer's next club membership deliver to the customer's affiliated retailer location, as described with reference to FIG. 26.

During pick-up, the particular retailer will perform age verification to verify that the customer is of the appropriate age to purchase the particular alcoholic beverages, and may receive payment. In an embodiment, payment information may be provided in advance, and the particular retailer will access the hybrid e-commerce platform (e.g., an In-Person Representative Professional Web Application) to provide an input indicating that the customer has picked-up the particular alcoholic beverages, which may cause the hybrid e-commerce platform to charge an account of the customer using the previously provided payment information. If the particular retailer indicates, via the hybrid e-commerce platform, that the customer is not of the appropriate age to purchase the alcoholic beverages, the hybrid e-commerce platform and/or the hybrid e-commerce server may not charge the account of the customer, although a processing fee may be charged if required.

By requiring in-person pick-up at an authorized partnering alcoholic beverage retailer, the hybrid e-commerce server and the hybrid e-commerce platform are able to offer online sales of alcoholic beverages on behalf of the partnering retailers, while complying with applicable government regulations and requirements pertaining to the sale of alcoholic beverages, such as age verification. Additionally, during pick-up, the customer is able to ask the retailer questions regarding the particular alcoholic beverages being purchase, such as where the particular alcoholic beverages are made, how they are made, etc., and may obtain food pairing recommendations and drink recipes from the retailer, such as for dinner parties, catering events, etc. In an embodiment, signature verified UPS and FedEx mailing services may be used to deliver alcoholic beverages (and/or other products) directly to the customer.

In an embodiment, the hybrid e-commerce server may act as an online sommelier, cicerone, or other beverage and/or cigar expert that is available on-demand, and the customer may merely pick-up the alcoholic beverages purchased via the hybrid e-commerce platform. For example, upon visiting the hybrid e-commerce platform and enrolling in the club program, the customer is requested to participate in an online consultation. The consultation may collect customer preference information that may be used by the hybrid e-commerce platform to narrow and tailor the product(s) recommended to, or selected for, the customer for their next club delivery. In an embodiment, the product consultation may be provided via the hybrid e-commerce page. In an embodiment, the consultation may be split up into consultations for each category (e.g., wine, beer, other alcoholic beverages and/or cigars). Thus, in contrast to traditional club memberships that do not account for customer preferences, club memberships according to embodiments provide a selection of products personalized and recommended to the customer by a highly accomplished sommelier, cicerone, beverage, or cigar experts. In an embodiment, customer feedback on the wine they have ordered may be added to the customer's profile to improve selections for future orders.

In another illustrative example, the hybrid e-commerce platform and the hybrid e-commerce server may offer club memberships to customers on behalf of the partnering alcoholic beverage retailers, distributors, and manufacturers. However, unlike traditional alcoholic beverage club memberships, the memberships offered by the hybrid e-commerce platform and the hybrid e-commerce server may enable the customer to select from among a plurality of tiered club memberships. The tiered club memberships may have different price points. For example, in a wine club membership, the customer may select from a first tier wine club membership, a second tier wine club membership, and a third tier wine club membership. Each of the tiers may offer the customer a number of bottles of wine per month (or other time period/frequency), such as 6 bottles per month. However, the bottles of wine offered in the first tier may have a different price point than the bottles of wine provided to customers that elect the second tier or the third tier (e.g., $8-10 per bottle of wine for the first tier, $15-25 per bottle of wine for the second tier, or $30+ per bottle of wine for the third tier).

The customers may sign-up for club memberships by visiting the hybrid e-commerce platform, or may register for a club membership during a visit to their local retailer. The club memberships may each have a different membership cost that varies according the selected tier of the membership. For example, the first tier may have a lowest membership cost, the third tier may have the highest membership cost, and the second tier may have a membership cost that is between the first and second tier membership costs. Additionally, the hybrid e-commerce platform and the hybrid e-commerce server may offer alternatives to the tiered club memberships, such as offering a club membership that provides the customer with bottles of wine from the third tier at a reduced membership cost. However, such alternative club membership may provide a reduced number of bottles of wine than would be otherwise provided if the customer elected to sign up for the third tier club membership. The club memberships may also include memberships for bottles of liquor, beer, champagne, cigars, etc. Additionally, the club memberships may offer memberships for specific types of wines (e.g., red wines only, white wines only, cabernets only, etc.), for specific types of liquors (e.g., whiskey only, bourbon only, tequila only, etc.), for specific types of beers (e.g., craft beers only, lagers only, ales only, etc.), for specific types of cigars (e.g., Connecticut shade cigars only, maduro cigars only, etc.), for products from a specific region (e.g., locally brewed beers, cigars from the Dominican republic, wines from a particular wine region, etc.), or any other criteria.

The customer may pick-up the products provided in connection with their selected club membership(s) at a local retailer, who may perform age verification, accept payment information or provide confirmation of pick-up to the hybrid e-commerce platform, etc. Once a customer has been authorized (e.g., age confirmed by the local retailer) to purchase alcoholic beverages by a local retailer, the customer may make subsequent purchases of alcoholic beverages from the hybrid e-commerce platform and have the alcoholic beverages shipped to the customer's home directly, thereby eliminating the requirement to visit the retailer. Additionally, the hybrid e-commerce server and/or the hybrid e-commerce platform may coordinate club membership pick-up dates and times with events hosted by the partnering retailers. For example, a partnering retailer may schedule a tasting of the wines selected during a particular month for wine club members. Thus, during pick-up, the customer may taste the wines they are receiving as part of their membership, be educated on the regions where the wines are made, receive recipes for suggested food pairings, etc. In an aspect, the information associated with the regions where the wines are made, the recipes, and/or the food pairing suggestions may be provided via the hybrid e-commerce platform, such as via the online sommelier or cicerone provided by the hybrid e-commerce platform. This may increase the customers satisfaction with their selected wine club membership. Additionally, if the customer enjoys a particular selected bottle of wine they experience during the tasting, they may choose to purchase additional bottles of the wine that are in addition to the bottles they are receiving as part of the club membership, thereby increasing sales for the retailer hosting the tasting. The manufacturers of the wine may also be involved, such as by sending a representative to the event to discuss the particular grapes used to make the wine, how long the wine was aged, how it was aged, flavor profiles, etc., and may also provide additional bottles of wine to the retailer for use during the tasting. The hybrid e-commerce server and/or the hybrid e-commerce platform may be used to coordinate the shipment of the additional bottles of wine from the manufacturer to the retailer, and to schedule the date of the event.

It is noted that products provided to customers in conjunction with club memberships may also be picked up on dates and times other than scheduled tasting events as is convenient to the customer, and that the customer may ask the retailer questions at the time of pick-up. The recipes and food pairings, as well as the information on the manufacturing of the wines (or other products) may be e-mailed to the club members or may be otherwise accessible via the hybrid e-commerce server and/or the hybrid e-commerce platform. In this way, customers who did not attend the tasting event may still receive information educating them on their club membership product offerings. Additionally, the HECP may create or work with the manufacturers to create videos or other information that is provided to the club members, such as a video of a sommelier describing the wine and recommended pairings, or a video highlighting a particular vineyard where the grapes for one of the selected wines were grown or even showing the process of making one of the selected wines from start to finish. Additionally, it is noted that the club memberships provided by the hybrid e-commerce platform may include club memberships that provide a combination of products, such as a membership that offers a combination of beers and wine, or a membership that offers a combination of scotch and cigars. Memberships offering other product combinations may also be offered by the hybrid e-commerce platform, such as wine and cheese memberships, wine and chocolate memberships, themed cocktail memberships that provide a different combination of spirits and mixers with a different theme every month (e.g., island themed cocktails, holiday themed cocktails, etc.). Thus, the club memberships provided by the hybrid e-commerce server and/or the hybrid e-commerce platform provide an improved experience for customers. For example, alcoholic beverage club memberships provided by the hybrid e-commerce platform according to embodiments may create a more beneficial club experience because the membership and product delivery is provided by local liquor stores which provide ease of pick up, complimentary product and pairing recommendations and inventory, such as when the customer arrives at the liquor store to pick up the membership selections that have been pre-packaged for the customer. It is noted that club membership terms and conditions/availability may vary from state to state dependent on the state laws and restrictions.

In a further aspect, the hybrid e-commerce server and the hybrid e-commerce platform may provide services that are in addition to, and complimentary to, providing for in-person inspections prior to purchasing a product. For example, in a hair salon setting, a hair stylist may provide information associated with hair care products that were used to style a customer's hair during a visit to a hair salon to the hybrid e-commerce platform, and the information may be used to target advertisements for the hair care products to the customer via e-mail, text messages, and other forms of communication (e.g., direct mailers). Additionally, the hybrid e-commerce platform may be used by the customer to schedule subsequent appointments with the hair salon, which may include selecting a particular hair stylist, requesting products for purchase during the appointment, etc. It is noted that, while described with reference to hair salon appointments, such features may be readily adapted, in conjunction with one or more of the features provided by the hybrid e-commerce platform, to other industries, such as pet grooming, veterinary care, musical instrument sales, makeup sales and appointments with makeup artists, electronic appliance sales, or any other industry.

Although the present disclosure and its advantages have been described in detail, it should be understood that various changes, substitutions and alterations can be made herein without departing from the spirit and scope of the disclosure as defined by the appended claims. It should be noted that any of the various feature(s) disclosed in the detailed description may be excluded from any one of the various embodiments (i.e., a negative limitation of a particular feature) for the purpose of reducing cost, reducing complexity, distinguishing from other methods and/or systems, and/or removing duplicative features that may be provided by a separate method or system, especially when the other method or system is connected with the present method and/or system. Further, various industries will require different combinations of the various features of the disclosed invention, and in particular, may need to limit or exclude certain features (i.e., a negative limitation of a various feature). Moreover, the scope of the present application is not intended to be limited to any particular embodiment of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1-50. (canceled)

51. A computer program product, comprising:
a non-transitory computer readable medium comprising code to perform the steps of:
providing, by at least one e-commerce server, a website displaying at least one available alcoholic product;
receiving, by at least one e-commerce server, at least one selection of at least one alcoholic product for inspection at an in-person provider or by viewing an on line instructional video regarding the alcoholic product;
sending, by at least one e-commerce server, at least one selection of at least one alcoholic product to at least one in-person product provider; and
prompting, by an in-person provider scheduling server or at least one e-commerce server, or combination thereof, notification that the alcoholic product is available at the in-person provider for inspection or trial or to arrange for the delivery of the alcoholic product to the consumer for inspection or trial of the alcoholic product.

52. The computer program product of claim 51, in which the medium further comprises code to perform the steps of:
receiving, by at least one e-commerce server, at least one status message from the in-person provider scheduling server, a third-party server, or a combination thereof;
sending, by at least one e-commerce server, at least one status message to the in-person provider scheduling server, the third-party server, or a combination thereof;
wherein at least one status message sent by at least one e-commerce server prompts the in-person provider or the in-person provider server to schedule an appointment with the customer or to schedule a delivery or pick-up time with the in-person provider.

53. The computer program product of claim 52, in which the medium further comprises code to perform the step:
providing, by at least one e-commerce server, at least one consultation,
wherein at least one on-line website is used by at least one e-commerce server to tailor the alcoholic product provided in the step of providing to an online viewer website displaying at least one available alcoholic product.

54. The computer program product of claim 51, in which the medium further comprises code to perform the steps of:
submitting, by at least one e-commerce server, at least one selection of at least one alcoholic product to a social media platform,
wherein the customer receives social feedback related to their at least one alcoholic selection, and
wherein the step of submitting at least one selection of at least one alcoholic product to a social media platform is performed after the step of receiving, by at least one e-commerce server, at least one selection of at least one alcoholic product for inspection at an in-person provider.

55. The computer program product of claim 51, wherein the website displaying at least one available alcoholic product, provided by at least one e-commerce server, uses the color and layout of the in-person provider's website.

56. The computer program product of claim 51, in which the medium further comprises code to perform the step of:
providing, by at least one e-commerce server, a list of in-person providers in geographical proximity to the online viewer's location; and
receiving, by at-least one e-commerce server, a selected in-person provider,
wherein at least one e-commerce server provides the shipping information of the selected in-person provider to at least one product provider.

57. A computer program product, comprising:
a non-transitory computer readable medium comprising code to perform the steps of:
providing, by at least one e-commerce server, a website displaying at least one available eyewear frame product;
receiving, by at least one e-commerce server, at least one selection of at least one eyewear frame product for inspection at an in-person provider; and
sending, by at least one e-commerce server, at least one selection of at least one eyewear frame product to at least one in-person product provider;
sending, by at least one e-commerce server to the in-person provider, notification that at least one eyewear frame product is shipping or is already available from at least one product provider;
prompting, by an in-person provider scheduling server or at least one e-commerce server, or combination thereof, the scheduling of an initial appointment with the in-person provider;
sending, by at least one e-commerce server to a third-party provider server, the final production characteristics of at least one eyewear frame product for further processing by the third-party provider; and
prompting, by an in-person provider scheduling server or at least one e-commerce server, or combination thereof, the online viewer to schedule at least one subsequent appointment with the in-person provider;
wherein the initial appointment establishes the final production characteristics of at least one eyewear frame product.

58. The computer program product of claim 57, in which the medium further comprises code to perform the steps of:
receiving, by at least one e-commerce server, at least one status message from the in-person provider scheduling server, a third-party server, or a combination thereof;
sending, by at least one e-commerce server, at least one status message to the in-person provider scheduling server, the third-party server, or a combination thereof;
wherein at least one status message sent by at least one e-commerce server prompts the in-person provider or the in-person provider server to schedule an appointment with the customer.

59. The computer program product of claim 58, in which the medium further comprises code to perform the step:
providing, by at least one e-commerce server, at least one consultation,
wherein at least one consultation is used by at least one e-commerce server to tailor the eyewear product provided in the step of providing to an online viewer website displaying at least one available eyewear frame product.

60. The computer program product of claim 57, in which the medium further comprises code to perform the steps of:
submitting, by at least one e-commerce server, at least one selection of at least one eyewear frame product to a social media platform,
wherein the customer receives social feedback related to their at least one selection, and
wherein the step of submitting at least one selection of at least one eyewear frame product to a social media platform is performed prior to the step of receiving, by at least one e-commerce server, at least one selection of at least one eyewear frame product for inspection at an in-person provider.

61. The computer program product of claim 57, wherein the website displaying at least one available eyewear frame product, provided by at least one e-commerce server, uses the color, brand or layout of the in-person provider's website.

62. The computer program product of claim 57, in which the medium further comprises code to perform the step of:
providing, by at least one e-commerce server, a list of in-person providers in geographical proximity to the online viewer's location; and
receiving, by at-least one e-commerce server, a selected in-person provider,
wherein at least one e-commerce server provides the shipping information of the selected in-person provider to at least one eyewear frame product provider.

63. An apparatus, comprising:
a memory; and
a processor coupled to the memory, the processor configured to execute the steps of:
providing, by at least one e-commerce server, a website displaying at least one available alcoholic product;
receiving, by at least one e-commerce server, at least one selection of at least one alcoholic product for inspection at an in-person provider or by viewing an on line instructional video;
sending, by at least one e-commerce server, at least one selection of at least one alcoholic product to at least one product provider;
prompting, by an in-person provider scheduling server or at least one e-commerce server, or combination thereof, notification that the alcoholic product is available at the in-person provider for inspection or trial or to arrange for the delivery of the alcoholic product to the consumer for inspection or trial of the alcoholic product.

64. The apparatus of claim 63, in which the processor is further configured to execute the steps of:
receiving, by at least one e-commerce server, at least one status message from the in-person provider scheduling server, a third-party server, or a combination thereof;
sending, by at least one e-commerce server, at least one status message to the in-person provider scheduling server, the third-party server, or a combination thereof;
wherein at least one status message sent by at least one e-commerce server prompts the in-person provider or the in-person provider server to schedule an appointment with the customer or to schedule a delivery or pick-up time with the in-person provider.

65. The apparatus of claim 63, in which the processor is further configured to execute the steps of:
providing, by at least one e-commerce server, at least one consultation,
wherein at least one on-line website is used by at least one e-commerce server to tailor the alcoholic product provided in the step of providing to an online viewer website displaying at least one available alcoholic product.

66. The apparatus of claim 63, in which the processor is further configured to execute the steps of:
submitting, by at least one e-commerce server, at least one selection of at least one alcoholic product to a social media platform,
wherein the customer receives social feedback related to their at least one selection, and
wherein the step of submitting at least one selection of at least one alcoholic product to a social media platform is performed after the step of receiving, by at least one e-commerce server, at least one selection of at least one alcoholic product for inspection at an in-person provider.

67. The apparatus of claim 63, wherein the website displaying at least one available alcoholic product, provided by at least one e-commerce server, uses the color and layout of the in-person provider's website or brand.

68. The apparatus of claim 63, in which the processor is further configured to execute the steps of:
providing, by at least one e-commerce server, a list of in-person providers in geographical proximity to the online viewer's location; and
receiving, by at-least one e-commerce server, a selected in-person provider,
wherein at least one e-commerce server provides the shipping information of the selected in-person provider to at least one product provider.
